(19) United States
(12) Patent Application Publication
(10) Pub. No.: US 2026/0023525 A1
(43) Pub. Date: Jan. 22, 2026

(54) DISPLAY APPARATUS AND METHOD THEREFOR

(71) Applicant: HISENSE VISUAL TECHNOLOGY CO., LTD., Shandon (CN)

(72) Inventors: Zijing DENG, Shandong (CN); Donghang LI, Shandong (CN); Xiaochen WANG, Shandong (CN); Jianzhu XIU, Shandong (CN)

(21) Appl. No.: 19/345,319

(22) Filed: Sep. 30, 2025

Related U.S. Application Data
(63) Continuation of application No. PCT/CN2024/079007, filed on Feb. 28, 2024.

(30) Foreign Application Priority Data
Mar. 30, 2023 (CN) 202310331670.0
Nov. 23, 2023 (CN) 202311575535.7
Nov. 23, 2023 (CN) 202311583106.4
Nov. 23, 2023 (CN) 202311583113.4

(51) Int. Cl. G06F 3/16; G06F 1/16; H04W 12/50

(52) U.S. Cl. CPC G06F 3/165; G06F 1/1605; H04W 12/50

(57) ABSTRACT

Disclosed are a display apparatus and a method therefor. The method includes: controlling a Bluetooth communication module of the display apparatus to perform device scanning, and displaying scanned devices on a display of the display apparatus; in response to a pairing request triggered for a target device among the scanned devices, establishing a Bluetooth connection based on an A2DP protocol with the target device; obtaining a UUID of the target device; after successfully establishing the Bluetooth connection based on the A2DP protocol, adding the target device to a list of connected devices; determining, based on the UUID, that the target device supports a LE Audio protocol, adding a preset visual indicator for the target device; where the preset visual indicator is used to prompt a user that the Bluetooth connection with the target device is allowed to be switched to a Bluetooth connection based on the LE Audio protocol.

### CROSS-REFERENCE TO RELATED APPLICATIONS

This disclosure is a continuation application of International Application No. PCT/CN2024/079007 filed Feb. 28, 2024, which claims priority to Chinese Patent Application No. 202311575535.7 filed on Nov. 23, 2023, Chinese Patent Application No. 202311583113.4 filed on Nov. 23, 2023, Chinese Patent Application No. 202311583106.4 filed on Nov. 23, 2023, and Chinese Patent Application No. 202310331670.0 filed on Mar. 30, 2023, all of which are hereby incorporated by reference in their entireties.

### TECHNICAL FIELD

The disclosure relates to the field of Bluetooth technology, in particular to a display apparatus and an apparatus control method.

### BACKGROUND

With the introduction of a new generation Bluetooth audio technology standard-Bluetooth Low Energy Audio (LE Audio) technology, an increasing number of devices can support the Bluetooth Low Energy Audio (LE Audio) protocol. For devices supporting the LE Audio protocol, there is a need for a device control method.

### SUMMARY

In a first aspect, the disclosure can provide a display apparatus, including: a display, configured to display images and/or a user input interface; a user input interface, configured to receive a command from a user; a Bluetooth communication module, configured to perform operations related to the Bluetooth protocol; a communicating device, configured to communicate with external devices according to a predetermined protocol; a memory, configured to store computer instructions and data associated with the display apparatus; at least one processor, connected with the display, the user input interface, the Bluetooth communication module, the communicating device, and the memory, configured to execute computer instructions to cause the display apparatus to perform: controlling the Bluetooth communication module to perform device scanning, and controlling the display to display scanned devices; in response to a pairing request triggered for a target device among the scanned devices, establishing a Bluetooth connection with the target device and obtaining a Universally Unique Identifier (UUID) of the target device; where the UUID can be used to indicate whether the target device supports the Bluetooth Low Energy Audio (LE Audio) protocol; and, based on determining according to the UUID that the target device supports the LE Audio protocol, controlling the display to display a preset indicator for the target device; where the preset indicator can be used to indicate that the target device supports the LE Audio protocol.

In a second aspect, the disclosure can provide a device control method, including: controlling a Bluetooth communication module to perform device scanning, and controlling a display to display scanned devices; in response to a pairing request triggered for a target device among the scanned devices, establishing a Bluetooth connection with the target device and obtaining a Universally Unique Identifier (UUID) of the target device; where the UUID can be used to indicate whether the target device supports the Bluetooth Low Energy Audio (LE Audio) protocol; and, based on determining according to the UUID that the target device supports the LE Audio protocol, controlling the display to display a preset indicator for the target device; where the preset indicator can be used to indicate that the target device supports the LE Audio protocol.

### BRIEF DESCRIPTION OF FIGURES

FIG. 1 is a schematic diagram illustrating one-to-one audio transmission for unicast media audio according to some embodiments.

FIG. 2 is a schematic diagram illustrating one-to-two audio transmission for unicast media audio according to some embodiments.

FIG. 3 is a schematic diagram illustrating a relationship between extended broadcasting, periodic broadcasting, and BIS according to some embodiments.

FIG. 4 is a schematic diagram illustrating a relationship between extended advertising packets, auxiliary advertising packets, periodic advertising packets, and BIS according to some embodiments.

FIG. 5 is a schematic diagram illustrating continuous BIG transmission according to some embodiments.

FIG. 6 is a schematic diagram of a scenario for a device control method according to some embodiments.

FIG. 7 is a block diagram of a hardware configuration of a display apparatus 100 according to some embodiments.

FIG. 8 is a schematic diagram of a software system architecture of a display apparatus 100 according to some embodiments.

FIG. 9 is a block diagram of a hardware configuration of a scanned device 200 according to some embodiments.

FIG. 10 is a first schematic flowchart of a device control method according to some embodiments.

FIG. 11 is a first schematic diagram of a device management page of a display apparatus according to some embodiments.

FIG. 12 is a second schematic diagram of a device management page of a display apparatus according to some embodiments.

FIG. 13 is a second schematic flowchart of a device control method according to some embodiments.

FIG. 14 is a third schematic diagram of a device management page of a display apparatus according to some embodiments.

FIG. 15 is a fourth schematic diagram of a device management page of a display apparatus according to some embodiments.

FIG. 16 is a third schematic flowchart of a device control method according to some embodiments.

FIG. 17 is a fifth schematic diagram of a device management page of a display apparatus according to some embodiments.

FIG. 18 is a sixth schematic diagram of a device management page of a display apparatus according to some embodiments.

FIG. 19 is a flowchart illustrating device pairing display according to some embodiments.

FIG. 20 is a fourth schematic flowchart of a device control method according to some embodiments.

FIG. 21 is a schematic diagram of a broadcast display page of a display apparatus according to some embodiments.

FIG. 22 is a fifth schematic flowchart of a device control method according to some embodiments.

FIG. 23 is a sixth schematic flowchart of a device control method according to some embodiments.

FIG. 24 is a second schematic diagram of a scenario for a device control method according to some embodiments.

FIG. 25 is a block diagram of a hardware configuration of a control terminal 300 according to some embodiments.

FIG. 26 is a seventh schematic flowchart of a device control method according to some embodiments.

FIG. 27 is a schematic diagram of a sound settings page according to some embodiments.

FIG. 28 is a schematic diagram of another sound settings page according to some embodiments.

FIG. 29 is an eighth schematic flowchart of a device control method according to some embodiments.

FIG. 30 is a seventh schematic diagram of a device management page of a display apparatus according to some embodiments.

FIG. 31 is a ninth schematic flowchart of a device control method according to some embodiments.

FIG. 32 is an eighth schematic diagram of a device management page of a display apparatus according to some embodiments.

FIG. 33 is a first schematic diagram illustrating a configuration method for broadcasting BIS audio according to some embodiments.

FIG. 34 is a second schematic diagram illustrating a configuration method for broadcasting BIS audio according to some embodiments.

FIG. 35 is a third schematic diagram illustrating a configuration method for broadcasting BIS audio according to some embodiments.

FIG. 36 is a third schematic diagram of a scenario for a device control method according to some embodiments.

FIG. 37 is a fourth schematic diagram of a scenario for a device control method according to some embodiments.

FIG. 38 is a fifth schematic diagram of a scenario for a device control method according to some embodiments.

FIG. 39 is a ninth schematic flowchart of a device control method according to some embodiments.

FIG. 40 is a schematic diagram of an interface displaying an application identifier of a Bluetooth speaker application in a display apparatus according to some embodiments.

FIG. 41 is a schematic diagram of an interface for channel combination selection according to some embodiments.

FIG. 42 is a schematic diagram of an interface for audio output mode selection according to some embodiments.

FIG. 43 is a first schematic diagram of a setup interface for configuring a speaker combination according to some embodiments.

FIG. 44 is a schematic diagram of an interface for scanning audio receiving devices according to some embodiments.

FIG. 45 is a schematic diagram of a pairing interface according to some embodiments.

FIG. 46 is a schematic diagram of an interface showing configuration information after speaker configuration has been performed according to some embodiments.

FIG. 47 is a schematic diagram of an audio media resource playback interface according to some embodiments.

FIG. 48 is a schematic diagram of an interface for sound channel combination selection according to some embodiments.

FIG. 49 is a schematic diagram of another interface for sound channel combination selection according to some embodiments.

FIG. 50 is a schematic diagram of an interface for volume adjustment according to some embodiments.

FIG. 51 is a second schematic diagram of a setup interface for configuring a speaker combination according to some embodiments.

FIG. 52 is a schematic diagram of an interface for outputting prompt information according to some embodiments.

FIG. 53 is a schematic diagram of an interface showing setup success according to some embodiments.

FIG. 54 is a schematic diagram of an interface for channel and volume configuration according to some embodiments.

FIG. 55 is a schematic diagram of an interface showing configuration completion according to some embodiments.

FIG. 56 is a schematic diagram of an interface for volume adjustment according to some embodiments.

FIG. 57 is a tenth schematic flowchart of a device control method according to some embodiments.

FIG. 58 is a schematic diagram of an interface for triggering the launch of a broadcast assistant application according to some embodiments.

FIG. 59 is a schematic diagram illustrating a control terminal scanning for available Bluetooth speakers according to some embodiments.

FIG. 60 is a schematic diagram illustrating sound channel configuration for a connected Bluetooth speaker according to some embodiments.

FIG. 61 is a schematic diagram of an interface for volume adjustment via a control terminal according to some embodiments.

FIG. 62 is a schematic diagram of an interface for channel selection according to some embodiments.

FIG. 63 is a schematic diagram of an interface for setting a front left speaker according to some embodiments.

FIG. 64 is an eleventh schematic flowchart of a device control method according to some embodiments.

FIG. 65 is a schematic diagram of a hardware structure of an electronic device according to some embodiments.

### DETAILED DESCRIPTION

The display apparatus and the audio receiving device(s) provided in the disclosure can support Bluetooth Low Energy Audio (LE Audio) technology, where the display apparatus serves as an apparatus for audio playback or an apparatus for configuring audio receiving devices. In some embodiments, the display apparatus may be a television, mobile phone, projector, etc., and the audio receiving device may be a Bluetooth speaker, Bluetooth earphone, etc.

Compared to Classic Bluetooth, LE Audio can offer the following advantages.
1. One audio playback device can simultaneously connect with multiple audio receiving devices.
2. One broadcast audio device can transmit broadcast audio to an unlimited number of audio receiving devices, supporting encrypted broadcasting.
3. The latest Low Complexity Communication Codec (LC3) audio format is used, providing improved sound quality.
4. Voice over Internet Protocol (VoIP) and high-definition calling are supported.
5. Hearing aid/assistive listening applications are supported.

In the application layer specification of LE Audio, the Telephony and Media Audio Profile (TMAP) can define two types of media audio applications: unicast media audio and broadcast media audio.

### Unicast Media Audio

The unicast media audio in TMAP can adopt more advanced audio codecs compared to the current Classic Bluetooth media audio application specification (Advanced Audio Distribution Profile, A2DP) to provide better sound quality, while simultaneously offering richer control functions than the current Classic Bluetooth media playback control specification (Audio/Video Remote Control Profile, AVRCP). TMAP can define two roles for unicast media audio applications: Unicast Media Sender (UMS) and Unicast Media Receiver (UMR). Unicast media audio communication between UMS and UMR is achieved through Connected Isochronous Streams (CIS).

It should be noted that the unicast media audio defined in TMAP is not limited to one-to-one audio transmission; it can also support one unicast media sender transmitting unicast media audio to two unicast media receivers.

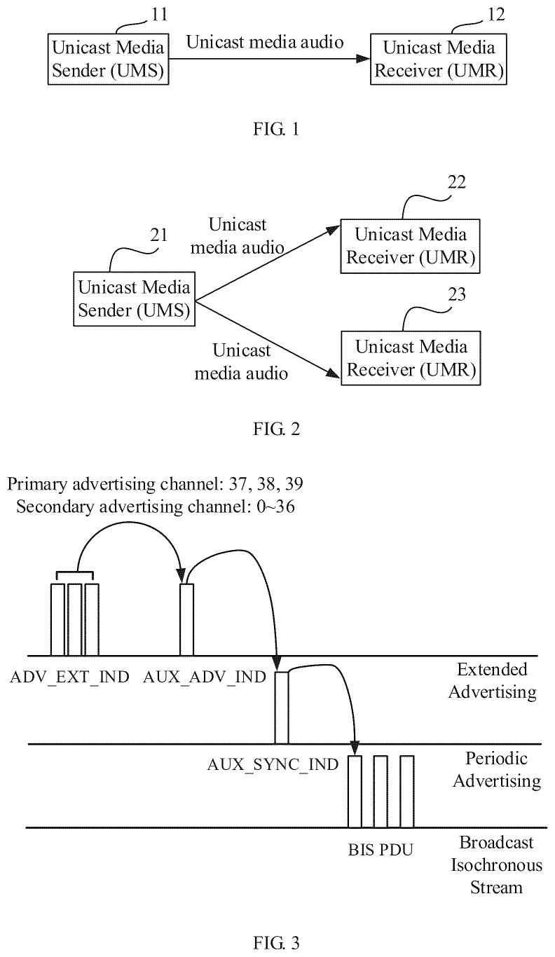

FIG. 1 is a schematic diagram of one-to-one audio transmission for unicast media audio in the related art. As shown in FIG. 1, UMS 11 transmits unicast media audio to UMR 12.

FIG. 2 is a schematic diagram of one-to-two audio transmission for unicast media audio in the related art. As shown in FIG. 2, UMS 21 transmits unicast media audio to UMR 22 and UMR 23, respectively.

### Broadcast Media Audio

The broadcast media audio in TMAP is based on the synchronous transmission of a plurality of connectionless Broadcast Isochronous Streams (BIS). The greatest advantage of broadcast media audio is its ability to synchronously transmit audio data to multiple audio receiving devices.

The broadcast synchronization channels for broadcast media audio in TMAP involve two concepts: Broadcast Isochronous Group (BIG) and BIS. One audio sending device can simultaneously transmit a plurality of BIGs. Each BIG can consist of a plurality of BISs, and one BIG can contain up to 31 BISs. Each BIS can have a unique Access Address. The Access Address of a BIS can be generated based on the Seed Access Address of the BIG it belongs to, using a unified algorithm.

Broadcast media audio can include various broadcasts with different access addresses. In some embodiments, these may include: Extended Advertising: this is extended advertising on the primary advertising channel. It can use ADV_EXT_IND packets and point to auxiliary advertising via time and frequency information. Its access address can use the primary advertising access address specified in the Bluetooth Core Specification: 0x8E89BED6;

Periodic Advertising: Auxiliary advertising can use AUX_ADV_IND packets and point to this periodic advertising via time, frequency hopping map, access address, etc. This periodic advertising can use AUX_SYNC_IND packets and include BIG information (BIGInfo); and

Broadcast Isochronous Stream (BIS): this refers to the BIS pointed to by periodic advertising via time, frequency hopping map, access address, and BIG information (BIGInfo). It can use BIS Protocol Data Unit (PDU) packets to broadcast digital audio.

FIG. 3 is a schematic diagram illustrating the relationship between extended advertising, periodic advertising, and BIS. It should be noted that Bluetooth operates in the 2.4 GHz band, which ranges from 2402 MHz to 2480 MHz, with one channel every 2 MHz, totaling 40 channels. 3 channels are primary advertising channels (channels 37, 38, and 39), and the remaining 37 channels are secondary advertising channels (channels 0 to 36). As shown in FIG. 3, the primary advertising channels can include channels 37, 38, and 39; the secondary advertising channels include channels 0 to 36. Extended advertising on the primary advertising channels uses ADV_EXT_IND packets and points to auxiliary advertising on the secondary advertising channels via time and frequency information. Subsequently, the auxiliary advertising can use AUX_ADV_IND packets to point to periodic advertising via time, frequency hopping map, and access address. Further, this periodic advertising can use AUX_SYNC_IND packets to point to the BIS via time, frequency hopping map, access address, and BIG information (BIGInfo). The BIS then uses BIS PDU packets to broadcast digital audio.

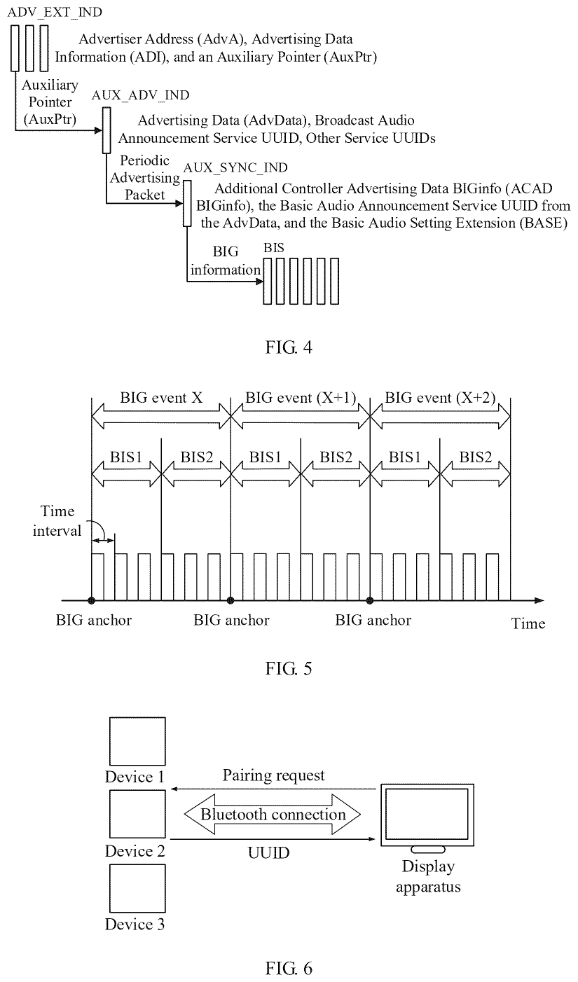

FIG. 4 is a schematic diagram illustrating the relationship between extended advertising packets, auxiliary advertising packets, periodic advertising packets, and BIS. As shown in FIG. 4, the audio sending device can transmit extended advertising packets (ADV_EXT_IND) on the primary advertising channels (37, 38, 39). The extended advertising packet can include: Advertiser Address (AdvA), Advertising Data Information (ADI), and an Auxiliary Pointer (AuxPtr). The AuxPtr indicates that auxiliary advertising will follow on the secondary advertising channels. The auxiliary advertising packet (AUX_ADV_IND) can include: Advertising Data (AdvData), Broadcast Audio Announcement Service UUID, Other Service UUIDs, and indicates the data channel and advertising period for the periodic advertising. The periodic advertising packet (AUX_SYNC_IND) can include: Additional Controller Advertising Data BIGinfo (ACAD BIGinfo), the Basic Audio Announcement Service UUID from the AdvData, and the Basic Audio Setting Extension (BASE). The periodic advertising packet can include all the information for the Broadcast Isochronous Stream (BIS). After receiving the periodic advertising packet, broadcast receivers can use the included data to receive BIS data on specific channels at specific time anchors, thereby obtaining the BIS audio stream.

In practical applications, while broadcasting digital audio via the BIS method, it can be implemented by continuously transmitting BIGs. Each transmission of a BIG can be referred to as a BIG event, and each BIG event can include a plurality of BISs.

FIG. 5 is a schematic diagram of continuously transmitting BIGs in the related art. As shown in FIG. 5, during the process of continuously transmitting BIGs, BIG events can be executed periodically and consecutively. The BIG anchors shown in FIG. 5 indicate the start time of each BIG event. The time interval between two anchors is the period for executing one BIG event. It should be noted that FIG. 5 uses an example of 3 BIG events, each containing 2 BISs. FIG. 5 can show the consecutive execution of BIG event X, BIG event (X+1), and BIG event (X+2), where each BIG event can include 2 BISs, shown as BIS1 and BIS2 in FIG. 5. During the execution of a BIG event, BISs are broadcast, and during the broadcasting of BIS, the BIS is broadcast at fixed time intervals.

The device control method in some embodiments can be implemented through a display apparatus and a device(s) scanned by the display apparatus. The display apparatus may be a mobile phone, television, computer, etc. The scanned device may be a speaker, earphone, keyboard, mouse, etc. The device control method provided in the embodiments of the disclosure can involve a pairing connection phase and a preset indicator display phase. The pairing connection phase can be implemented through the display apparatus and/or a control terminal. The control terminal may be a mobile terminal, such as a mobile phone, tablet computer, remote control, wearable device, or any other device capable of establishing a Bluetooth connection with a target device. Wearable devices may include smart watches, smart bands, etc.

FIG. 6 is a first schematic diagram of a scenario for a device control method according to some embodiments. As shown in FIG. 6, the scenario is described using an example where the display apparatus is a television, and the scanned devices are Device 1, Device 2, and Device 3. In the scenario, the television and Device 1, Device 2, and Device 3 are included. The television can control a Bluetooth communication module to perform device scanning and can control a display to show the scanned devices. Upon receiving a pairing request triggered for Device 2 (i.e., a target device), the television can establish a Bluetooth connection with Device 2, obtain the UUID of Device 2, and, upon determining based on the UUID of Device 2 that Device 2 supports the LE Audio protocol, can control the display to show an LE Audio identifier for Device 2.

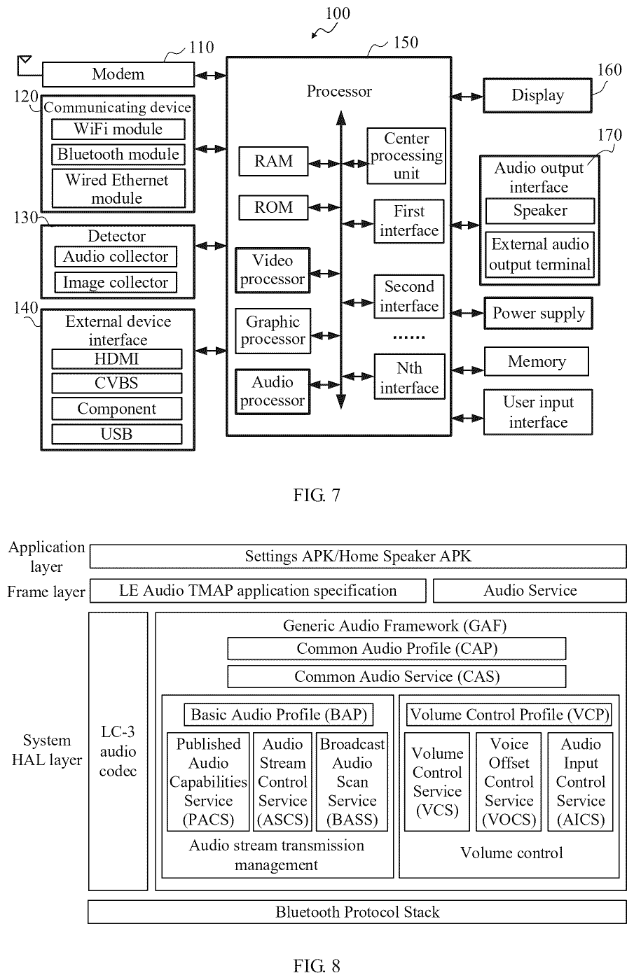

FIG. 7 is a block diagram of a hardware configuration of a display apparatus 100 according to some embodiments. As shown in FIG. 7, the display apparatus 100 can include: a modem 110, a communicating device 120, a detector 130, an external device interface 140, a processor 150, a display 160, an audio output interface 170, a memory, a power supply, etc. The processor 150 can include a central processing unit (CPU), a video processor, an audio processor, a graphics processing unit (GPU), Random Access Memory (RAM), Read-Only Memory (ROM), and first to nth interfaces for input/output. The display 160 can be at least one of a liquid crystal display, an OLED display, a touch display, or a projection display, and can also be a projection device and a projection screen. The modem 110 can receive broadcast television signals via wired or wireless means and demodulates audio and video signals, such as Electronic Program Guide (EPG) data signals, from multiple wireless or wired broadcast television signals. The detector 130 can be used to collect signals from the external environment or for interaction with the external environment. The processor 150 and the modem 110 can be located in different separate devices; that is, the modem 110 can also be in an external device of the main body device where the processor 150 is located, such as an external set-top box.

For the scenario shown in FIG. 6, when implementing the device control method according to some embodiments, the various components of the display apparatus 100 can perform the following functions.

In some embodiments, at least one processor is configured to execute computer instructions to cause the display apparatus to perform: controlling the Bluetooth communication module to perform device scanning and controlling the display to show the scanned devices; in response to a pairing request triggered for a target device among the scanned devices, establishing a Bluetooth connection with the target device and obtaining a Universally Unique Identifier (UUID) of the target device; where the UUID can be used to indicate whether the target device supports the Bluetooth Low Energy Audio (LE Audio) protocol; based on determining according to the UUID of the target device that the target device supports the LE Audio protocol, controlling the display to show a preset indicator for the target device; where the preset indicator can be used to indicate that the target device supports the LE Audio protocol.

During the process of establishing a Bluetooth connection with the target device, the aforementioned display apparatus can obtain the UUID of the target device. After determining based on the UUID that the target device supports the LE Audio protocol, it can display a preset indicator on the display apparatus, achieving the effect of showing the preset indicator for devices supporting the LE Audio protocol.

In some embodiments, the at least one processor is further configured to execute computer instructions to cause the display apparatus to perform: based on determining according to the UUID that the target device supports the LE Audio protocol, then controlling the display to show the preset indicator for the target device includes: based on determining according to the UUID and/or COD information of the target device that the target device supports the LE Audio protocol, controlling the display to show the preset indicator for the target device; where the COD information can be used to indicate whether the corresponding device is an audio receiving device that supports the LE Audio protocol.

In some embodiments, the at least one processor is further configured to execute computer instructions to cause the display apparatus to perform: before based on determining according to the UUID and/or the COD information of the target device that the target device supports the LE Audio protocol, then controlling the display to show the preset indicator for the target device, during the process of controlling the Bluetooth communication module to perform device scanning, obtaining the COD information of the scanned devices.

In some embodiments, the at least one processor is further configured to execute computer instructions to cause the display apparatus to perform: based on determining according to the UUID that the target device supports the LE Audio protocol, showing the preset indicator for the target device includes: during the process of establishing the Bluetooth connection with the target device, or after successfully establishing the Bluetooth connection with the target device, based on determining according to the UUID that the target device supports the LE Audio protocol, controlling the display to show the preset indicator for the target device.

In some embodiments, the at least one processor is further configured to execute computer instructions to cause the display apparatus to perform: in response to the pairing request triggered for the target device among the scanned devices, establishing the Bluetooth connection with the target device includes: in response to the pairing request triggered for the target device among the scanned devices, determining whether the target device is a dual-mode device; where the dual-mode device is an audio receiving device that supports both the Classic Bluetooth protocol and the Bluetooth Low Energy (BLE) protocol; based on determining that the target device is the dual-mode device, controlling the Bluetooth communication module to establish the Bluetooth connection with the target device based on the A2DP protocol.

In some embodiments, the at least one processor is further configured to execute computer instructions to cause the display apparatus to perform: after controlling the Bluetooth communication module to establish the Bluetooth connection with the target device based on the A2DP protocol, in response to a connection protocol switching command for the target device, controlling the Bluetooth communication module to disconnect the Bluetooth connection established based on the A2DP protocol, and controlling a local speaker to play audio data; controlling the Bluetooth communication module to establish the Bluetooth connection with the target device based on the LE Audio protocol, and controlling the local speaker to stop playing audio data, and synchronizing the audio data of the display apparatus to the target device through the Bluetooth connection established based on the LE Audio protocol.

In some embodiments, the at least one processor is further configured to execute computer instructions to cause the display apparatus to perform: in response to the pairing request triggered for the target device among the scanned devices, establishing the Bluetooth connection with the target device includes: in response to the pairing request triggered for the target device among the scanned devices, controlling the Bluetooth communication module to establish the Bluetooth connection with the target device based on the LE Audio protocol.

In some embodiments, the at least one processor is further configured to execute computer instructions to cause the display apparatus to perform: after controlling the Bluetooth communication module to establish the Bluetooth connection with the target device based on the LE Audio protocol in response to the pairing request triggered for the target device among the scanned devices, setting a UMS protocol state to an active state, and setting a BMS protocol state to an inactive state.

In some embodiments, the at least one processor is further configured to execute computer instructions to cause the display apparatus to perform: in response to a trigger operation for switching the current audio output channel to a Bluetooth broadcast audio output channel, switching the BMS protocol state to an active state, and switching the UMS protocol state to an inactive state.

FIG. 8 is a schematic diagram of a software system architecture of a display apparatus 100 according to some embodiments. As shown in FIG. 8, the software system may include: an Applications layer, an Application Framework layer (referred to as the “Framework layer”), a Hardware Abstraction Layer (HAL), and a Bluetooth protocol stack.

The Applications layer may include: a Settings application package (Android application package, APK) corresponding to a settings application, or a Home Speaker APK corresponding to a home speaker application. Both the Settings APK and the Home Speaker APK can be used to configure audio receiving devices, broadcast BIS streams, configure BIS identifiers corresponding to various audio receiving devices, and synchronize BIS streams as described in the embodiments of the disclosure.

The Application Framework layer may include: the LE Audio TMAP application specification and an Audio Service. The LE Audio TMAP is a technical specification for devices supporting LE Audio to implement globally universal various call and media applications. In the embodiments of the disclosure, the technical specifications for media applications within LE Audio TMAP can be used to configure audio receiving devices, broadcast BIS streams, and invoke the Broadcast Assistant Function (BASS, also known as Broadcast Audio Scan Service). The Audio Service can be responsible for receiving sound channel information configured by application(s). After the audio decoder (Decoder) can obtain the audio data by decoding, it can send the audio data to the Bluetooth communication module according to the configured sound channel information. The Bluetooth communication module then can broadcast the audio data, i.e., the BIS.

The System HAL layer may include the LC-3 audio codec, which is a low-complexity communication codec. In the embodiments of the disclosure, audio data transmitted into the Bluetooth protocol stack needs to be encoded by the LC-3 audio codec. The System HAL layer may also include the Generic Audio Framework (GAF). GAF may further include the Common Audio Profile (CAP), the Common Audio Service (CAS), audio stream transmission management, and volume control. The audio stream transmission management may include the Basic Audio Profile (BAP), the Published Audio Capabilities Service (PACS), the Audio Stream Control Service (ASCS), and the Broadcast Audio Scan Service (BASS). BASS is required for broadcast synchronization in the embodiments of the disclosure. Volume control may include: the Volume Control Profile (VCP), the Volume Control Service (VCS), the Voice Offset Control Service (VOCS), and the Audio Input Control Service (AICS). In the embodiments of the disclosure, when the display apparatus controls the display to show scanned devices and display the preset indicator for the target device, it can be implemented through services involved in the device pairing display.

The Bluetooth protocol stack can be responsible for scanning, connecting with, and configuring audio receiving devices, as well as configuring broadcasts and encoding audio.

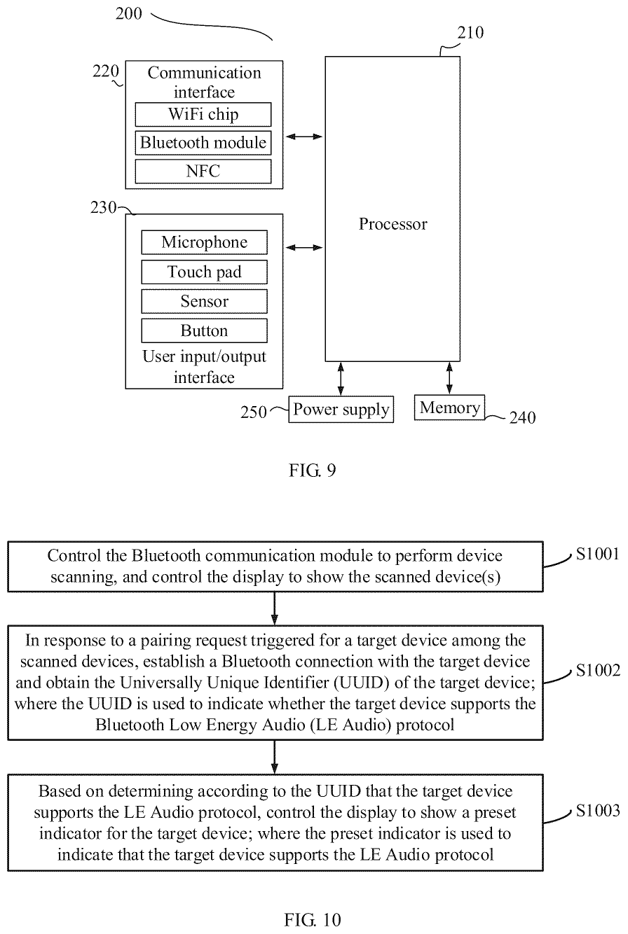

FIG. 9 is a block diagram of a hardware configuration of a scanned device 200 (i.e., an audio receiving device 200) according to some embodiments. As shown in FIG. 9, the device 200 may include: a processor 210, a communicating device 220, a user input/output interface 230, a memory 240, and a power supply 250. The communicating device 220 is used for external communication and can include at least one of a Wi-Fi chip, a Bluetooth communication module, NFC, or a substitutable module. The user input/output interface 230 can include at least one of a speaker, a microphone, a touchpad, a sensor, a button, or a substitutable module.

Corresponding to the scenario schematic shown in FIG. 6, embodiments of the disclosure provide a device control method as shown in FIG. 10 below. FIG. 10 is a first schematic flowchart of a device control method according to some embodiments. As shown in FIG. 10, the method may include, but is not limited to, the following steps S1001-S1003.

S1001: control the Bluetooth communication module to perform device scanning, and control the display to show the scanned device(s).

In some embodiments, upon entering the device management page, the display apparatus can automatically control the Bluetooth communication module to scan for nearby devices and can display the scanned devices on the device management page of the display.

The Bluetooth communication module can be used to interact with other devices supporting Bluetooth via the Bluetooth protocol. For example, the display apparatus can scan for other devices supporting Bluetooth through the Bluetooth communication module.

The scanned devices may include audio receiving devices supporting Bluetooth, such as earphones, speakers, etc., and may also include mice, keyboards, electronic pens, and other devices supporting Bluetooth.

As shown in FIG. 11, which is a first schematic diagram of a device management page of a display apparatus according to some embodiments, the list of scanned devices on this device management page can show the devices scanned this time, such as Device 3 and Device 4.

S1002: in response to a pairing request triggered for a target device among the scanned devices, establish a Bluetooth connection with the target device and obtain the Universally Unique Identifier (UUID) of the target device.

The UUID can be used to indicate whether the target device supports the Bluetooth Low Energy Audio (LE Audio) protocol.

In practical applications, because the UUIDs supporting the Classic Bluetooth protocol and the LE Audio protocol are different, the UUID can be used to indicate whether the target device's UUID is of the type that supports the LE Audio protocol. If the UUID is determined to be of the type supporting the LE Audio protocol, the target device can be considered to be a device supporting the LE Audio protocol.

In some embodiments, the target device can be any one of the devices scanned by the display apparatus.

In some embodiments, the Universally Unique Identifier (UUID) can be used to indicate the protocol types supported by the device, such as whether the device supports the Bluetooth Low Energy Audio (LE Audio) protocol or the Advanced Audio Distribution Profile (A2DP) protocol. In the embodiments of the disclosure, since the UUID can be used to indicate whether the target device supports the LE Audio protocol, after obtaining the UUID of the target device, it is possible to determine whether the target device supports the LE Audio protocol based on the UUID.

The pairing request triggered for the target device can be used to trigger the display apparatus to establish a Bluetooth connection with the target device and to obtain the UUID of the target device.

In some embodiments, the display apparatus can use the Session Description Protocol (SDP) or the Attribute Protocol (ATT) to obtain the UUID of the target device.

In some embodiments, the display apparatus may, upon receiving a user's pairing operation for the target device among the scanned devices, establish a Bluetooth connection with the target device and obtain the UUID of the target device. The pairing operation for the target device may include a click operation within an area for displaying the target device, etc.

As shown in FIG. 11, the display apparatus, in response to a pairing request triggered for Device 4 in the list of scanned devices, can establish a Bluetooth connection with Device 4 and can obtain the UUID of Device 4 to determine whether Device 4 supports the Bluetooth Low Energy Audio (LE Audio) protocol. The list of connected devices can show devices that have already established a Bluetooth connection with the display apparatus, and the list of scanned devices can show the devices scanned by the display apparatus this time.

S1003: based on determining according to the UUID that the target device supports the LE Audio protocol, control the display to show a preset indicator for the target device.

The preset indicator can be used to indicate that the target device supports the LE Audio protocol.

In the embodiments of the disclosure, after establishing a Bluetooth connection with the target device and obtaining the UUID of the target device, it is possible to determine based on the UUID whether the target device supports the Bluetooth Low Energy Audio (LE Audio) protocol. Based on determining that the target device supports the Bluetooth Low Energy Audio (LE Audio) protocol, a preset indicator can be displayed for the target device.

The preset indicator can be used to indicate that the target device supports the LE Audio protocol. A display style of the preset indicator can include text, icons, etc. For example, text “LE Audio” can be displayed in a position corresponding to the device supporting the LE Audio protocol.

As shown in FIG. 11, when the display apparatus receives a pairing request triggered for Device 4, it can establish a Bluetooth connection with Device 4 and obtain the UUID of Device 4. In some embodiments, the Bluetooth connection with Device 4 can be based on A2DP protocol.

In some embodiments, after the Bluetooth connection can be established with Device 4, Device 4 can be added into the list of connected devices.

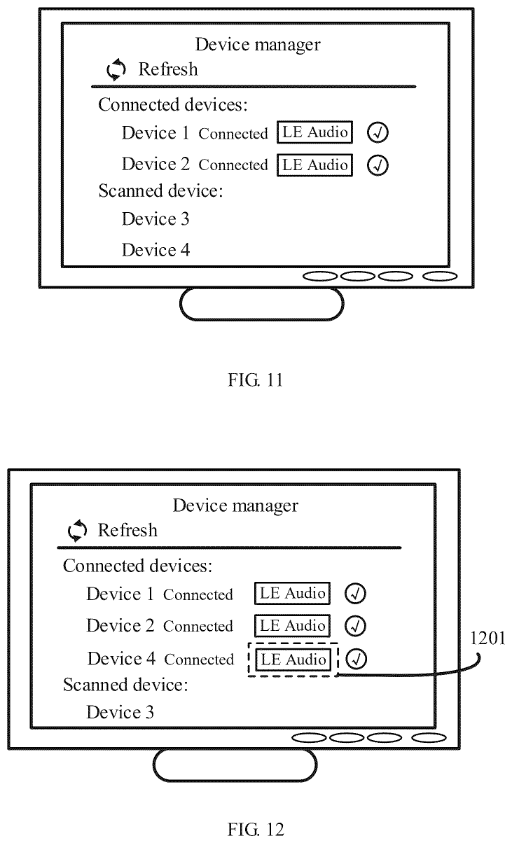

As shown in FIG. 12, which is a second schematic diagram of a device management page of a display apparatus according to some embodiments, the list of connected devices on this device management page can include Device 4. The devices, which are Device 1, Device 2, and Device 4, displayed in the list of connected devices are devices that have already established a Bluetooth connection with the display apparatus.

In some embodiments, based on determining according to the UUID that Device 4 supports the Bluetooth Low Energy Audio (LE Audio) protocol, it can control the display to show a preset indicator for Device 4. As shown in FIG. 12, the preset indicator 1201 can be displayed for Device 4.

In some embodiments, the preset indicator 1201, as shown in FIG. 12, can be a visual indicator.

In some embodiments, the preset indicator 1201 can be used to prompt the user that the Bluetooth connection can be switched to a Bluetooth connection based on LE audio protocol with the target device.

In some embodiments, a “Connected” text prompt and/or an icon prompt can also be displayed for connected devices, indicating that the device has completed pairing and connection with the display apparatus.

In some embodiments, during the display apparatus establishing a Bluetooth connection with the target device, i.e., before the connection is fully established, based on determining according to the UUID that the target device supports the LE Audio protocol, the display can be controlled to show the preset indicator for the target device.

In some embodiments, after the display apparatus has successfully established a Bluetooth connection with the target device, based on determining according to the UUID that the target device supports the LE Audio protocol, the display can be controlled to show the preset indicator for the target device.

In practical applications, since the manufacturers of the scanned devices may differ, different manufacturers might place the information used to indicate whether a device supports the LE Audio protocol or the A2DP protocol in different locations. For example, some manufacturers might place the information indicating whether the device supports LE Audio protocol in the UUID. The display apparatus can only determine whether the device supports the LE Audio protocol after obtaining its UUID. Other manufacturers might place the information indicating whether the device supports LE Audio protocol in the COD (Class of Device) information. The display apparatus can only determine whether the device supports the LE Audio protocol after obtaining its COD information.

In some embodiments, it is also possible to determine whether the target device supports the LE Audio protocol based on the target device's COD information and/or UUID. Based on determining according to at least one of the COD information or the UUID that the target device supports the LE Audio protocol, the display can be controlled to show the preset indicator for the target device.

Specifically, based on determining according to the COD information that the target device supports the LE Audio protocol, but determining according to the UUID that the target device does not support the LE Audio protocol, the preset indicator can be displayed for the target device. Based on determining according to both the COD information and the UUID that the target device supports the LE Audio protocol, the preset indicator can displayed for the target device. Based on determining according to the COD information that the target device does not support the LE Audio protocol, but determining according to the UUID that the target device supports the LE Audio protocol, the preset indicator can be displayed for the target device. Based on determining according to both the COD information and the UUID that the target device does not support the LE Audio protocol, the preset indicator is not displayed.

Here, the COD information can be used to indicate whether the corresponding device is an audio receiving device that supports the LE Audio protocol.

The Class of Device (COD) information can be used to identify type information of the device, such as earphones, keyboards, mice, etc.

In some embodiments, before step of based on determining according to the UUID and/or the COD information of the target device that the target device supports the LE Audio protocol, controlling the display to show the preset indicator for the target device, the COD information of the scanned devices can be obtained during the Bluetooth communication module scanning for nearby devices controlled by the display apparatus.

It is understandable that in the embodiments of the disclosure, the COD information of a device can be obtained during the display apparatus scanning the device. The UUID of the target device can be obtained during the display apparatus pairing and connecting with the target device.

In some embodiments, during the display apparatus establishing a Bluetooth connection with the target device (i.e., before the connection is fully established), based on determining according to the UUID and/or the COD information of the target device that the target device supports the LE Audio protocol, the display can be controlled to show the preset indicator for the target device.

In some embodiments, after the display apparatus has successfully established a Bluetooth connection with the target device, based on determining according to the UUID and/or the COD information of the target device that the target device supports the LE Audio protocol, the display can be controlled to show the preset indicator for the target device.

According to the device control method of some embodiments, first, the Bluetooth communication module can be controlled to perform device scanning, and the display can be controlled to show the scanned devices. Then, in response to a pairing request triggered for a target device among the scanned devices, a Bluetooth connection can be established with the target device, and the Universally Unique Identifier (UUID) of the target device can be obtained, where the UUID can be used to indicate whether the target device supports the Bluetooth Low Energy Audio (LE Audio) protocol. Furthermore, based on determining according to the UUID that the target device supports the LE Audio protocol, the display can be controlled to show a preset indicator for the target device, where the preset indicator can be used to indicate that the target device supports the LE Audio protocol. As can be seen, based on the embodiments of the disclosure, pairing and connection between the display apparatus and the target device can be realized, the target device's UUID can be obtained during the pairing process, and thereby enable the function of displaying an LE Audio identifier for devices supporting the LE Audio protocol.

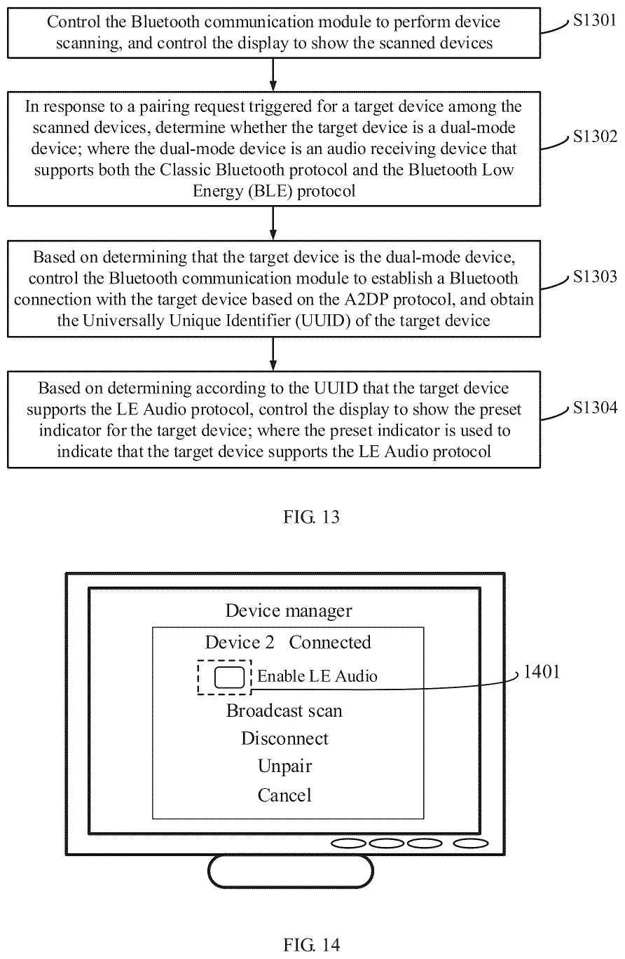

Corresponding to the scenario schematic shown in FIG. 6, embodiments of the disclosure provide a device control method as shown in FIG. 13 below. FIG. 13 is a second schematic flowchart of a device control method according to some embodiments. As shown in FIG. 13, the method may include, but is not limited to, the following steps S1301-S1305.

S1301: control the Bluetooth communication module to perform device scanning, and control the display to show the scanned devices.

S1302: in response to a pairing request triggered for a target device among the scanned devices, determine whether the target device is a dual-mode device.

Here, the dual-mode device is an audio receiving device that supports both the Classic Bluetooth protocol and the Bluetooth Low Energy (BLE) protocol.

In the embodiments, when the display apparatus can receive a pairing request triggered for a target device among the scanned devices, it first can determine whether the target device is a dual-mode device.

In the embodiments, a dual-mode device refers to a device that supports both the Classic Bluetooth protocol and the Bluetooth Low Energy (BLE) protocol. Correspondingly, a single-mode device refers to a device that supports a single Bluetooth protocol, e.g., only the Classic Bluetooth protocol or only the Bluetooth Low Energy (BLE) protocol.

In some embodiments, based on determining that the target device is a single-mode device supporting the Bluetooth Low Energy protocol, the Bluetooth communication module can be controlled to establish a Bluetooth connection with the target device based on the LE Audio protocol, and the preset indicator can be displayed for the target device. Based on determining that the target device is a single-mode device supporting the Classic Bluetooth protocol, the Bluetooth communication module can be controlled to establish a Bluetooth connection with the target device based on the A2DP protocol, and in this case, the preset indicator is not displayed.

S1303: based on determining that the target device is the dual-mode device, control the Bluetooth communication module to establish a Bluetooth connection with the target device based on the A2DP protocol, and obtain the Universally Unique Identifier (UUID) of the target device.

Here, the UUID can be used to indicate whether the target device supports the Bluetooth Low Energy Audio (LE Audio) protocol.

In practical applications, after determining that the target device is a dual-mode device, the Bluetooth communication module can be controlled to establish a Bluetooth connection with the target device based on the A2DP protocol.

S1304: based on determining according to the UUID that the target device supports the LE Audio protocol, control the display to show the preset indicator for the target device.

Here, the preset indicator can be used to indicate that the target device supports the LE Audio protocol.

In some embodiments, after the display apparatus can control the Bluetooth communication module to establish a Bluetooth connection with the target device based on the A2DP protocol, it can further, in response to a connection protocol switching command for the target device, control the Bluetooth communication module to disconnect the Bluetooth connection established based on the A2DP protocol and control the local speaker to play audio data.

In the embodiments, after determining that the target device is a dual-mode device and controlling the Bluetooth communication module to establish a Bluetooth connection with the target device based on the A2DP protocol, the display apparatus can, upon receiving a connection protocol switching command for the target device, control its local Bluetooth communication module to disconnect the Bluetooth connection established based on the A2DP protocol and control the local speaker to play audio data.

The connection protocol switching command for the target device may be issued based on a trigger operation on a preset control corresponding to the target device, such as a selection on an “Enable LE Audio” control, a deselection on the “Enable LE Audio” control, etc.

In some embodiments, during displaying connected devices on the device management page, in response to a selection on the target device among the connected devices from the user, a pop-up window corresponding to the target device can be displayed. This pop-up window may show an “Enable LE Audio” control. In response to a selection on the “Enable LE Audio” control, the display apparatus can control the Bluetooth communication module to disconnect the Bluetooth connection established with the target device based on the A2DP protocol and can control the local speaker to play audio data.

As shown in FIG. 12, the list of “Connected Devices” on this device management page can show three devices: Device 1, Device 2, and Device 4. The list of “Scanned Devices” (i.e., devices not yet paired/connected) can include Device 3. In response to a selection on Device 2 from the user, a pop-up window corresponding to Device 2 can be displayed on the current page.

As shown in FIG. 14, which is a third schematic diagram of a device management page of a display apparatus according to some embodiments, a pop-up window corresponding to Device 2 can be displayed on this page. In response to a selection on the “Enable LE Audio” control 1401, the display apparatus can control the Bluetooth communication module to disconnect the Bluetooth connection established with the target device based on the A2DP protocol and can control the local speaker to play audio data.

In some embodiments, the pop-up window corresponding to the target device can also display controls such as “Disconnect”, “Unpair”, “Cancel”, etc. The “Disconnect” control can be used to instruct the Bluetooth communication module to disconnect the Bluetooth connection with the target device. For example, when the “Enable LE Audio” control is in a deselected state, the display apparatus, upon receiving a trigger operation on the “Disconnect” control, can control the Bluetooth communication module to disconnect the Bluetooth connection established based on the A2DP protocol. When the “Enable LE Audio” control is in a selected state, the display apparatus, upon receiving a trigger operation on the “Disconnect” control, can control the Bluetooth communication module to disconnect the Bluetooth connection established based on the LE Audio protocol.

The “Unpair” control can be used to cancel the pairing connection between the display apparatus and the target device. After unpairing, if the user wants to re-establish a Bluetooth connection for the target device, a new pairing request for that target device needs to be triggered. The “Cancel” control can be used to close the pop-up window for the target device.

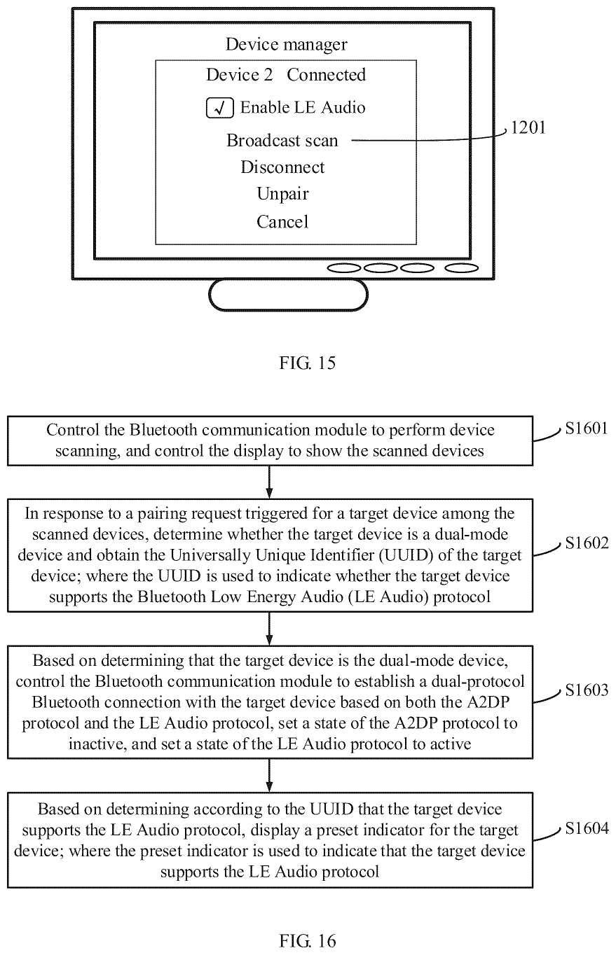

As shown in FIG. 15, which is a fourth schematic diagram of a device management page of a display apparatus according to some embodiments, the “Enable LE Audio” control on this page is in a selected state, indicating that the display apparatus has already established a Bluetooth connection with the target device based on the LE Audio protocol.

In some embodiments, after the display apparatus can control the Bluetooth communication module to establish a Bluetooth connection with the target device based on the A2DP protocol, it can broadcast audio data to the target device via the A2DP protocol, allowing the target device to play the received audio data based on its current playback mode.

In practical applications, when the display apparatus receives a connection protocol switching command for the target device, the target device might be playing audio data received via the A2DP protocol. Since audio data transmission might be interrupted during the protocol switching process, the display apparatus, while controlling its local Bluetooth communication module to disconnect the Bluetooth connection established with the target device based on the A2DP protocol, can also control its local speaker to play audio data, or control the local speaker to play audio data muted.

In some embodiments, during the display apparatus establishing a Bluetooth connection with the target device based on the A2DP protocol, since the A2DP protocol does not support the function of scanning for broadcasts for the target device, the broadcast scan control can remain in an inoperable state. As shown in FIG. 14, the broadcast scan control 1401 can be in an inoperable state.

In some embodiments, after the display apparatus controls the Bluetooth communication module to establish a Bluetooth connection with the target device based on the A2DP protocol, and upon receiving a trigger operation to switch the connection protocol for the target device to the LE Audio protocol, it can display the broadcast scan control in an operable state.

Here, the broadcast scan control can be used to scan for broadcasts for the target device. The broadcast scan control being in an operable state means the display apparatus can scan for broadcasts for the target device in response to a trigger operation on the broadcast scan control.

As shown in FIG. 14, in response to a selection on the “Enable LE Audio” control from the user, the broadcast scan control can be controlled to switch from an inoperable state to an operable state. As shown in FIG. 15, the “Enable LE Audio” control is in a selected state, and the broadcast scan control 1501 is in an operable state.

In some embodiments, while the broadcast scan control can be displayed in an operable state, upon receiving a trigger operation on this broadcast scan control, the display apparatus first can control the Bluetooth communication module to scan for broadcast signal source(s) and can display an identifier of at least one scanned broadcast signal source. Then, in response to a selection on a target identifier among the identifier of the at least one broadcast signal source, the display apparatus can determine a broadcast signal source corresponding to the target identifier as the target broadcast signal source. Furthermore, the display apparatus can control the Bluetooth communication module to send broadcast parameter information of the target broadcast signal source to the target device, enabling the target device to synchronously play the audio data transmitted by the target broadcast signal source based on the broadcast parameter information. The trigger operation on the broadcast scan control may include a click operation on this control, etc.

Here, the target broadcast signal source can be any broadcast signal source corresponding to an identifier among the broadcast signal source identifiers scanned by the display apparatus. The target device can be used to play the audio data transmitted by the target broadcast signal source.

In some embodiments, upon receiving a trigger operation on the broadcast scan control, the display apparatus can automatically launch a broadcast assistant application installed on the display apparatus. Furthermore, the display apparatus can scan for broadcast signal sources for the target device based on this broadcast assistant application.

In some embodiments, after the display apparatus can control the Bluetooth communication module to disconnect the Bluetooth connection established with the target device based on the A2DP protocol and can control the local speaker to play audio data, it can control the Bluetooth communication module to establish a Bluetooth connection with the target device based on the LE Audio protocol, can control the local speaker to stop playing audio data and synchronize the audio data from the display apparatus to the target device via the Bluetooth connection established based on the LE Audio protocol. Subsequently, the target device can play the received audio data.

According to the device control method of some embodiments, the display apparatus can control the Bluetooth communication module to perform device scanning and can control the display to show the scanned devices. In response to a pairing request triggered for a target device among the scanned devices, the display apparatus can determine whether the target device is a dual-mode device, where the dual-mode device supports both the Advanced Audio Distribution Profile (A2DP) protocol and the LE Audio protocol. Based on determining that the target device is a dual-mode device, the Bluetooth communication module can be controlled to establish a Bluetooth connection with the target device based on the A2DP protocol, and the UUID of the target device can be obtained, where the UUID can be used to indicate whether the target device supports the Bluetooth Low Energy Audio (LE Audio) protocol. Furthermore, based on determining according to the UUID that the target device supports the LE Audio protocol, the display can be controlled to show a preset indicator for the target device, where the preset indicator can be used to indicate that the target device supports the LE Audio protocol. That is, in the embodiments of the disclosure, pairing and connection between the display apparatus and the target device can be realized, and the target device's UUID can be obtained during the pairing process, thereby enabling the function of displaying an LE Audio identifier for devices supporting the LE Audio protocol.

In some embodiments, upon receiving a pairing request triggered for a target device among the scanned devices, the Bluetooth communication module can further be controlled to establish a Bluetooth connection with the target device based on the LE Audio protocol.

In practical applications, in the LE Audio application layer specification, the Telephony and Media Audio Profile (TMAP) can define two media audio applications: unicast media audio and broadcast media audio. For unicast media audio, a Unicast Media Sender (UMS) and a Unicast Media Receiver (UMR) can be used. For broadcast media audio, a Broadcast Media Sender (BMS) and a Broadcast Media Receiver (BMR) can be used. The UMS and the BMS are mutually exclusive; that is, the audio output channel of a Bluetooth device cannot be in a unicast state and a broadcast state simultaneously.

In some embodiments, since the audio output channel of the target device cannot be in the unicast state and the broadcast state simultaneously, after controlling the Bluetooth communication module to establish a Bluetooth connection with the target device based on the LE Audio protocol, the UMS protocol state (i.e., unicast state) can be set to an active state, and the BMS protocol state (i.e., broadcast state) can be set to an inactive state.

In some embodiments, upon receiving a trigger operation to switch the current audio output channel to a Bluetooth broadcast audio data channel, the BMS protocol state can be switched to an active state, and the UMS protocol state can be set to an inactive state.

In practical applications, after setting the BMS protocol state of the display apparatus to the active state, the display apparatus can enter the broadcast state. Its own broadcast parameter information can be obtained and further sent to the target audio receiving device, enabling the target audio receiving device to synchronously play the audio data transmitted by the target broadcast signal source based on the broadcast parameter information.

Here, the current audio output channel may include the local speaker output channel, USB audio output channel, HDMI output channel, etc.

Broadcast parameter information may include address type, device address, broadcast source address, broadcast packet cluster ID, broadcast ID information, synchronization interval, encryption status, broadcast code, rendering delay time, SUB GROUP information, Android version information, etc.

Corresponding to the scenario schematic shown in FIG. 6, embodiments of the disclosure provide a device control method as shown in FIG. 16 below. FIG. 16 is a third schematic flowchart of a device control method according to some embodiments. As shown in FIG. 16, the method may include, but is not limited to, the following steps S1601-S1604.

S1601: control the Bluetooth communication module to perform device scanning, and control the display to show the scanned devices.

S1602: in response to a pairing request triggered for a target device among the scanned devices, determine whether the target device is a dual-mode device and obtain the Universally Unique Identifier (UUID) of the target device; where the UUID can be used to indicate whether the target device supports the Bluetooth Low Energy Audio (LE Audio) protocol.

Here, the dual-mode device can be an audio receiving device that supports both the Classic Bluetooth protocol and the Bluetooth Low Energy (BLE) protocol.

S1603: based on determining that the target device is the dual-mode device, control the Bluetooth communication module to establish a dual-protocol Bluetooth connection with the target device based on both the A2DP protocol and the LE Audio protocol, set a state of the A2DP protocol to inactive, and set a state of the LE Audio protocol to active.

In practical applications, the built-in Bluetooth communication module of the display apparatus can establish a dual-protocol Bluetooth connection with the target device based on both the A2DP protocol and the LE Audio protocol. However, within a successfully established dual-protocol connection, one of Bluetooth connections can be in the active state. Therefore, after controlling the Bluetooth communication module to establish the dual-protocol Bluetooth connection with the target device based on both the A2DP and LE Audio protocols, the display apparatus must determine which connection will be active.

The active Bluetooth connection can allow audio data generated by applications on the display apparatus to be sent to the target device via the Bluetooth connection for playback by the target device. The inactive Bluetooth connection cannot allow the display apparatus's audio data to be sent to the target device.

In some embodiments, if the state of the A2DP protocol can be set to active and the state of the LE Audio protocol can be set to inactive, audio data can be sent to the target device based on the A2DP protocol. Conversely, if the state of the A2DP protocol can be set to inactive and the state of the LE Audio protocol can be set to active, audio data can be sent to the target device based on the LE Audio protocol. The target device can be used to play the received audio data.

S1604: based on determining according to the UUID that the target device supports the LE Audio protocol, display a preset indicator for the target device; where the preset indicator can be used to indicate that the target device supports the LE Audio protocol.

In some embodiments, after the display apparatus can control the Bluetooth communication module to establish a Bluetooth connection with the target device based on both the A2DP protocol and the LE Audio protocol and determines one connection to be in the active state, it can further, in response to a connection protocol switching command for the target device, update the active Bluetooth connection and send audio data to the target device based on the active Bluetooth connection. The connection protocol switching command for the target device may be issued based on a trigger operation on a preset control corresponding to the target device, such as a selection on the “Enable LE Audio” control or a deselection on the “Enable LE Audio” control.

In practical applications, based on determining that the active Bluetooth connection can be established based on the A2DP protocol, upon receiving a connection protocol switching command for the target device, the Bluetooth connection based on the A2DP protocol can be switched from active to inactive, and the Bluetooth connection based on the LE Audio protocol can be updated to active. Audio data can be sent to the target device based on the LE Audio protocol.

Based on determining that the active Bluetooth connection can be established with the target device based on the LE Audio protocol, upon receiving a connection protocol switching command for the target device, the Bluetooth connection based on the LE Audio protocol can be switched from active to inactive, and the Bluetooth connection based on the A2DP protocol can be updated to active. Audio data then can be sent to the target device based on the A2DP protocol.

In some embodiments, during displaying connected devices on the device management page, in response to a selection on the target device among the connected devices from the user, a pop-up window corresponding to the target device can be displayed. This pop-up window may show an “Enable LE Audio” control.

Based on determining that the current active Bluetooth connection can be established with the target device based on the A2DP protocol, the “Enable LE Audio” control in the pop-up window can be, by default, in a deselected state. Upon receiving a connection protocol switching command for the target device, the display apparatus can update the Bluetooth connection based on the LE Audio protocol to active and send audio data to the target device based on the LE Audio protocol.

Based on determining that the current active Bluetooth connection can be established with the target device based on the LE Audio protocol, the “Enable LE Audio” control in the pop-up window can be, by default, in a selected state. In response to a deselection on the “Enable LE Audio” control from the user, the display apparatus can update the Bluetooth connection based on the A2DP protocol to active and send audio data to the target device based on the A2DP protocol.

In some embodiments, after controlling the Bluetooth communication module to establish a Bluetooth connection with the target device based on the A2DP protocol, and upon receiving a trigger operation to switch the connection protocol for the target device to the LE Audio protocol, the display apparatus can display the broadcast scan control in an operable state.

Here, the broadcast scan control can be used to scan for broadcasts for the target device. The broadcast scan control being in an operable state means the display apparatus can scan for broadcasts for the target device in response to a trigger operation on the broadcast scan control.

As shown in FIG. 14, the broadcast scan control is in an inoperable state. In response to a selection on the “Enable LE Audio” control from the user, the broadcast scan control can be controlled to switch from the inoperable state to an operable state. As shown in FIG. 15, the broadcast scan control 1501 is in an operable state.

In some embodiments, while the broadcast scan control is in an operable state, the display apparatus can receive a user trigger operation on the broadcast scan control. Upon receiving the trigger operation on the broadcast scan control, the display apparatus first can control the Bluetooth communication module to scan for broadcast signal sources and can display the identifier(s) of at least one scanned broadcast signal source. Then, the display apparatus can control the Bluetooth communication module to send the audio data from the target broadcast signal source among the scanned broadcast signal sources to the target device.

Here, the target broadcast signal source can be any broadcast signal source among those scanned by the display apparatus. The target device can be used to play the audio data from the target broadcast signal source.

That is, in the device control method provided by the disclosure, the display apparatus can control the Bluetooth communication module to perform device scanning and can display the scanned devices. In response to a pairing request triggered for a target device among the scanned devices, the display apparatus can determine whether the target device is a dual-mode device, where the dual-mode device supports both the Advanced Audio Distribution Profile (A2DP) protocol and the LE Audio protocol. Based on determining that the target device is a dual-mode device, the Bluetooth communication module can be controlled to establish a Bluetooth connection with the target device based on the A2DP protocol, and the UUID of the target device can be obtained, where the UUID can be used to indicate whether the target device supports the Bluetooth Low Energy Audio (LE Audio) protocol. Furthermore, based on determining that the target device is a dual-mode device, the Bluetooth communication module can be controlled to establish a dual-protocol Bluetooth connection with the target device based on both the A2DP protocol and the LE Audio protocol, the state of the A2DP protocol can be set to inactive, and the state of the LE Audio protocol can be set to active. Based on determining according to the UUID that the target device supports the LE Audio protocol, a preset indicator can be displayed for the target device, where the preset indicator can be used to indicate that the target device supports the LE Audio protocol. According to the embodiments of the disclosure, the pairing and connection between the display apparatus and the target device can be realized, and the target device's UUID can be obtained during the pairing process, thereby enabling the function of displaying an LE Audio identifier for devices supporting the LE Audio protocol.

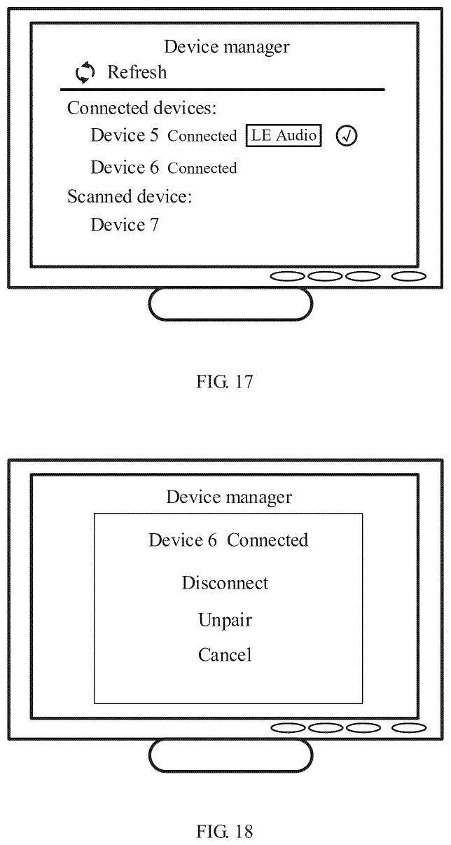

As shown in FIG. 17, which is a fifth schematic diagram of a device management page of a display apparatus according to some embodiments, the page can display a “Connected Devices” list and a “Scanned Devices” list. The “Connected Devices” list can include Device 5, which supports the LE Audio protocol, and Device 6, which does not support the LE Audio protocol. The “Scanned Devices” list can include Device 7, which is currently scanned by the display apparatus. Here, Device 6 is a single-mode device that does not support the LE Audio protocol.

Upon receiving a trigger operation for Device 6, a pop-up window corresponding to Device 6 can be displayed on the current page. As shown in FIG. 18, which is a sixth schematic diagram of a device management page of a display apparatus according to some embodiments, the page can display a pop-up window corresponding to Device 6. This pop-up window may show controls such as “Disconnect”, “Unpair”, and “Cancel”.

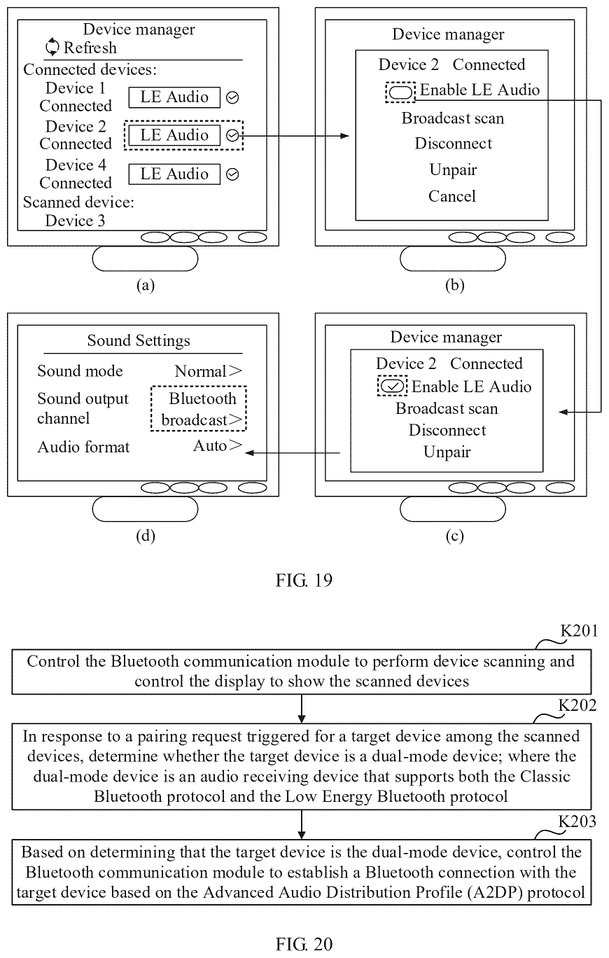

Based on the above method embodiments, the disclosure further provides a display flowchart for device pairing, specifically using a television as an example to describe the display process executed by the display apparatus during device pairing. As shown in FIG. 19, it is a display flowchart of device pairing according to some embodiments.

In practical applications, upon entering the device management page, the display apparatus automatically can control the Bluetooth communication module to scan for nearby devices and can display the identifiers of the scanned devices on the device management page. As shown in FIG. 19(A), the device management page can display Device 3 scanned this time.

During the process of displaying the identifiers of the scanned devices on the device management page, in response to a pairing request triggered for a target device among the scanned devices, the display apparatus can determine whether the target device supports the LE Audio protocol based on the target device's COD information and/or UUID information. Based on determining that the target device supports the LE Audio protocol, a preset indicator can be displayed for the target device on the device management page, and the Bluetooth communication module can be controlled to establish a Bluetooth connection with the target device based on the A2DP protocol. As shown in FIG. 19(A), Device 1, Device 2, and Device 4 displayed on the device management page all support the LE Audio protocol and the preset indicators can be displayed for them respectively.

During the process of displaying the preset indicator for devices supporting the LE Audio protocol on the device management page, in response to a connection protocol switching command for the target device, the Bluetooth communication module can be controlled to disconnect the Bluetooth connection established with the target device based on the A2DP protocol, and the local speaker can be controlled to play audio data (muted). Furthermore, the Bluetooth communication module can be controlled to establish a Bluetooth connection with the target device based on the LE Audio protocol and the BSA protocol, the local speaker can be controlled to stop playing audio data, and the audio data of the display apparatus can be synchronized to the target device via the Bluetooth channel established based on the LE Audio protocol.

As shown in FIG. 19(A), during the process of displaying devices supporting the LE Audio protocol in the list of connected devices on the device management page, in response to a selection on Device 2 from the user, a pop-up window corresponding to Device 2 can be displayed on the current page. As shown in FIG. 19(B), the page can display a pop-up window corresponding to Device 2. In response to a selection on the “Enable LE Audio” control from the user, the Bluetooth communication module can be controlled to disconnect the Bluetooth connection established with Device 2 based on the A2DP protocol, and the local speaker can be controlled to play audio data (muted).

Furthermore, after controlling the Bluetooth communication module to establish a Bluetooth connection with the target device based on the LE Audio protocol and synchronizing the audio data of the display apparatus to the target device via the Bluetooth channel established based on the LE Audio protocol, the broadcast scan control can be controlled to switch from an inoperable state to an operable state. As shown in FIG. 19(C), the “Enable LE Audio” control is in a selected state, indicating that the display apparatus has established a Bluetooth connection with the target device based on the LE Audio protocol, and the broadcast scan control is in an operable state.

In practical applications, during the process of displaying the broadcast scan control in an operable state, in response to a trigger operation on the broadcast scan control, the Bluetooth communication module can be controlled to scan for broadcast signal sources, and the display can be controlled to show the identifiers of the scanned broadcast signal sources.

In some embodiments, assuming the display apparatus is a television, when the television can receive a trigger operation on the broadcast scan control in an operable state, it can control its own Bluetooth communication module to scan for broadcast signal sources, or scans for broadcast signal sources based on a broadcast assistant application. After scanning at least one broadcast signal source, the display apparatus can display the scanned at least one broadcast signal source on the television's display.

In some embodiments, during the process of controlling the display to show the identifiers of the scanned broadcast signal sources, in response to a selection on a target identifier among the identifiers of the scanned broadcast signal sources, the broadcast parameter information of the broadcast signal source corresponding to the target identifier can be sent to the target device, enabling the target device to play the audio data transmitted by the broadcast source based on the broadcast parameter information.

In some embodiments, if the display apparatus's own broadcast source is also broadcasting, the display apparatus's broadcast identifier (i.e., the identifier of the local broadcast) can also be displayed on the broadcast display interface. In response to a selection on the local broadcast identifier, the broadcast parameter information of the local broadcast can be sent to the target device, enabling the target device to synchronously play the local broadcast based on the broadcast parameter information.

In some embodiments, after switching the target device's connection protocol to the LE Audio protocol, establishing a Bluetooth connection with the target device based on the UMS protocol and the BSA protocol can be prioritized by default.

In practical applications, in the LE Audio application layer specification, the Telephony and Media Audio Profile (TMAP) can define two media audio applications: unicast media audio and broadcast media audio. For unicast media audio, a Unicast Media Sender (UMS) and a Unicast Media Receiver (UMR) can be used. For broadcast media audio, a Broadcast Media Sender (BMS) and a Broadcast Media Receiver (BMR) can be used.

Since the UMS and the BMS are mutually exclusive and cannot be active simultaneously, on the sound settings page, in response to a trigger operation to switch the current audio output channel (e.g., the Bluetooth channel established based on the UMS protocol) to the Bluetooth broadcast output channel, the UMS protocol state can be updated to inactive, and the BMS protocol state can be updated to active.

In practical applications, after setting the BMS protocol state of the display apparatus to active and obtaining the broadcast parameter information of the display apparatus, the broadcast parameter information of the display apparatus can be sent to the target device via the Bluetooth connection established with the target device based on the BSA protocol, enabling the target device to synchronously play the audio data transmitted by the display apparatus based on the broadcast parameter information.

As shown in FIG. 19(D), it is a schematic diagram of a sound settings page after switching to the Bluetooth broadcast output channel according to some embodiments.

As can be seen, in the embodiments of the disclosure, when switching to the Bluetooth broadcast output channel, the broadcast parameter information of the display apparatus can be sent to the target device via the Bluetooth channel established with the target device based on the BSA protocol, enabling the target device to synchronously play the audio data of the display apparatus based on the broadcast parameter information. This allows the display apparatus to realize the function of switching from the current audio output channel to the Bluetooth broadcast output channel.

Furthermore, in the disclosure, pairing and connection can be realized between the display apparatus and dual-mode devices that support both the Classic Bluetooth protocol and the Low Energy Bluetooth protocol. Using the scenario shown in FIG. 6 as an example, while implementing the device control method according to some embodiments, the various components of the display apparatus 100 can also perform the following functions.

In some embodiments, at least one processor is further configured to execute computer instructions to cause the display apparatus to perform: controlling the Bluetooth communication module to perform device scanning and controlling the display to show the scanned devices; in response to a pairing request triggered for a target device among the scanned devices, determining whether the target device is a dual-mode device; where the dual-mode device is an audio receiving device that supports both the Classic Bluetooth protocol and the Low Energy Bluetooth protocol; based on determining that the target device is the dual-mode device, controlling the Bluetooth communication module to establish a Bluetooth connection with the target device based on the Advanced Audio Distribution Profile (A2DP) protocol.

In some embodiments, at least one processor is further configured to execute computer instructions to cause the display apparatus to perform: after controlling the Bluetooth communication module to establish a Bluetooth connection with the target device based on the A2DP protocol, in response to a connection protocol switching command for the target device, controlling the Bluetooth communication module to disconnect the Bluetooth connection established based on the A2DP protocol and controlling a local speaker to play audio data; controlling the Bluetooth communication module to establish a Bluetooth connection with the target device based on the LE Audio protocol, and controlling the local speaker to stop playing audio data, and synchronizing the audio data of the display apparatus to the target device via the Bluetooth connection established based on the LE Audio protocol.

In some embodiments, at least one processor is further configured to execute computer instructions to cause the display apparatus to perform: while controlling the local speaker to play audio data, controlling the local speaker to play audio data in a muted manner.

In some embodiments, at least one processor is further configured to execute computer instructions to cause the display apparatus to perform: after controlling the Bluetooth communication module to establish a Bluetooth connection with the target device based on the A2DP protocol, in response to a connection protocol switching command for the target device, controlling the Bluetooth communication module to establish a dual-protocol Bluetooth connection with the target device based on both the A2DP protocol and the LE Audio protocol, setting the state of the A2DP protocol to inactive, and setting the state of the LE Audio protocol to active; where the LE Audio protocol in the active state is used in synchronizing the audio data of the display apparatus to the target device.

In some embodiments, at least one processor is further configured to execute computer instructions to cause the display apparatus to perform: after controlling the Bluetooth communication module to establish a Bluetooth connection with the target device based on the A2DP protocol, in response to a connection protocol switching command for the target device, controlling the display to show a broadcast scan control in an operable state; where the broadcast scan control can be used to trigger scanning for broadcast signal sources for the target device.

In some embodiments, at least one processor is further configured to execute computer instructions to cause the display apparatus to perform: in response to a trigger operation on the broadcast scan control, controlling the Bluetooth communication module to scan for broadcasts and controlling the display to show the identifier(s) of the scanned broadcast signal source(s); in response to a selection on a target identifier among the identifiers of the scanned broadcast signal sources, sending the broadcast parameter information of the broadcast signal source corresponding to the target identifier to the target device, enabling the target device to play the audio data transmitted by the broadcast signal source based on the broadcast parameter information.

In some embodiments, at least one processor is further configured to execute computer instructions to cause the display apparatus to perform: in response to a pairing request triggered for a target device among the scanned devices, determining whether the target device supports the LE Audio protocol based on the COD information and/or UUID information of the target device; based on determining that the target device supports the LE Audio protocol, controlling the display to show a preset indicator for the target device; where the preset indicator can be used to indicate that the target device supports the LE Audio protocol.

In some embodiments, at least one processor is further configured to execute computer instructions to cause the display apparatus to perform: after controlling the Bluetooth communication module to establish a Bluetooth connection with the target device based on the LE Audio protocol, in response to a trigger operation for switching the current audio output channel to a Bluetooth broadcast output channel, controlling the UMS protocol state to switch to an inactive state and controlling the BMS protocol state to switch to an active state; sending the broadcast parameter information of the display apparatus to the target device, enabling the target device to synchronously play the audio data transmitted by the display apparatus based on the broadcast parameter information.

FIG. 20 is a fourth schematic flowchart of a device control method according to some embodiments. As shown in FIG. 20, the method may include, but is not limited to, the following steps K201-K203.

K201: control the Bluetooth communication module to perform device scanning and control the display to show the scanned devices.

In some embodiments, upon entering the device management page, the display apparatus can automatically control the Bluetooth communication module to scan for nearby devices and can display the scanned devices on the device management page.

The Bluetooth communication module can be used to interact with other devices supporting Bluetooth via the Bluetooth protocol. For example, the display apparatus can scan for other devices supporting Bluetooth through the Bluetooth communication module.

The scanned devices may include audio receiving devices supporting Bluetooth, such as earphones, speakers, etc., and may also include mice, keyboards, electronic pens, and other devices supporting Bluetooth.

K202: in response to a pairing request triggered for a target device among the scanned devices, determine whether the target device is a dual-mode device; where the dual-mode device is an audio receiving device that supports both the Classic Bluetooth protocol and the Low Energy Bluetooth protocol.

In the embodiments, when the display apparatus receives a pairing request triggered for a target device among the scanned devices, it can first determine whether the target device is a dual-mode device.

In the embodiments, a dual-mode device refers to an audio receiving device that supports both the Classic Bluetooth protocol and the Low Energy Bluetooth protocol. Correspondingly, a single-mode device refers to an audio receiving device that supports a single Bluetooth protocol, e.g., an audio receiving device that only supports the Classic Bluetooth protocol.

In practical applications, because dual-mode devices can transmit broadcast protocol packets outward, and these packets carry field information identifying the device as a dual-mode device, while the display apparatus is in a scanning state and scans a broadcast protocol packet sent by a device, it can determine based on the field information carried in the broadcast protocol packet that the device is an audio receiving device that supports both the Classic Bluetooth protocol and the Low Energy Bluetooth protocol.

In some embodiments, when the display apparatus can receive a pairing request triggered for a target device among the scanned devices, it can also determine that the target device is a dual-mode device based on the field information carried in the target device's broadcast protocol packet. For example, if the target device's broadcast protocol packet carries field information of supporting BR/EDR, it can be determined that the target device is a dual-mode device supporting both the Classic Bluetooth protocol and the Low Energy Bluetooth protocol.

Furthermore, for single-mode devices that only support the Classic Bluetooth protocol, since these devices can transmit inquiry command packets outward, while the display apparatus is in a scanning state and scans an inquiry command packet sent by a device, it can determine based on the inquiry command packet that the device is a single-mode device that supports only the Classic Bluetooth protocol.

K203: based on determining that the target device is the dual-mode device, control the Bluetooth communication module to establish a Bluetooth connection with the target device based on the Advanced Audio Distribution Profile (A2DP) protocol.

In the LE Audio application layer specification, the Telephony and Media Audio Profile (TMAP) can define two media audio applications: unicast media audio and broadcast media audio. For unicast media audio, a Unicast Media Sender (UMS) and a Unicast Media Receiver (UMR) can be used. For broadcast media audio, a Broadcast Media Sender (BMS) and a Broadcast Media Receiver (BMR) can be used. In practical applications, the UMS and the BMS are mutually exclusive; that is, the audio output channel of a Bluetooth device cannot be in both unicast state and broadcast state simultaneously.

In some embodiments, since the audio output channel of the target device cannot be in both unicast and broadcast states simultaneously, after controlling the Bluetooth communication module to establish a Bluetooth connection with the target device based on the LE Audio protocol, upon receiving a trigger operation to switch the current audio data channel to the Bluetooth broadcast output channel, the BMS protocol state can be controlled to switch to an active state, and the UMS protocol state can be controlled to be set to an inactive state.

In practical applications, after setting the BMS protocol state of the display apparatus to active, the display apparatus can enter the broadcast state. The broadcast parameter information of the display apparatus can be obtained at this time and further sent to the target device, enabling the target device to synchronously play the audio data transmitted by the display apparatus based on the broadcast parameter information.

Here, the current audio output channel may include the local speaker audio output channel, USB audio output channel, HDMI audio output channel, etc.

Broadcast parameter information may include address type, device address, broadcast source address, broadcast packet cluster ID, broadcast ID information, synchronization interval, encryption status, broadcast code, rendering delay time, SUB GROUP information, Android version, etc. After receiving the broadcast parameters from the display apparatus, the target device can synchronously play the audio data transmitted by the applications on the display apparatus based on the broadcast parameter information.

According to the device control method of some embodiments, first, the Bluetooth communication module can be controlled to perform device scanning, and the display can be controlled to show the scanned devices. Then, in response to a pairing request triggered for a target device among the scanned devices, it can be determined whether the target device is a dual-mode device; where the dual-mode device is an audio receiving device that supports both the Classic Bluetooth protocol and the Low Energy Bluetooth protocol. Based on determining that the target device is the dual-mode device, the Bluetooth communication module can be controlled to establish a Bluetooth connection with the target device based on the Advanced Audio Distribution Profile (A2DP) protocol. That is, based on the embodiments of the disclosure, pairing and connection between the display apparatus and audio receiving devices that support both the Classic Bluetooth protocol and the Low Energy Bluetooth protocol can be realized.

In some embodiments, after controlling the Bluetooth communication module to establish a Bluetooth connection with the target device based on the A2DP protocol, it can also, in response to a connection protocol switching command for the target device, control the Bluetooth communication module to disconnect the Bluetooth connection established based on the A2DP protocol and control the local speaker to play audio data.

The connection protocol switching command for the target device may be issued based on a trigger operation on a preset control corresponding to the target device, such as a selection on the “Enable LE Audio” control or a deselection on the “Enable LE Audio” control.

In some embodiments, during the process of displaying connected devices on the device management page, in response to a selection on the target device among the connected devices from the user, a pop-up window corresponding to the target device can be displayed. This pop-up window may show an “Enable LE Audio” control. In response to a selection on the “Enable LE Audio” control, the display apparatus can control the Bluetooth communication module to disconnect the Bluetooth connection established with the target device based on the A2DP protocol and can control the local speaker to play audio data.

As mentioned earlier in FIG. 12, the list of connected devices on this device management page can show Device 1, Device 2, and Device 4, which have already established Bluetooth connections with the display apparatus. In response to a selection on Device 2, a pop-up window corresponding to Device 2 can be displayed on the current page. Based on this, after the display apparatus of this embodiment can control the Bluetooth communication module to establish a Bluetooth connection with the target device based on the A2DP protocol, it can broadcast audio data to the target device based on the A2DP protocol, allowing the target device to play the received audio data based on its current playback mode.

In practical applications, when the display apparatus receives a connection protocol switching command for the target device, the target device might be playing audio data received via the A2DP protocol. Since audio data transmission might be interrupted during the protocol switching process, the display apparatus, while controlling its local Bluetooth communication module to disconnect the Bluetooth connection established with the target device based on the A2DP protocol, can also control its local speaker to play audio data, or control the local speaker to play audio data muted.

In some embodiments, the pop-up window corresponding to the target device can also display controls such as “Disconnect”, “Unpair”, “Cancel”, etc. The “Disconnect” control can be used to instruct the Bluetooth communication module to disconnect the Bluetooth connection with the target device. For example, while the “Enable LE Audio” control is in a deselected state, the display apparatus, upon receiving a trigger operation on the “Disconnect” control, can control the Bluetooth communication module to disconnect the Bluetooth connection established based on the A2DP protocol. While the “Enable LE Audio” control is in a selected state, the display apparatus, upon receiving a trigger operation on the “Disconnect” control, can control the Bluetooth communication module to disconnect the Bluetooth connection established based on the LE Audio protocol.

The “Unpair” control can be used to cancel the pairing connection between the display apparatus and the target device. After unpairing, if the user wants to re-establish a Bluetooth connection for the target device, a new pairing request for that target device needs to be triggered. The “Cancel” control can be used to close the pop-up window for the target device.

In some embodiments, after the display apparatus can control the Bluetooth communication module to disconnect the Bluetooth connection established with the target device based on the A2DP protocol and can control the local speaker to play audio data, it can also control the Bluetooth communication module to establish a Bluetooth connection with the target device based on the LE Audio protocol, control the local speaker to stop playing audio data, and synchronize the audio data of the display apparatus to the target device via the Bluetooth connection established based on the LE Audio protocol.

In the embodiments, since the display apparatus and the target device can communicate audio data based on the LE Audio protocol after establishing a Bluetooth connection based on the LE Audio protocol, the display apparatus, while controlling the Bluetooth communication module to establish a Bluetooth connection with the target device based on the LE Audio protocol, can control the local speaker to stop playing audio data. It sends the audio data to the target device via the Bluetooth connection established based on the LE Audio protocol, and the target device synchronously plays the audio data sent based on the LE Audio protocol.

As shown in FIG. 14, in the embodiments, if the “Enable LE Audio” control on the device management page is in a selected state, it can indicate that the display apparatus has established a Bluetooth connection with the target device based on the LE Audio protocol. In this case, the local speaker can be controlled to stop playing audio data, and the audio data of the display apparatus is synchronized to the target device via the Bluetooth connection established based on the LE Audio protocol. Based on this, after the display apparatus can control the Bluetooth communication module to establish a Bluetooth connection with the target device based on the A2DP protocol, upon receiving a connection protocol switching command for the target device, it can control the Bluetooth communication module to disconnect the Bluetooth connection established based on the A2DP protocol, without controlling the local speaker to play audio data. Instead, the display apparatus directly can establish a Bluetooth connection with the target device based on the LE Audio protocol and synchronizes the audio data of the display apparatus to the target device via the Bluetooth connection established based on the LE Audio protocol.

According to the device control method of some embodiments, the display apparatus can control the Bluetooth communication module to perform device scanning and can control the display to show the scanned devices. In response to a pairing request triggered for a target device among the scanned devices, the display apparatus can control the Bluetooth communication module to establish a Bluetooth connection with the target device based on the A2DP protocol. In response to a connection protocol switching command for the target device, the display apparatus can control the Bluetooth communication module to disconnect the Bluetooth connection established based on the A2DP protocol and can control the local speaker to play audio data. The display apparatus can control the Bluetooth communication module to establish a Bluetooth connection with the target device based on the LE Audio protocol, can control the local speaker to stop playing audio data, and synchronizes the audio data of the display apparatus to the target device via the Bluetooth connection established based on the LE Audio protocol. As can be seen, based on the embodiments of the disclosure, switching between the A2DP protocol and the LE Audio protocol can be realized and, after switching to the LE Audio protocol, the function of synchronously playing audio data based on the LE Audio protocol can also be realized.

In some embodiments, after the display apparatus can control the Bluetooth communication module to establish a Bluetooth connection with the target device based on the A2DP protocol, upon receiving a connection protocol switching command for the target device, it can also control the Bluetooth communication module to establish a dual-protocol Bluetooth connection with the target device based on both the A2DP protocol and the LE Audio protocol, set the state of the A2DP protocol to inactive, and set the state of the LE Audio protocol to active. Here, the LE Audio protocol in the active state can be used to synchronize the audio data of the display apparatus to the target device.

In practical applications, the display apparatus can establish a dual-protocol Bluetooth connection with the target device based on both the A2DP protocol and the LE Audio protocol. However, for a successfully established dual-protocol connection, a single Bluetooth connection protocol can be in the active state, while the other Bluetooth connection protocol is in the inactive state.

The active Bluetooth connection protocol can be used for sending audio data generated by applications on the display apparatus to the target device via this Bluetooth connection for playback by the target device. The inactive Bluetooth connection protocol cannot be used for sending the audio data of the display apparatus to the target device.

In the embodiments, after the display apparatus can control the Bluetooth communication module to establish a dual-protocol Bluetooth connection with the target device based on both the A2DP protocol and the LE Audio protocol, by setting the state of the A2DP protocol to inactive and the state of the LE Audio protocol to active, the audio data of the display apparatus can be synchronized to the target device based on the active LE Audio protocol. Furthermore, the target device plays the audio data of the display apparatus.

As can be seen, based on the embodiments of the disclosure, the target device's connection protocol can be switched from the A2DP protocol to the LE Audio protocol by setting the state of the A2DP protocol to inactive and the state of the LE Audio protocol to active, thereby achieving the protocol switching function for the target device.

In some embodiments, during the display apparatus establishing a Bluetooth connection with the target device based on the A2DP protocol, since the A2DP protocol does not support the function of scanning for broadcasts for the target device, the broadcast scan control remains in an inoperable state. As shown in FIG. 13, while the display apparatus of the disclosure can establish a Bluetooth connection with the target device based on the A2DP protocol, the broadcast scan control 1301 is in an inoperable state.

In some embodiments, after the display apparatus can control the Bluetooth communication module to establish a Bluetooth connection with the target device based on the A2DP protocol, upon receiving a connection protocol switching command for the target device, it can control the display to show the broadcast scan control in an operable state. Here, the broadcast scan control can be used to trigger scanning for broadcast signal sources for the target device. The broadcast scan control being in an operable state means the display apparatus can scan for broadcast signal sources for the target device in response to a trigger operation on the broadcast scan control. As still shown in FIG. 13, in response to a selection on the “Enable LE Audio” control from the user, the broadcast scan control can be controlled to switch from an inoperable state to an operable state. As shown in FIG. 14, the “Enable LE Audio” control is now in a selected state, and the broadcast scan control 1401 is in an operable state.

In some embodiments, during the process of displaying the broadcast scan control in an operable state, in response to a trigger operation on the broadcast scan control, the Bluetooth communication module can be controlled to scan for broadcast signal sources, and the display can be controlled to show the identifiers of the scanned broadcast signal sources.

In some embodiments, assuming the display apparatus is a television, upon receiving a trigger operation on the broadcast scan control in an operable state, the television can control its own Bluetooth communication module to scan for broadcast signal sources, or scans for broadcast signal sources based on a broadcast assistant application. After scanning at least one broadcast signal source, it can display the scanned at least one broadcast signal source on the television's display. The trigger operation on the broadcast scan control may include a click operation, selection operation, etc., on this control. For example, as shown in FIG. 14, upon receiving a trigger operation on the broadcast scan control 1401, the Bluetooth communication module can be controlled to scan for broadcast signal sources.

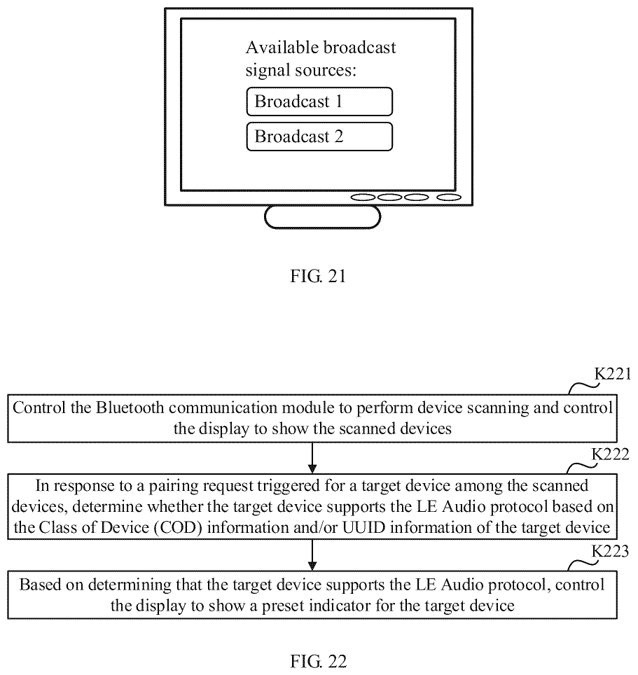

Next, as shown in FIG. 21, which is a schematic diagram of a broadcast display page of a display apparatus according to some embodiments, the page can display the identifiers of the broadcast signal sources scanned by the display apparatus, such as identifier “Broadcast 1” and identifier “Broadcast 2”.

In some embodiments, during the process of controlling the display to show the identifiers of the scanned broadcast signal sources, in response to a selection on a target identifier among the identifiers of the scanned broadcast signal sources, the broadcast parameter information of the broadcast signal source corresponding to the target identifier can be sent to the target device, enabling the target device to play the audio data transmitted by the broadcast source based on the broadcast parameter information.

Here, the target identifier can be any identifier among the identifiers of the at least one broadcast signal source. The selection operation on the target identifier may include a click operation, long-press operation, etc., on the target identifier.

In FIG. 21, the identifiers of the broadcast signal sources scanned by the display apparatus may include the identifier “Broadcast 1” and the identifier “Broadcast 2”. In response to a selection on the identifier “Broadcast 1”, the broadcast parameter information of the broadcast signal source corresponding to the identifier “Broadcast 1” can be sent to the target device, enabling the target device to play the audio data transmitted by the broadcast source based on the broadcast parameter information.

In some embodiments, before sending the broadcast parameter information of the broadcast signal source corresponding to the target identifier to the target device in response to a selection on the target identifier among the identifiers of the scanned broadcast signal sources, it may also include: obtaining the identifier of the local broadcast.

During the process of controlling the display to show the identifiers of the scanned broadcast signal sources, if the broadcast source of the display apparatus is also broadcasting, the broadcast identifier of the display apparatus (i.e., the identifier of the local broadcast) can also be displayed on the broadcast display interface. In practical applications, the display apparatus can automatically synchronize and display the identifier of the local broadcast on the broadcast display page without needing to obtain the local broadcast via Bluetooth scanning.

After obtaining the local broadcast and the scanned broadcast signal sources, the identifier of the local broadcast and the identifiers of the scanned broadcast signal sources can be displayed. Furthermore, in response to a selection on a target identifier among the identifier of the local broadcast and the identifiers of the at least one broadcast signal source, the broadcast parameter information of the broadcast signal source corresponding to the target identifier can be sent to the target device.

In practical applications, if the broadcast signal source corresponding to the target identifier is the local broadcast, the target audio receiving device can be controlled to switch from the current Bluetooth protocol to the BMS protocol. Furthermore, the target audio receiving device plays the audio data of the target broadcast signal source based on the BMS protocol.

In some embodiments, the identifier of the local broadcast or the identifiers of the scanned broadcast signal sources can be displayed by means of broadcasting identification information.

In some embodiments, the display apparatus, in response to a trigger operation on a broadcast control, can display broadcast identification information; where the broadcast identification information may include a QR code, account password, etc., and carries the identifier of the local broadcast or the broadcast parameter information of the broadcast signal sources scanned by the display apparatus.

Additionally, the broadcast display interface can also show the names and passwords corresponding to the scanned broadcast signal sources. Other devices can only obtain the identifier of the broadcast signal source after entering the correct name and password.

In some embodiments, when displaying the broadcast parameter information of the local broadcast or the broadcast signal sources scanned by the display apparatus via the broadcast control using an account password for the first time, a random password can be set for this broadcast signal source. In practical applications, if the user wants to change the password, they need to stop transmitting the broadcast first. After changing the password, when displaying the broadcast parameter information of the broadcast signal sources scanned by the display apparatus via the broadcast control using an account password again, the modified password can be displayed.

In some embodiments, if the password corresponding to a broadcast signal source is empty, it means the broadcast is not encrypted. Other devices can obtain the identifier of the broadcast signal source without needing to enter a password.

As can be seen, the display apparatus in the embodiments of the disclosure can send the broadcast parameter information of the broadcast signal source to the target device that has established a Bluetooth connection with the display apparatus based on the LE Audio protocol. The target device can then synchronously play the audio data transmitted by the broadcast signal source based on the broadcast parameter information, thereby achieving the function of synchronously playing the audio data from the scanned broadcast signal source on the target device connected with the display apparatus.

Corresponding to the scenario schematic shown in the aforementioned FIG. 6, the display process for device pairing in the embodiments of the disclosure can be as shown in FIG. 22. FIG. 22 is a fifth schematic flowchart of a device control method according to some embodiments. As shown in FIG. 22, the method can include, but is not limited to, the following steps K221-K223.

K221: control the Bluetooth communication module to perform device scanning and control the display to show the scanned devices.

K222: in response to a pairing request triggered for a target device among the scanned devices, determine whether the target device supports the LE Audio protocol based on the Class of Device (COD) information and/or UUID information of the target device; where the COD information can be used to identify the type information of the device, such as earphones, keyboards, mice, etc. Both COD information and UUID can be used to indicate whether the target device supports the Bluetooth Low Energy Audio (LE Audio) protocol.

In practical applications, because the UUIDs supporting the Classic Bluetooth protocol and the LE Audio protocol are different, the UUID can be used to identify whether the target device's UUID is of the type that supports the LE Audio protocol. If the UUID is determined to be of the type supporting the LE Audio protocol, the target device can be considered to support the LE Audio protocol.

In some embodiments, before determining whether the target device supports the LE Audio protocol based on the UUID and/or COD information of the target device, the COD information of the scanned devices can be obtained during the process where the display apparatus can control the Bluetooth communication module to scan for nearby devices.

In some embodiments, in response to a pairing request triggered for a target device among the scanned devices, the UUID information of the target device can be obtained. Furthermore, it is determined whether the target device supports the LE Audio protocol based on the COD information obtained during scanning and/or the UUID of the target device.

Taking FIG. 11 as an example, the display apparatus, in response to a pairing request triggered for Device 4 in the list of scanned devices, can determine whether Device 4 supports the Bluetooth Low Energy Audio (LE Audio) protocol based on the COD information and/or UUID information of Device 4. The list of connected devices can show devices that have already established a Bluetooth connection with the display apparatus, and the list of scanned devices can show the devices scanned by the display apparatus this time.

In some embodiments, during the process where the display apparatus can establish a Bluetooth connection with the target device (i.e., before the connection is fully established), based on determining according to the UUID and/or the COD information of the target device that the target device supports the LE Audio protocol, the display can be controlled to show the preset indicator for the target device.

In some embodiments, after the display apparatus has successfully established a Bluetooth connection with the target device, based on determining according to the UUID and/or the COD information of the target device that the target device supports the LE Audio protocol, the display can be controlled to show the preset indicator for the target device.

K223: based on determining that the target device supports the LE Audio protocol, control the display to show a preset indicator for the target device; where the preset indicator can be used to indicate that the target device supports the LE Audio protocol.

In the embodiments, based on determining according to at least one of the COD information or the UUID of the target device that the target device supports the LE Audio protocol, the display can be controlled to show the preset indicator for the target device.

In some embodiments, based on determining according to the COD information that the target device supports the LE Audio protocol, but determining according to the UUID that the target device does not support the LE Audio protocol, the preset indicator can be displayed for the target device. Based on determining according to both the COD information and the UUID that the target device supports the LE Audio protocol, the preset indicator can be displayed for the target device. Based on determining according to the COD information that the target device does not support the LE Audio protocol, but determining according to the UUID that the target device supports the LE Audio protocol, the preset indicator can be displayed for the target device. Based on determining according to both the COD information and the UUID that the target device does not support the LE Audio protocol, the preset indicator is not displayed.

The preset indicator can be used to indicate that the target device supports the LE Audio protocol. The display style of the preset indicator can include text, icons, etc. For example, the text “LE Audio” can be displayed in a position corresponding to the device supporting the LE Audio protocol.

Taking FIG. 11 as an example, when the display apparatus receives a pairing request triggered for Device 4, it can establish a Bluetooth connection with Device 4 and can obtain the COD information and UUID information of Device 4. Based on determining according to the COD information and UUID information that Device 4 supports the Bluetooth Low Energy Audio (LE Audio) protocol, it can control the display to show the preset indicator for Device 4.

According to the device control method of some embodiments, first, the Bluetooth communication module can be controlled to perform device scanning, and the scanned devices can be displayed. Then, in response to a pairing request triggered for a target device among the scanned devices, it is determined whether the target device supports the LE Audio protocol based on the COD information and/or UUID information of the target device. Based on determining that the target device supports the LE Audio protocol, the display can be controlled to show a preset indicator for the target device. As can be seen, based on the embodiments of the disclosure, the function of displaying an LE Audio identifier for devices supporting the LE Audio protocol based on COD information and UUID information can be realized.

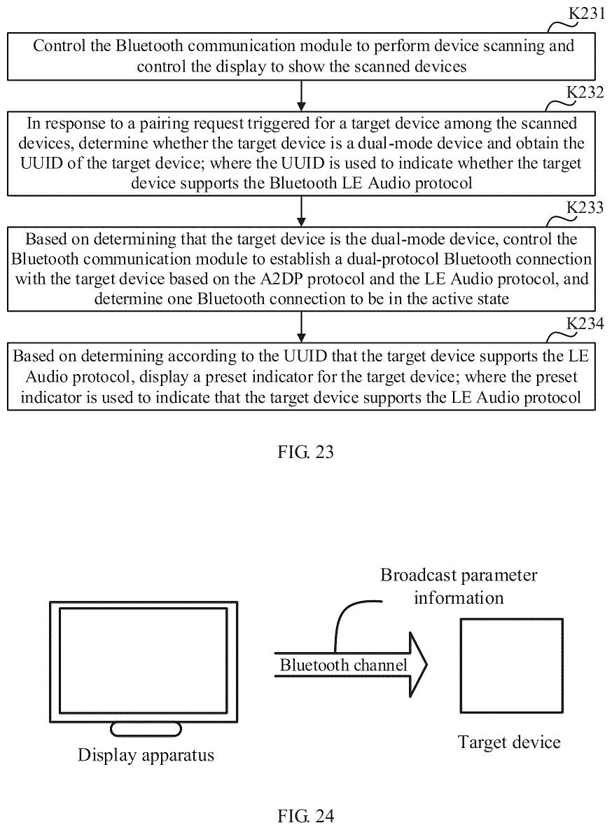

Corresponding to the scenario schematic shown in FIG. 6, FIG. 23 is a sixth schematic flowchart of a device control method according to some embodiments. As shown in FIG. 23, the method can include, but is not limited to, the following steps K231-K234.

K231: control the Bluetooth communication module to perform device scanning and control the display to show the scanned devices.

K232: in response to a pairing request triggered for a target device among the scanned devices, determine whether the target device is a dual-mode device and obtain the Universally Unique Identifier (UUID) of the target device; where the UUID can be used to indicate whether the target device supports the Bluetooth Low Energy Audio (LE Audio) protocol; and the dual-mode device is a device that supports both the Advanced Audio Distribution Profile (A2DP) protocol and the LE Audio protocol.

K233: based on determining that the target device is the dual-mode device, control the Bluetooth communication module to establish a dual-protocol Bluetooth connection with the target device based on the A2DP protocol and the LE Audio protocol, and determine one Bluetooth connection to be in the active state.

In practical applications, the built-in Bluetooth communication module of the display apparatus can establish a dual-protocol Bluetooth connection with the target device based on both the A2DP protocol and the LE Audio protocol. However, within a successfully established dual-protocol connection, a single Bluetooth connection can be in the active state. Therefore, after controlling the Bluetooth communication module to establish the dual-protocol Bluetooth connection with the target device based on both the A2DP and LE Audio protocols, the display apparatus must determine which connection will be active.

The active Bluetooth connection can be used for sending audio data generated by applications on the display apparatus to the target device via the Bluetooth connection for playback by the target device. The inactive Bluetooth connection cannot be used for sending the display apparatus's audio data to the target device.

In some embodiments, if the Bluetooth connection established between the display apparatus and the target device based on the A2DP protocol is active, audio data can be sent to the target device based on the A2DP protocol. If the Bluetooth connection established between the display apparatus and the target device based on the LE Audio protocol is active, audio data can be sent to the target device based on the LE Audio protocol. The target device can be used to play the received audio data.

K234: based on determining according to the UUID that the target device supports the LE Audio protocol, display a preset indicator for the target device; where the preset indicator can be used to indicate that the target device supports the LE Audio protocol.

In some embodiments, after the display apparatus can control the Bluetooth communication module to establish a Bluetooth connection with the target device based on both the A2DP protocol and the LE Audio protocol and determines one connection to be in the active state, it can also, in response to a connection protocol switching command for the target device, update the active Bluetooth connection and send audio data to the target device based on the active Bluetooth connection.

The connection protocol switching command for the target device may include a trigger operation on a preset control corresponding to the target device, such as a selection on the “Enable LE Audio” control or a deselection on the “Enable LE Audio” control.

In practical applications, if the active Bluetooth connection is determined to be the one established with the target device based on the A2DP protocol, then upon receiving a connection protocol switching command for the target device, the Bluetooth connection based on the A2DP protocol can be switched from active to inactive, and the Bluetooth connection based on the LE Audio protocol can be updated to active. Audio data is then sent to the target device based on the LE Audio protocol.

If the active Bluetooth connection is determined to be the one established with the target device based on the LE Audio protocol, upon receiving a connection protocol switching command for the target device, the Bluetooth connection based on the LE Audio protocol can be switched from active to inactive, and the Bluetooth connection based on the A2DP protocol can be updated to active. Audio data then can be sent to the target device based on the A2DP protocol.

In some embodiments, during the process of displaying connected devices on the device management page, in response to a selection on the target device among the connected devices from a user, a pop-up window corresponding to the target device can be displayed. This pop-up window may show an “Enable LE Audio” control.

Based on determining that the currently active Bluetooth connection is the one established with the target device based on the A2DP protocol, the “Enable LE Audio” control in the pop-up window can be, by default, in a deselected state. Upon receiving a connection protocol switching command for the target device, the display apparatus can update the Bluetooth connection established with the target device based on the LE Audio protocol to an active state can send audio data to the target device based on the LE Audio protocol.

Based on determining that the currently active Bluetooth connection is the one established with the target device based on the LE Audio protocol, the “Enable LE Audio” control in the pop-up window is, by default, in a selected state. In response to a deselection on the “Enable LE Audio” control, the display apparatus can update the Bluetooth connection established with the target device based on the A2DP protocol to an active state can send audio data to the target device based on the A2DP protocol.

As can be seen, in the device control method provided by the disclosure, the display apparatus can control the Bluetooth communication module to perform device scanning and can display the scanned devices. In response to a pairing request triggered for a target device among the scanned devices, the display apparatus can determine whether the target device is a dual-mode device, where the dual-mode device supports both the Advanced Audio Distribution Profile (A2DP) protocol and the LE Audio protocol. Based on determining that the target device is a dual-mode device, the Bluetooth communication module can be controlled to establish a Bluetooth connection with the target device based on the A2DP protocol, and the UUID of the target device can be obtained, where the UUID can be used to indicate whether the target device supports the Bluetooth Low Energy Audio (LE Audio) protocol. Based on determining that the target device is a dual-mode device, the Bluetooth communication module can be controlled to establish a dual-protocol Bluetooth connection with the target device based on both the A2DP protocol and the LE Audio protocol, and one Bluetooth connection is determined to be in the active state. Based on determining according to the UUID that the target device supports the LE Audio protocol, a preset indicator can be displayed for the target device, where the preset indicator can be used to indicate that the target device supports the LE Audio protocol. Based on the embodiments of the disclosure, pairing and connection between the display apparatus and the target device can be realized, the target device's UUID can be obtained during the pairing process, thereby enabling the function of displaying an LE Audio identifier for devices supporting the LE Audio protocol.

In some embodiments, if the broadcast source of the display apparatus is also broadcasting, the broadcast identifier of the display apparatus (i.e., the identifier of the local broadcast) can also be displayed on the broadcast display interface. In response to a selection on the local broadcast identifier, the broadcast parameter information of the local broadcast can be sent to the target device, enabling the target device to synchronously play the local broadcast based on the broadcast parameter information.

In some embodiments, after switching the target device's connection protocol to the LE Audio protocol, establishing a Bluetooth connection with the target device based on the UMS protocol and the BSA protocol is prioritized by default.

In practical applications, in the LE Audio application layer specification, the Telephony and Media Audio Profile (TMAP) can define two media audio applications: unicast media audio and broadcast media audio. For unicast media audio, a Unicast Media Sender (UMS) and a Unicast Media Receiver (UMR) can be used. For broadcast media audio, a Broadcast Media Sender (BMS) and a Broadcast Media Receiver (BMR) can be used.

Since the UMS and the BMS are mutually exclusive and cannot be active simultaneously, on the sound settings page, in response to a trigger operation to switch the current audio output channel (e.g., the Bluetooth channel established based on the UMS protocol) to the Bluetooth broadcast output channel, the UMS protocol state can be updated to inactive, and the BMS protocol state can be updated to active.

In practical applications, after setting the BMS protocol state of the display apparatus to active and obtaining the broadcast parameter information of the display apparatus, the broadcast parameter information of the display apparatus can be sent to the target device via the Bluetooth connection established with the target device based on the BSA protocol, enabling the target device to synchronously play the audio data transmitted by the display apparatus based on the broadcast parameter information.

FIG. 24 is a second schematic diagram of a scenario for a device control method according to some embodiments. As shown in FIG. 24, the display apparatus can also, upon receiving a trigger operation to switch the current audio output channel to the Bluetooth broadcast output channel, obtain the broadcast parameter information of the display apparatus and send the broadcast parameter information to the device to be processed via a Bluetooth channel established with the device to be processed based on the BSA protocol, enabling the device to be processed to synchronously broadcast the audio data transmitted by the display apparatus based on the broadcast parameter information. As can be seen, based on the embodiments of the disclosure, the broadcast parameter information of the display apparatus can be sent to the device to be processed, enabling the device to be processed to synchronously play the audio data of the display apparatus based on the broadcast parameter information, thereby achieving the function of switching the display apparatus from the current audio output channel to the Bluetooth broadcast output channel.

The device control method according to some embodiments can be implemented through a display apparatus, a control terminal, and a device to be processed. The control terminal can be a mobile phone, tablet computer, etc., and can be used to manage the device control method.

Using the scenario shown in FIG. 24 as an example, when implementing the device control method according to some embodiments, the various components of the display apparatus 100 can also perform the following functions.

In some embodiments, at least one processor is further configured to execute computer instructions to cause the display apparatus to perform: in response to a trigger operation to switch a current audio output channel to a Bluetooth broadcast output channel, obtaining broadcast parameter information of the display apparatus; sending the broadcast parameter information to the device to be processed via a Bluetooth channel established with the device to be processed based on the BSA protocol, enabling the device to be processed to synchronously play the audio data transmitted by the display apparatus based on the broadcast parameter information; where the device to be processed is an audio receiving device that has established a Bluetooth connection with the display apparatus based on the LE Audio protocol and the BSA protocol.

In some embodiments, at least one processor is further configured to execute computer instructions to cause the display apparatus to perform: before obtaining the broadcast parameter information of the display apparatus in response to a trigger operation to switch the current audio output channel to a Bluetooth broadcast output channel, in response to a pairing request triggered for a device to be processed among the scanned devices, determining whether the device to be processed supports the LE Audio protocol; based on determining that the device to be processed supports the LE Audio protocol, establishing a Bluetooth connection with the device to be processed based on the LE Audio protocol and the BSA protocol.

In some embodiments, at least one processor is further configured to execute computer instructions to cause the display apparatus to perform: while determining whether the device to be processed supports the LE Audio protocol in response to a pairing request triggered for a device to be processed among the scanned devices, determining whether the device to be processed supports the LE Audio protocol based on the COD information and/or UUID of the device to be processed.

In some embodiments, at least one processor is further configured to execute computer instructions to cause the display apparatus to perform: in response to the trigger operation to switch the current audio output channel to a Bluetooth broadcast output channel, updating the UMS protocol state to inactive and updating the BMS protocol state to active.

In some embodiments, at least one processor is further configured to execute computer instructions to cause the display apparatus to perform: in response to a trigger operation to switch the current audio output channel to a Bluetooth broadcast output channel, setting a state of the audio module of the display apparatus to inactive.

In some embodiments, at least one processor is further configured to execute computer instructions to cause the display apparatus to perform: in response to a trigger operation to switch from the Bluetooth broadcast output channel to a Bluetooth output channel, updating the UMS protocol state to inactive and updating the BMS protocol state to active.

In some embodiments, at least one processor is further configured to execute computer instructions to cause the display apparatus to perform: in response to a trigger operation to switch from the Bluetooth broadcast output channel to a Bluetooth output channel, sending a notification message to the device to be processed via the Bluetooth channel established with the device to be processed based on the BSA protocol, to notify the device to be processed to stop receiving broadcast, and updating the BMS protocol state to inactive and the UMS protocol state to active.

In some embodiments, at least one processor is further configured to execute computer instructions to cause the display apparatus to perform: after the step of in response to a trigger operation to switch the current audio output channel to a Bluetooth broadcast output channel, obtaining the broadcast parameter information of the display apparatus, and before the step of sending the broadcast parameter information to the device to be processed via a Bluetooth channel established with the device to be processed based on the BSA protocol, controlling the Bluetooth communication module to perform device scanning; in response to a pairing request triggered for a device to be processed among the scanned devices, determining whether the device to be processed is an audio receiving device that supports both the LE Audio protocol and the A2DP protocol; based on determining that the device to be processed is an audio receiving device that supports both the LE Audio protocol and the A2DP protocol, establishing a Bluetooth connection with the device to be processed based on the LE Audio protocol and the BSA protocol.

In some embodiments, at least one processor is further configured to execute computer instructions to cause the display apparatus to perform: before establishing a Bluetooth connection with the device to be processed based on the LE Audio protocol and the BSA protocol, determining whether the display apparatus is currently in a broadcast state; based on determining that the display apparatus is currently in the broadcast state, executing the step of establishing a Bluetooth connection with the device to be processed based on the LE Audio protocol and the BSA protocol.

In some embodiments, at least one processor is further configured to execute computer instructions to cause the display apparatus to perform: based on determining that the device to be processed supports the LE Audio protocol, controlling the display to show a preset indicator for the device to be processed; where the preset indicator can be used to indicate that the device to be processed supports the LE Audio protocol.

As mentioned above, the device to be processed in the embodiments of the disclosure can be an audio receiving device that has established a Bluetooth connection with the display apparatus based on the LE Audio protocol and the BSA protocol. Therefore, the hardware structure of the device to be processed can directly refer to the audio receiving device 200 shown in FIG. 9, i.e., the device to be processed can include: a processor 210, a communicating device 220, a user input/output interface 230, a memory 240, and a power supply 250. The communicating device 220 can be used for external communication and can include at least one of a Wi-Fi chip, a Bluetooth communication module, NFC, or a substitutable module. The user input/output interface 230 can include at least one of a speaker, a microphone, a touchpad, a sensor, a button, or a substitutable module.

Using the scenario shown in FIG. 24 as an example, when implementing the device control method according to some embodiments, the various components of the device to be processed can perform the following functions.

In some embodiments, the processor is configured to: receive the broadcast parameter information sent by the display apparatus, and synchronously play the audio data transmitted by the display apparatus based on the broadcast parameter information.

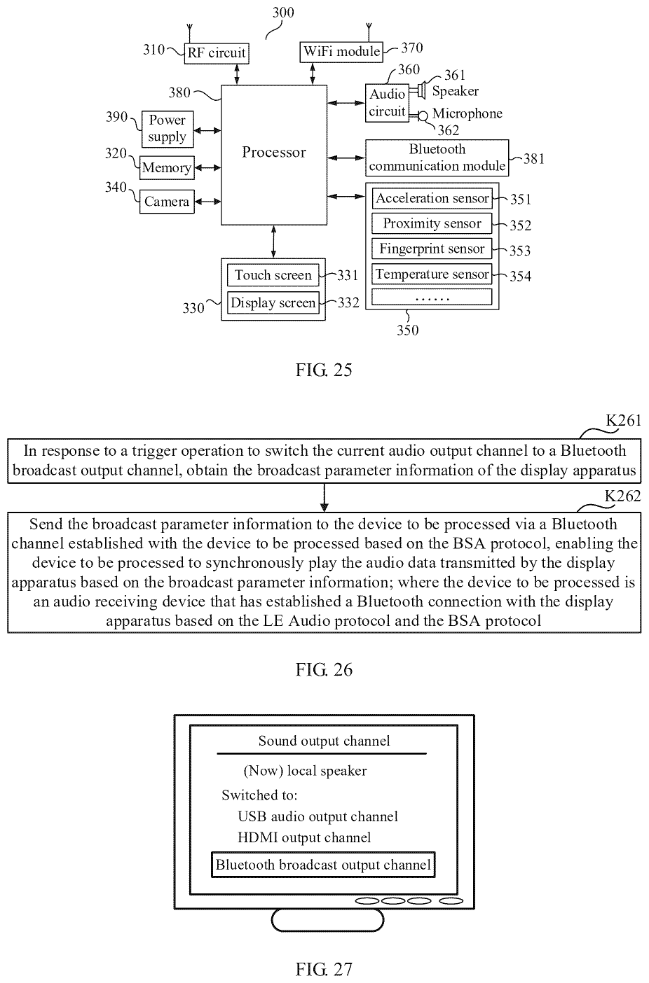

FIG. 25 is a block diagram of a hardware configuration of a control terminal 300 according to some embodiments. It should be understood that the control terminal 300 shown in FIG. 25 is only an example, and the control terminal 300 may have more or fewer components than those shown in FIG. 25, may combine two or more components, or may have a different component configuration. The various components shown in FIG. 25 can be implemented in hardware, software, or a combination of hardware and software, including one or more signal processing and/or application-specific integrated circuits.

As shown in FIG. 25, the control terminal 300 can include: a radio frequency (RF) circuit 310, a memory 320, a display unit 330, a camera 340, a sensor 350, an audio circuit 360, a Wireless Fidelity (Wi-Fi) module 370, a processor 380, a Bluetooth communication module 381, and a power supply 390, and other components.

The RF circuit 310 can be used for receiving and sending signals during information transmission or calls. It can receive downlink data from a base station and hand it over to the processor 380 for processing; it can also send uplink data to the base station. The memory 320 can be used to store software programs and data. The memory 320 stores an operating system that enables the control terminal 300 to operate. In the disclosure, the memory 320 can store the operating system and various applications, and can also store the program code for executing the device control method in some embodiments of the disclosure.

The display unit 330 can be used to receive input digital or character information and generate signal inputs related to user settings and function control of the control terminal 300. Specifically, the display unit 330 may include a touchscreen 331 located on the front of the control terminal 300, which can collect touch operations by the user on or near it, such as clicking buttons.

The display unit 330 can also be used to display information input by the user or provided to the user, as well as graphical user interfaces (GUIs) for various menus of the control terminal 300. The display unit 330 may include a display screen 332 located on the front of the control terminal 300. The touchscreen 331 can be overlaid on the display screen 332, or the touchscreen 331 and the display screen 332 can be integrated to implement the input and output functions of the control terminal 300. After integration, it can be referred to as a touch display screen. The control terminal 300 may also include at least one type of sensor 350, such as an acceleration sensor 351, a proximity sensor 352, a fingerprint sensor 353, and a temperature sensor 354.

The audio circuit 360, speaker 361, and microphone 362 can provide an audio interface between the user and the control terminal 300. Wi-Fi is a short-range wireless transmission technology. The control terminal 300 can use the Wi-Fi module 370 to help users send and receive emails, browse web pages, and access streaming media, providing users with wireless broadband internet access.

The processor 380 is the control center of the control terminal 300. It connects various parts of the entire control terminal using various interfaces and lines, executes various functions and processes data of the control terminal 300 by running or executing software programs stored in the memory 320 and calling data stored in the memory 320. In some embodiments, the processor 380 may include one or more processing units. The processor 380 can also integrate an application processor and a baseband processor, where the application processor mainly handles the operating system, user interface, and applications, while the baseband processor mainly handles wireless communication. It is understandable that the aforementioned baseband processor may not be integrated into the processor 380. In the disclosure, the processor 380 can run the operating system, applications, user interface display and touch response, as well as the device control method executed by the control terminal in some embodiments of the disclosure. Additionally, the processor 380 is coupled to the display unit 330.

The Bluetooth communication module 381 can be used for information interaction with other Bluetooth devices that have Bluetooth communication modules based on the Bluetooth protocol. For example, the control terminal 300 can establish a Bluetooth connection with a display apparatus that also has a Bluetooth communication module through the Bluetooth communication module 381, thereby enabling data interaction. In the embodiments of the disclosure, the control terminal 300 can establish an ACL link with a display apparatus that also has a Bluetooth communication module through the Bluetooth communication module 381 to receive sound channel information or BIS identifiers sent by the display apparatus. The control terminal 300 also can include a power supply 390 (such as a battery) that supplies power to various components.

Corresponding to the scenario schematic shown in FIG. 24, FIG. 26 is a seventh schematic flowchart of a device control method according to some embodiments. The method may include, but is not limited to, the following steps K261-K262.

K261: in response to a trigger operation to switch the current audio output channel to a Bluetooth broadcast output channel, obtain the broadcast parameter information of the display apparatus.

The current audio output channel may include relatively-conventional output channels such as the local speaker output channel, Universal Serial Bus (USB) audio output channel, High Definition Multimedia Interface (HDMI) output channel, etc., and may also include audio output channels established based on the Unicast Media Sender (UMS).

The Bluetooth broadcast output channel may include a Bluetooth broadcast output channel established based on the Broadcast Media Sender (BMS).

In practical applications, while the display apparatus is playing audio data based on the current audio output channel, such as the USB audio output channel, upon receiving a trigger operation to switch the current audio output channel to the Bluetooth broadcast output channel, the display apparatus can obtain the broadcast parameter information of the display apparatus.

The broadcast parameter information may include address type, device address, broadcast source address, broadcast packet cluster ID, broadcast ID information, synchronization interval, encryption status, broadcast code, rendering delay time, SUB GROUP information, Android version, etc. After obtaining the broadcast parameter information of the display apparatus, audio receiving devices can be enabled to synchronously play the audio data transmitted by the display apparatus based on this information.

In some embodiments, the trigger operation to switch the current audio output channel to the Bluetooth broadcast output channel may include a selection on a Bluetooth broadcast option among the sound output channels on the sound settings page in the device manager.

As shown in FIG. 27, which is a schematic diagram of a sound settings page according to some embodiments, the current sound output channel is the local speaker output channel. The sound settings page can also show the USB audio output channel, HDMI output channel, Bluetooth broadcast output channel, etc. In response to a selection on the Bluetooth broadcast output channel among the sound output channels, the currently set local speaker output channel can be switched to the Bluetooth broadcast output channel, and the broadcast parameter information of the display apparatus can be obtained.

In the LE Audio application layer specification, the Telephony and Media Audio Profile (TMAP) can define two media audio applications: unicast media audio and broadcast media audio. For unicast media audio, a Unicast Media Sender (UMS) and a Unicast Media Receiver (UMR) can be used. For broadcast media audio, a Broadcast Media Sender (BMS) and a Broadcast Media Receiver (BMR) can be used. In practical applications, the UMS and the BMS are mutually exclusive; that is, the audio output channel of a Bluetooth device cannot be in both unicast state and broadcast state simultaneously.

Since the audio output channel of the device to be processed cannot be in both unicast and broadcast states simultaneously, when the current audio output channel is the UMS audio output channel, in response to a trigger operation to switch the current audio output channel to the Bluetooth broadcast output channel, the UMS protocol state can be updated to inactive, and the BMS protocol state can be updated to active.

Here, a Bluetooth protocol in the active state can be used for sending audio data to Bluetooth devices based on that protocol, while a Bluetooth protocol in the inactive state cannot be used for sending audio data to Bluetooth devices.

In practical applications, after setting the BMS protocol state of the display apparatus to active, the display apparatus enters the broadcast state. In this case, the broadcast parameter information of the display apparatus can be obtained and further sent to the device to be processed, enabling the device to be processed to synchronously play the audio data transmitted by the display apparatus based on the broadcast parameter information.

In some embodiments, after setting the BMS protocol state of the display apparatus to active, in response to a trigger operation to switch from the Bluetooth broadcast output channel to a Bluetooth output channel, the UMS protocol state can be updated to active, and the BMS protocol state can be updated to inactive.

The trigger operation to switch from the Bluetooth broadcast output channel to a Bluetooth output channel may include a selection on the Bluetooth output channel, etc.

In practical applications, after updating the UMS protocol state of the display apparatus to active, the audio data transmitted by the display apparatus can be sent to the device to be processed via the Bluetooth output channel established based on the UMS protocol, similar to the audio transmission method based on Classic Bluetooth.

In some embodiments, upon receiving a trigger operation to switch from the Bluetooth broadcast transmission channel to a Bluetooth output channel, a notification message can also be sent to the device to be processed via the Bluetooth channel established with the device to be processed based on the BSA protocol, to notify the device to be processed to stop receiving broadcasts, update the BMS protocol state of the device to be processed to inactive, and update the UMS protocol state to active.

When the device to be processed can receive the notification message sent by the display apparatus via the Bluetooth channel established with the device to be processed based on the BSA protocol, it stops receiving broadcasts, can update its own BMS protocol state to inactive, and can update the UMS protocol state to active. At this point, the display apparatus can then send audio data to the device to be processed via the Bluetooth connection established with the device to be processed based on the UMS protocol.

In some embodiments, the display apparatus can also, upon receiving a response message from the device to be processed regarding the notification message, control the Bluetooth communication module to stop sending audio data to the Bluetooth protocol stack. Furthermore, it can send audio data to the device to be processed via the Bluetooth connection established with the device to be processed based on the UMS protocol.

In some embodiments, the display apparatus can also, upon receiving a trigger operation to switch the current audio output channel to the Bluetooth broadcast output channel, set the state of the audio module of the display apparatus to inactive.

Here, the audio module refers to a circuit module in the display apparatus responsible for audio signal input, output, processing, and control, and also manages audio receiving devices. In practical applications, while the audio module of the display apparatus is in the active state, the display apparatus can use the audio module to control the sending of audio data to the device to be processed via the current audio output channel.

Upon receiving a trigger operation to switch the current audio output channel to the Bluetooth broadcast output channel, since the audio module does not support the Bluetooth broadcast output channel, the state of the audio module of the display apparatus needs to be set to inactive, making the audio module unavailable in this case.

K262: send the broadcast parameter information to the device to be processed via a Bluetooth channel established with the device to be processed based on the BSA protocol, enabling the device to be processed to synchronously play the audio data transmitted by the display apparatus based on the broadcast parameter information; where the device to be processed is an audio receiving device that has established a Bluetooth connection with the display apparatus based on the LE Audio protocol and the BSA protocol.

In some embodiments, before obtaining the broadcast parameter information of the display apparatus in response to a trigger operation to switch the current audio output channel to a Bluetooth broadcast output channel, the method may further include: in response to a pairing request triggered for a device to be processed among the scanned devices, determining whether the device to be processed supports the LE Audio protocol; based on determining that the device to be processed supports the LE Audio protocol, establishing a Bluetooth connection with the device to be processed based on the LE Audio protocol and the BSA protocol.

In the embodiment, based on determining that the device to be processed is an audio receiving device that supports the LE Audio protocol, the display apparatus can control the Bluetooth communication module to establish a Bluetooth connection with the device to be processed based on the LE Audio protocol and the BSA protocol. Furthermore, the display apparatus can send the broadcast parameter information to the device to be processed via the Bluetooth channel established with the device to be processed based on the BSA protocol, enabling the device to be processed to synchronously play the audio data transmitted by the display apparatus based on the broadcast parameter information.

Since the device to be processed has already established a Bluetooth connection with the display apparatus based on the LE Audio protocol and the BSA protocol, the device to be processed can receive the broadcast parameter information sent by the display apparatus. Furthermore, after receiving the broadcast parameter information, the device to be processed can synchronously play the audio data transmitted by the display apparatus based on the received broadcast parameter information.

In some embodiments, after the display apparatus successfully switches from the current audio output channel to the Bluetooth broadcast output channel, an identifier for the Bluetooth broadcast output channel can be displayed on the sound settings page in the device manager. The identifier for the Bluetooth broadcast output channel can be used to indicate that the display apparatus has successfully switched to the Bluetooth broadcast output channel.

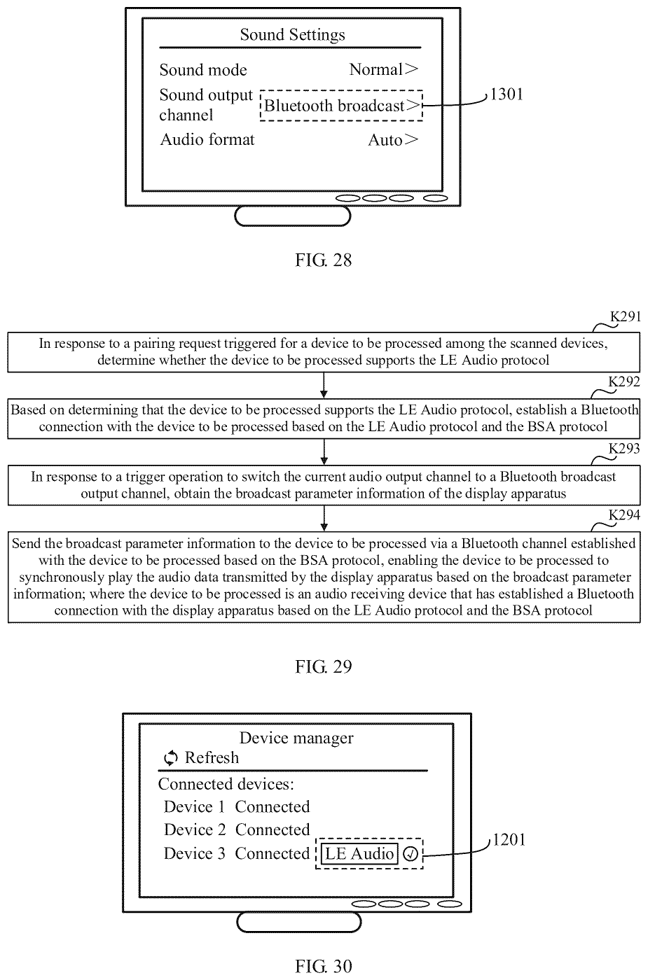

As shown in FIG. 28, which is a schematic diagram of another sound settings page according to some embodiments, the page can display an identifier 1301 for the Bluetooth broadcast output channel.

In some embodiments, the trigger operation to switch from the Bluetooth broadcast output channel to a Bluetooth output channel may further include, on the sound settings page shown in FIG. 28, a trigger operation on the identifier of the Bluetooth broadcast output channel, causing a skip from the current page to the settings page corresponding to the sound output device. On the settings page corresponding to the sound output device, in response to a trigger operation on the Bluetooth output channel, the UMS protocol state can be updated to active, and the BMS protocol state can be updated to inactive.

According to the device control method of some embodiments, first, in response to a trigger operation to switch the current audio output channel to a Bluetooth broadcast output channel, the broadcast parameter information of the display apparatus can be obtained. Then, the broadcast parameter information can be sent to the device to be processed via a Bluetooth channel established with the device to be processed based on the BSA protocol, enabling the device to be processed to synchronously broadcast the audio data transmitted by the display apparatus based on the broadcast parameter information. The device to be processed is an audio receiving device that has established a Bluetooth connection with the display apparatus based on the LE Audio protocol and the BSA protocol. As can be seen, in the embodiments of the disclosure, when switching to the Bluetooth broadcast output channel, the broadcast parameter information of the display apparatus can be sent to the device to be processed via a Bluetooth channel established with the device to be processed based on the BSA protocol, enabling the device to be processed to synchronously play the audio data of the display apparatus based on the broadcast parameter information, thereby achieving the function of switching the display apparatus from the current audio output channel to the Bluetooth broadcast output channel.

Corresponding to the scenario schematic shown in FIG. 24, FIG. 29 is an eighth schematic flowchart of a device control method according to some embodiments. The method may include, but is not limited to, the following steps K291-K293.

K291: in response to a pairing request triggered for a device to be processed among the scanned devices, determine whether the device to be processed supports the LE Audio protocol.

In some embodiments, upon entering the device management page, the display apparatus automatically can control the Bluetooth communication module to scan for nearby devices and can display the scanned devices on the device management page of the display.

The scanned devices may include audio receiving devices supporting Bluetooth, such as earphones, speakers, etc., and may also include mice, keyboards, electronic pens, and other devices supporting Bluetooth. The device to be processed can be any one of the aforementioned devices scanned by the display apparatus.

In some embodiments, after scanning at least one device, the display apparatus can control the display to show the at least one scanned device. Upon receiving a pairing request triggered for a device to be processed among the at least one scanned device, the display apparatus can determine whether the device to be processed supports the LE Audio protocol.

In some embodiments, based on determining that the device to be processed is an audio receiving device that supports the LE Audio protocol, the display apparatus can control the Bluetooth communication module to establish a Bluetooth connection with the device to be processed based on the LE Audio protocol, and synchronizes the audio data of the display apparatus to the device to be processed via the Bluetooth connection established based on the LE Audio protocol.

Audio receiving devices that support the LE Audio protocol may include single-mode devices that only support the Low Energy Bluetooth protocol, as well as dual-mode devices that support both the Classic Bluetooth protocol and the Low Energy Bluetooth protocol. In the embodiments, there is no specific restriction on whether the device to be processed is a single-mode or dual-mode device.

In some embodiments, in response to a pairing request triggered for a device to be processed among the scanned devices, it can be determined based on UUID information whether the device to be processed supports the LE Audio protocol. The pairing request triggered for the device to be processed can be used to trigger the display apparatus to establish a Bluetooth connection with the device to be processed and to determine, based on the UUID information, whether the device to be processed supports the LE Audio protocol.

In practical applications, because the UUIDs supporting the Classic Bluetooth protocol and the LE Audio protocol are different, the UUID can be used to identify whether the UUID of the device to be processed is of the type that supports the LE Audio protocol. If the UUID is determined to be of the type supporting the LE Audio protocol, the device to be processed can be considered to be a device that supports the LE Audio protocol.

In some embodiments, the Universally Unique Identifier (UUID) can further be used to indicate the protocol types supported by the device, such as whether the device supports the Bluetooth Low Energy Audio (LE Audio) protocol or the Advanced Audio Distribution Profile (A2DP) protocol. In the embodiments of the disclosure, since the UUID can be used to indicate whether the device to be processed supports the LE Audio protocol, after obtaining the UUID of the device to be processed, it is possible to determine whether the device to be processed supports the LE Audio protocol based on the UUID.

In some embodiments, before determining whether the device to be processed supports the LE Audio protocol based on the UUID information, the UUID information of the device to be processed can be obtained.

In practical applications, the display apparatus can use the Session Description Protocol (SDP) or the Attribute Protocol (ATT) to obtain the UUID information of the device to be processed.

In some embodiments, in response to a pairing request triggered for a device to be processed among the scanned devices, it can be determined whether the device to be processed supports the LE Audio protocol based on the COD information and/or UUID of the device to be processed.

In practical applications, since the manufacturers of the scanned devices may differ, different manufacturers might place the information used to identify whether a device supports the LE Audio protocol or the A2DP protocol in different locations. For example, some manufacturers might place the information identifying whether LE Audio protocol is support in the UUID. The display apparatus can only determine if the device supports the LE Audio protocol after obtaining the UUID. Other manufacturers might place the information identifying whether LE Audio protocol is support in the COD (Class of Device) information. The display apparatus can only determine if the device supports the LE Audio protocol after obtaining the COD information.

In some embodiments, before determining whether the device to be processed supports the LE Audio protocol based on the COD information and/or UUID of the device to be processed, the COD information and UUID information of the device to be processed can be obtained. The COD information of the device to be processed can be obtained during the process where the display apparatus can control the Bluetooth communication module to perform device scanning. The UUID of the device to be processed can be obtained during the process where the display apparatus pairs and connects with the device to be processed, or after the display apparatus has successfully paired and connected with the device to be processed.

The COD information can be used to indicate whether the corresponding device is an audio receiving device that supports the LE Audio protocol. Additionally, the Class of Device (COD) information can further be used to identify the type information of the device, such as earphones, keyboards, mice, etc.

In some embodiments, in response to a pairing request triggered for a device to be processed among the scanned devices, it can be determined whether the device to be processed supports the LE Audio protocol based on at least one of the COD information or the UUID information of the device to be processed. Based on determining that the device to be processed supports the LE Audio protocol, the display can be controlled to show a preset indicator for the device to be processed.

The preset indicator can be used to indicate that the device to be processed supports the LE Audio protocol. The display style of the preset indicator can include text, icons, etc. For example, the text “LE Audio” can be displayed in a position corresponding to the device supporting the LE Audio protocol.

As shown in FIG. 30, which is a seventh schematic diagram of a device management page of a display apparatus according to some embodiments, the list of connected devices on this page can show Device 1, Device 2, and Device 3. Device 1, Device 2, and Device 3 are all devices that have established a Bluetooth connection with the display apparatus. Among them, Device 3 is a device that supports the LE Audio protocol, and a preset indicator 1201 can be displayed for Device 3. This preset indicator can be used to indicate that Device 3 supports the LE Audio protocol.

K292: based on determining that the device to be processed supports the LE Audio protocol, establish a Bluetooth connection with the device to be processed based on the LE Audio protocol and the BSA protocol.

In the embodiments, after determining that the device to be processed is an audio receiving device that supports the LE Audio protocol, a Bluetooth connection can be established with the device to be processed based on both the LE Audio protocol and the BSA protocol. After the display apparatus can establish a Bluetooth connection with the device to be processed based on the BSA protocol, it can send the broadcast parameter information of the display apparatus to the device to be processed via the Bluetooth channel established with the device to be processed based on the BSA protocol.

K293: in response to a trigger operation to switch the current audio output channel to a Bluetooth broadcast output channel, obtain the broadcast parameter information of the display apparatus.

In some embodiments, while the display apparatus is playing audio data based on the local speaker output channel, upon receiving a trigger operation to switch the local speaker output channel to the Bluetooth broadcast output channel, it can obtain the broadcast parameter information of the display apparatus. The broadcast parameter information can be used to play the audio data of the display apparatus.

In some embodiments, the display apparatus can further, while playing audio data based on the USB audio output channel, in response to a trigger operation to switch the USB audio output channel to the Bluetooth broadcast output channel, obtain the broadcast parameter information of the display apparatus.

In some embodiments, the display apparatus can further, while playing audio data based on the HDMI output channel, in response to a trigger operation to switch the HDMI output channel to the Bluetooth broadcast output channel, obtain the broadcast parameter information of the display apparatus.

In some embodiments, the display apparatus can further, while playing audio data based on the audio output channel established based on the UMS protocol, in response to a trigger operation to switch the audio output channel established based on the UMS protocol to the Bluetooth broadcast output channel, obtain the broadcast parameter information of the display apparatus.

K294: send the broadcast parameter information to the device to be processed via a Bluetooth channel established with the device to be processed based on the BSA protocol, enabling the device to be processed to synchronously play the audio data transmitted by the display apparatus based on the broadcast parameter information; where the device to be processed is an audio receiving device that has established a Bluetooth connection with the display apparatus based on the LE Audio protocol and the BSA protocol.

In some embodiments, as shown in FIG. 28, after the display apparatus successfully switches from the current audio output channel to the Bluetooth broadcast output channel, an identifier for the Bluetooth broadcast output channel can further be displayed on the sound settings page in the device manager. The identifier for the Bluetooth broadcast output channel can be used to indicate that the display apparatus has sent the broadcast parameter information to the device to be processed via the Bluetooth channel established with the device to be processed based on the BSA protocol, enabling the device to be processed to synchronously play the audio data transmitted by the display apparatus based on the broadcast parameter information.

According to the device control method of some embodiments, first, in response to a pairing request triggered for a device to be processed among the scanned devices, it is determined whether the device to be processed supports the LE Audio protocol. Based on determining that the device to be processed supports the LE Audio protocol, a Bluetooth connection can be established with the device to be processed based on the LE Audio protocol and the BSA protocol. Then, in response to a trigger operation to switch the current audio output channel to a Bluetooth broadcast output channel, the broadcast parameter information of the display apparatus can be obtained. Next, the broadcast parameter information can be sent to the device to be processed via a Bluetooth channel established with the device to be processed based on the BSA protocol, enabling the device to be processed to synchronously play the audio data transmitted by the display apparatus based on the broadcast parameter information. As can be seen, the display apparatus in the embodiments of the disclosure can, after establishing a Bluetooth connection with the device to be processed, send the broadcast parameter information of the display apparatus to the device to be processed via the Bluetooth connection, enabling the device to be processed to play the audio data of the display apparatus based on the broadcast parameter information, thereby achieving the function of switching the current audio output channel to the Bluetooth broadcast output channel.

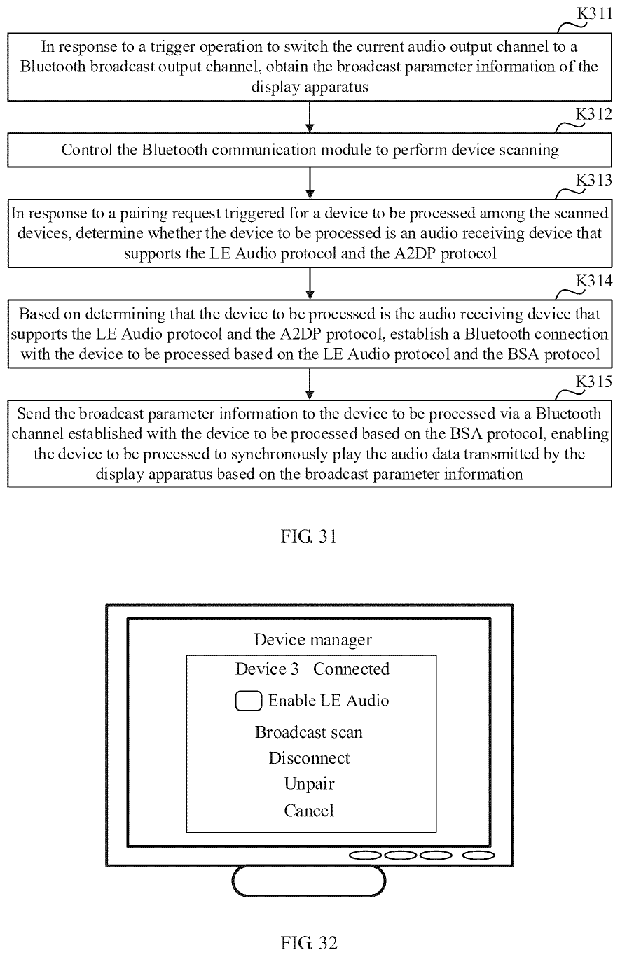

Corresponding to the scenario schematic shown in FIG. 24, FIG. 31 is a ninth schematic flowchart of a device control method according to some embodiments. The method may include, but is not limited to, the following steps K311-K315.

K311: in response to a trigger operation to switch the current audio output channel to a Bluetooth broadcast output channel, obtain the broadcast parameter information of the display apparatus.

K312: control the Bluetooth communication module to perform device scanning.

In the embodiments, when the display apparatus can receive a trigger operation to switch the current audio output channel to the Bluetooth broadcast output channel, it first can obtain the broadcast parameter information of the display apparatus. At this point, the display apparatus is in a broadcast state. It then can control the Bluetooth communication module to perform scanning so that it can subsequently establish a Bluetooth connection with a device to be processed among the scanned devices after scanning at least one device.

In some embodiments, upon entering the device management page, the display apparatus can automatically control the Bluetooth communication module to scan for nearby devices and can display the scanned devices on the device management page of the display. The Bluetooth communication module can be used to interact with other devices supporting Bluetooth via the Bluetooth protocol. For example, the display apparatus can scan for other devices supporting Bluetooth through the Bluetooth communication module.

K313: in response to a pairing request triggered for a device to be processed among the scanned devices, determine whether the device to be processed is an audio receiving device that supports the LE Audio protocol and the A2DP protocol.

In some embodiments, after scanning at least one device, the display apparatus can also control the display to show the at least one scanned device. Upon receiving a pairing request triggered for a device to be processed among the at least one scanned device, the display apparatus can determine whether the device to be processed is an audio receiving device that supports the LE Audio protocol and the A2DP protocol.

An audio receiving device that supports both the LE Audio protocol and the A2DP protocol is a dual-mode device. In practical applications, because dual-mode devices can transmit broadcast protocol packets outward, and these packets carry field information identifying the device as a dual-mode device, during the process where the display apparatus can control the Bluetooth communication module to perform device scanning, if it scans a broadcast protocol packet sent by a device, it can determine based on the field information carried in the broadcast protocol packet that the device is an audio receiving device that supports both the LE Audio protocol and the A2DP protocol.

In some embodiments, upon receiving a pairing request triggered for a device to be processed among the scanned devices, the display apparatus can determine that the device to be processed is an audio receiving device that supports the LE Audio protocol and the A2DP protocol based on the field information carried in the broadcast protocol packet of the device to be processed. For example, if the broadcast protocol packet of the device to be processed carries field information of supporting BR/EDR, it can be determined that the device to be processed is an audio receiving device that supports both the LE Audio protocol and the A2DP protocol.

K314: based on determining that the device to be processed is the audio receiving device that supports the LE Audio protocol and the A2DP protocol, establish a Bluetooth connection with the device to be processed based on the LE Audio protocol and the BSA protocol.

In some embodiments, before establishing a Bluetooth connection with the device to be processed based on the LE Audio protocol and the BSA protocol, it can further be determined whether the display apparatus is currently in a broadcast state. Based on determining that the display apparatus is currently in a broadcast state, the step of establishing a Bluetooth connection with the device to be processed based on the LE Audio protocol and the BSA protocol is executed.

In the embodiments, after switching from the current audio output channel to the Bluetooth broadcast output channel, and before establishing a Bluetooth connection with the device to be processed based on the LE Audio protocol and the A2DP protocol, the display apparatus can further determine whether the display apparatus is in a broadcast state. Based on determining that the display apparatus is currently in the broadcast state, it indicates that the display apparatus has successfully switched from the current audio output channel to the Bluetooth broadcast output channel. At this point, the step of establishing a Bluetooth connection with the device to be processed based on the LE Audio protocol and the BSA protocol is executed.

In some embodiments, based on determining that the device to be processed is an audio receiving device that supports both the LE Audio protocol and the A2DP protocol, the display apparatus can further be controlled to establish a Bluetooth connection with the device to be processed based on the A2DP protocol.

In some embodiments, after the display apparatus controls the Bluetooth communication module to establish a Bluetooth connection with the device to be processed based on the A2DP protocol, it can further, in response to a connection protocol switching command for the device to be processed, control the Bluetooth communication module to disconnect the Bluetooth connection established based on the A2DP protocol and control the local speaker to play audio data. Furthermore, the display apparatus can control the Bluetooth communication module to establish a Bluetooth connection with the device to be processed based on the LE Audio protocol, control the local speaker to stop playing audio data, and synchronize the audio data of the display apparatus to the device to be processed via the Bluetooth connection established with the device to be processed based on the LE Audio protocol.

As shown in FIG. 30, the list of connected devices on the device management page can show Device 1, Device 2, and Device 3, which have already established Bluetooth connections with the display apparatus. In response to a selection on Device 3 from a user, a pop-up window corresponding to Device 3 can be displayed on the current page.

As shown in FIG. 32, which is an eighth schematic diagram of a device management page of a display apparatus according to some embodiments, the page can display a pop-up window corresponding to Device 3. In response to a selection on the “Enable LE Audio” control, the display apparatus can control the Bluetooth communication module to disconnect the Bluetooth connection established with Device 3 based on the A2DP protocol and can control the local speaker to play audio data. The display apparatus then can control the Bluetooth communication module to establish a Bluetooth connection with the device to be processed based on the LE Audio protocol, can control the local speaker to stop playing audio data, and synchronizes the audio data of the display apparatus to the device to be processed via the Bluetooth connection established with the device to be processed based on the LE Audio protocol.

K315: send the broadcast parameter information to the device to be processed via a Bluetooth channel established with the device to be processed based on the BSA protocol, enabling the device to be processed to synchronously play the audio data transmitted by the display apparatus based on the broadcast parameter information.

According to the device control method of some embodiments, first, in response to a trigger operation to switch the current audio output channel to a Bluetooth broadcast output channel, the broadcast parameter information of the display apparatus can be obtained. Then, the Bluetooth communication module can be controlled to perform scanning. In response to a pairing request triggered for a scanned device to be processed, it is determined whether the device to be processed is an audio receiving device that supports the LE Audio protocol and the A2DP protocol. Based on determining that the device to be processed is an audio receiving device that supports the LE Audio protocol and the A2DP protocol, a Bluetooth connection can be established with the device to be processed based on the LE Audio protocol and the BSA protocol. Furthermore, the broadcast parameter information can be sent to the device to be processed via a Bluetooth channel established with the device to be processed based on the BSA protocol, enabling the device to be processed to synchronously play the audio data transmitted by the display apparatus based on the broadcast parameter information. As can be seen, the display apparatus in the embodiments of the disclosure can, after switching to the Bluetooth broadcast output channel, establish a Bluetooth connection with an audio receiving device that supports both the LE Audio protocol and the A2DP protocol. The display apparatus can then send the broadcast parameter information of the display apparatus to the device to be processed via the Bluetooth connection, enabling the device to be processed to play the audio data of the display apparatus based on the broadcast parameter information, thereby achieving the function of switching the current audio output channel to the Bluetooth broadcast output channel.

Furthermore, considering that current playback devices, such as televisions, when playing music or videos, often send audio to be played to Bluetooth speakers via Asynchronous Connection-Less (ACL) link to achieve better sound playback effect. After receiving the audio to be played, the Bluetooth speakers play the sound. However, due to current limitations in the Bluetooth links within televisions, a TV can typically only establish an ACL link with one Bluetooth speaker. Therefore, a single Bluetooth speaker can play the sound for one channel, making it impossible to achieve stereo playback effect.

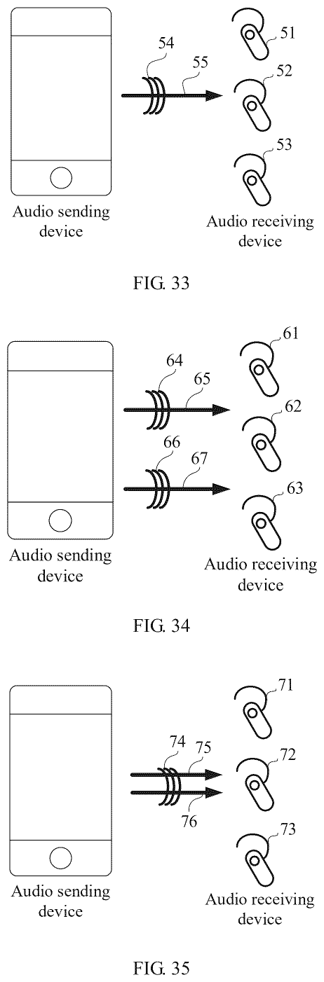

To facilitate understanding of the aforementioned content, the relationship between extended advertising, periodic advertising, and Broadcast Isochronous Stream (BIS) mentioned earlier will first be explained in more detail, as shown in FIG. 33. FIG. 33 is a first schematic diagram of a configuration method for broadcasting BIS audio (which can be a BIS stream) according to some embodiments. As shown in FIG. 33, the example uses three audio receiving devices, namely Bluetooth earphone 51, Bluetooth earphone 52, and Bluetooth earphone 53 shown in the figure. In this configuration, one audio sending device broadcasts one BIS audio stream 54. This single BIS audio stream 54 can include audio for one sound channel 55. Nearby Bluetooth earphones 51, 52, and 53 can receive this BIS audio stream 54 to obtain the audio for sound channel 55 from the BIS audio stream 54.

FIG. 34 is a second schematic diagram of a configuration method for broadcasting BIS audio according to some embodiments. As shown in FIG. 34, the example uses three audio receiving devices, namely Bluetooth earphone 61, Bluetooth earphone 62, and Bluetooth earphone 63 shown in the figure. In this configuration, one audio sending device broadcasts two BIS audio streams, shown as BIS audio stream 64 and BIS audio stream 66 in FIG. 34. BIS audio stream 64 can include audio for one sound channel 65, and BIS audio stream 66 can include audio for one sound channel 67. Sound channels 65 and 67 can be the same sound channel or different sound channels. Bluetooth earphones 61, 62, and 63 can all receive both BIS audio stream 64 and BIS audio stream 66, obtain the audio for sound channel 65 from BIS audio stream 64, and obtain the audio for sound channel 67 from BIS audio stream 66.

FIG. 35 is a third schematic diagram of a configuration method for broadcasting BIS audio according to some embodiments. As shown in FIG. 35, the example uses three audio receiving devices, namely Bluetooth earphone 71, Bluetooth earphone 72, and Bluetooth earphone 73 shown in the figure. In this configuration, one audio sending device broadcasts one BIS audio stream 74. This BIS audio stream 74 can include audio for two sound channels, namely the audio for sound channel 75 and the audio for sound channel 76 shown in FIG. 35. Nearby Bluetooth earphones 71, 72, and 73 can receive this BIS audio stream 74 to obtain the audio for both sound channel 75 and sound channel 76 from the BIS audio stream 74. In FIG. 35, the multiple audio receiving devices are Bluetooth earphones 71, 72, and 73. Sound channels 75 and 76 in FIG. 35 can be different sound channels; for example, sound channel 75 is the front left channel, and channel 76 is the front right channel.

According to the device control method of some embodiments, an audio sending device can transmit BIS audio for a plurality of sound channels to one or more audio receiving devices by broadcasting BIS audio. In the embodiments of the disclosure, any of the BIS audio broadcasting configuration methods similar to those shown in FIG. 33, FIG. 34, or FIG. 35 can be used to broadcast BIS audio.

The device control method of the embodiments of the disclosure can be implemented through a display apparatus and multiple audio receiving devices. The display apparatus can be a mobile phone, television, computer, etc. The audio receiving devices can be speakers, earphones, etc. The device control method provided in the embodiments of the disclosure may include a configuration phase and a multi-channel audio output phase. The configuration phase can involve configuring the BIS audio matching the sound channels for the audio receiving devices (i.e., configuring BIS identifiers) and configuring the volume for the display apparatus and audio receiving devices. The configuration phase can be implemented through the display apparatus and/or a control terminal, while the multi-channel audio output phase can be implemented by the display apparatus broadcasting BIS audio to the audio receiving devices. The control terminal can be a mobile terminal, such as a mobile phone, tablet computer, remote control, wearable device, etc., that can be used to configure BIS identifiers and volume for audio receiving devices. Wearable devices may include smart watches, smart bands, etc.

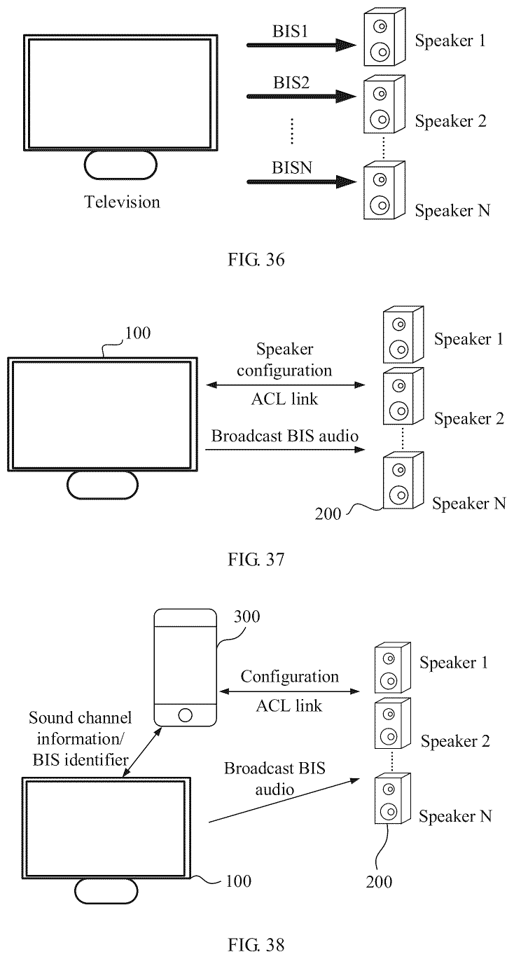

FIG. 36 is a third schematic diagram of a scenario of a device control method according to some embodiments. As shown in FIG. 36, the example uses a television as the display apparatus and N speakers as the audio receiving devices. In the scenario, the television and N speakers are included. The television can pre-configure BIS audio matching the sound channels for different speakers, then broadcast N BIS audio streams. Accordingly, each speaker can receive the N BIS audio streams and select the BIS audio stream matching its sound channel for playback. Different BIS streams may correspond to different sound channels. In the embodiments, N is greater than or equal to 1.

FIG. 37 is a fourth schematic diagram of a scenario for a device control method according to some embodiments. As shown in FIG. 37, the display apparatus 100 can perform speaker configuration for multiple audio receiving devices 200 via ACL links. After configuration is completed, the display apparatus can send audio for multiple channels to the multiple audio receiving devices 200 by broadcasting BIS audio. In FIG. 37, the multiple audio receiving devices 200 are N speakers, labeled as Speaker 1, Speaker 2, . . . , Speaker N.

In some embodiments, the device control method can be implemented through a display apparatus, a control terminal, and multiple audio receiving devices. The control terminal can be a mobile phone, tablet computer, etc., and is used for configuring the audio receiving devices.

FIG. 38 is a fifth schematic diagram of a scenario for a device control method according to some embodiments. As shown in FIG. 38, the display apparatus 100 can establish a wireless connection with a mobile phone. The display apparatus 100 can send the sound channel information to be configured to the control terminal 300. The control terminal 300 can then configure the multiple audio receiving devices 200 via ACL links based on the sound channel information. The display apparatus 100 can send audio for multiple sound channels to the multiple audio receiving devices 200 by broadcasting BIS audio. In FIG. 38, the multiple audio receiving devices 200 are N speakers, labeled as Speaker 1, Speaker 2, . . . , Speaker N. Optionally, the control terminal 300 can notify the display apparatus 100 with a configuration completion message after configuration is finished. After the display apparatus 100 can receive the configuration completion message, it can send audio for multiple sound channels to the multiple audio receiving devices 200 by broadcasting BIS audio.

For the scenario shown in FIG. 37, when implementing the device control method according to some embodiments, the various components of the display apparatus 100 can perform the following functions.

In some embodiments, at least one processor is further configured to execute computer instructions to cause the display apparatus to perform: obtaining sound channel information to be configured; controlling the Bluetooth communication module in the communicating device 120 to determine several audio receiving devices to be connected via Bluetooth scanning; controlling the Bluetooth communication module to establish ACL links with the plurality of audio receiving devices; configuring a BIS identifier for each audio receiving device among the plurality of audio receiving devices based on the sound channel information to be configured; sending the configured BIS identifier to each audio receiving device among the plurality of audio receiving devices via the ACL link, where the plurality of audio receiving devices are some or all of the several audio receiving devices; controlling the Bluetooth communication module in the communicating device 120 to broadcast a plurality of BIS streams, each BIS stream including BIS audio data and a BIS identifier corresponding to the BIS audio stream, enabling the plurality of audio receiving devices to obtain target BIS audio from the plurality of BIS streams, where the BIS identifier corresponding to the target BIS audio stream matches the configured BIS identifier.

In some embodiments, at least one processor is further configured to execute computer instructions to cause the display apparatus to perform: sending a configured volume parameter to each audio receiving device among the plurality of audio receiving devices via the ACL link.

In some embodiments, at least one processor is further configured to execute computer instructions to cause the display apparatus to perform: after determining the several audio receiving devices to be connected via Bluetooth scanning, and before controlling the Bluetooth communication module to establish ACL links with the plurality of audio receiving devices, determining the plurality of audio receiving devices that support Bluetooth Low Energy from among the several audio receiving devices.

In some embodiments, at least one processor is further configured to execute computer instructions to cause the display apparatus to perform: while determining the plurality of audio receiving devices that support Bluetooth Low Energy from the several audio receiving devices, obtaining a UUID corresponding to each audio receiving device among the several audio receiving devices; selecting, from the several audio receiving devices, the plurality of audio receiving devices, wherein the UUID corresponding to each of the plurality of audio receiving devices indicates that a device type supports Bluetooth Low Energy.

In some embodiments, at least one processor is further configured to execute computer instructions to cause the display apparatus to perform: while obtaining the sound channel information to be configured, obtaining sound channel information of an audio media resource being played currently; determining sound channel information to be configured that matches the sound channel information of the audio media resource from the sound channel information supported by the display apparatus.

In some embodiments, at least one processor is further configured to execute computer instructions to cause the display apparatus to perform: while obtaining the sound channel information to be configured, receiving an instruction for selecting a sound channel combination; in response to the instruction for selecting the sound channel combination, obtaining the sound channel information to be configured.

For the scenario shown in FIG. 38, while implementing the device control method according to some embodiments, the various components of the display apparatus 100 can perform the following functions.

In some embodiments, at least one processor is further configured to execute computer instructions to cause the display apparatus to perform: determining sound channel information to be configured; and controlling the communicating device 120 to send the sound channel information to be configured to the control terminal 300, enabling the control terminal 300 to configure speakers for each sound channel of the display apparatus based on the sound channel information to be configured. After the control terminal 300 configures speakers (i.e., configures different audio receiving devices) for each sound channel of the display apparatus, broadcasting the plurality of BIS streams, so that the speakers configured for the respective sound channels of the display apparatus can receive and play the BIS audio corresponding to their own channels.

In the embodiments of the disclosure, the display apparatus can transmit BIS audio for the plurality of sound channels to the plurality of audio receiving devices by broadcasting BIS streams, enabling the audio receiving devices to play the BIS audio corresponding to their own channels. This achieves stereo playback effect without occupying the current Bluetooth links in the display apparatus.

For the scenario shown in FIG. 37, while implementing the device control method according to some embodiments, the various components of the audio receiving device 200 can perform the following functions.

In some embodiments, the processor is configured to: control the Bluetooth communication module in the communicating device 220 to receive a scan signal sent by the display apparatus; in response to the scan signal sent by the display apparatus, control the Bluetooth communication module to establish an ACL link with the display apparatus; receive a BIS identifier configured by the display apparatus via the ACL link; control the Bluetooth communication module in the communicating device 220 to receive the plurality of BIS streams, each BIS stream including BIS audio data and the BIS identifier corresponding to the BIS audio stream; obtain target BIS audio from the plurality BIS audio streams, where the BIS identifier corresponding to the target BIS audio stream matches the configured BIS identifier.

For the scenario shown in FIG. 38, while implementing the device control method according to some embodiments, the various components of the audio receiving device 200 can perform the following functions.

In some embodiments, the Bluetooth communication module in the communicating device 220 is configured to: receive a scan signal sent by the control terminal 300; the processor is configured to: in response to the scan signal sent by the control terminal 300, control the Bluetooth communication module to establish an ACL link with the control terminal 300; receive a BIS identifier configured by the control terminal 300 via the ACL link; the Bluetooth communication module in the communicating device 220 is configured to: receive the plurality of BIS streams, each BIS stream including BIS audio data and the BIS identifier corresponding to the BIS audio stream; obtain target BIS audio from the plurality BIS audio stream, where the BIS identifier corresponding to the target BIS audio stream matches the configured BIS identifier.

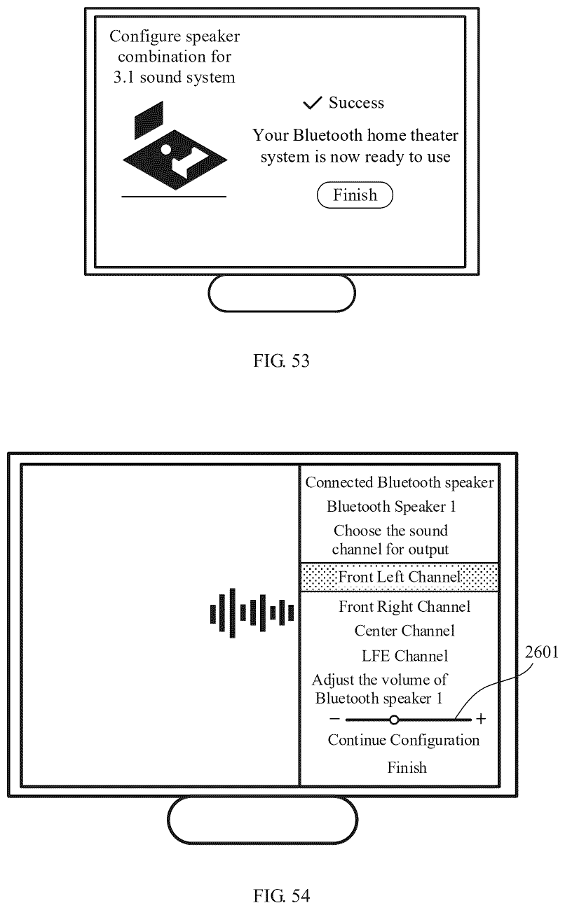

Referring to the control device 300 shown in FIG. 53, in some embodiments, the processor 310 of the control device 300 is configured to control the communicating device 320 to receive the sound channel information to be configured sent by the display apparatus. The processor 310 can control the Bluetooth communication module in the communicating device 320 to determine several audio receiving devices to be connected via Bluetooth scanning, and cause the control terminal to establish ACL links with the plurality of audio receiving devices.

The processor 310 is further configured to: send the configured BIS identifier to each audio receiving device among the plurality of audio receiving devices via the ACL link based on the sound channel information to be configured; and configure volume of the plurality of audio receiving devices via the ACL link.

In the embodiments of the disclosure, the audio receiving devices can be configured through the display apparatus to set up speakers corresponding to different sound channels for the display apparatus. The audio receiving device can further be configured through the control terminal to set up speakers corresponding to different sound channels for the display apparatus. Therefore, the device control method according to some embodiments offers flexible configuration options.

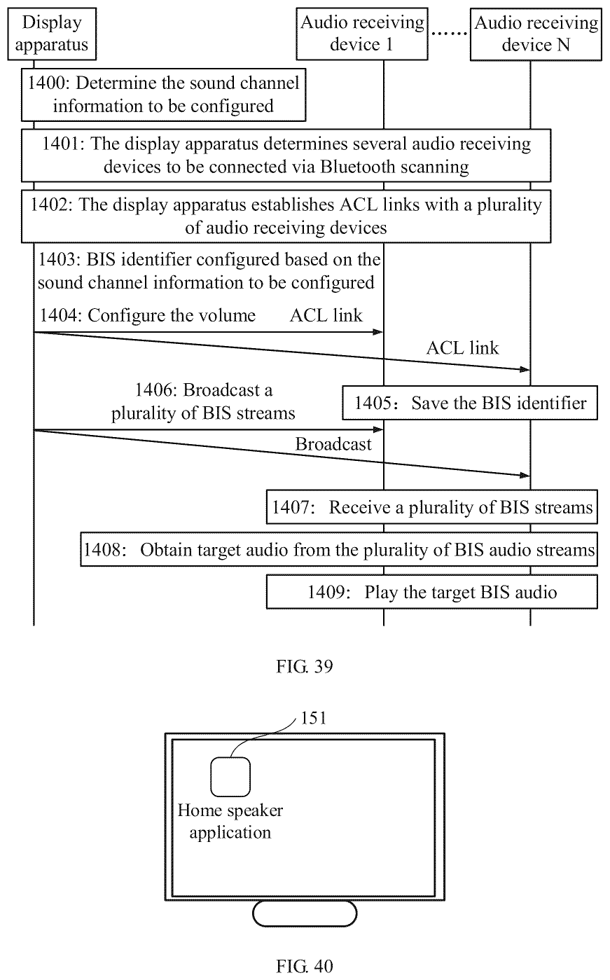

Corresponding to the scenario shown in FIG. 37, embodiments of the disclosure provide a device control method as shown in FIG. 39 below.

FIG. 39 is a ninth schematic flowchart of a device control method according to some embodiments. As shown in FIG. 39, the method can be implemented through interaction between the display apparatus and N audio receiving devices. FIG. 39 only can show audio receiving device 1 and audio receiving device N. The audio receiving devices involved in the following steps can be any audio receiving device among these N audio receiving devices. The method may include, but is not limited to, the following steps.

1400: the display apparatus can determine the sound channel information to be configured.

The sound channel information to be configured can be information about a sound channel combination of one or more sound channels. In some embodiments, a 2.0 sound channel combination for two sound channels can include a front left channel and a front right channel. Sound channel combinations for three sound channels include a 2.1 sound channel combination and a 3.0 sound channel combination. The 2.1 sound channel combination can include a front left channel, a front right channel, and a low-frequency effects (LFE) channel. The 3.0 sound channel combination can include a front left channel, a front right channel, and a center channel. Sound channel combinations for four channels include a 3.1 sound channel combination, a 2.2 sound channel combination, and a 4.0 sound channel combination. The 3.1 sound channel combination can include a front left channel, a front right channel, a center channel, and an LFE channel. The 2.2 sound channel combination can include a front left channel, a front right channel, and two LFE channels. The 4.0 sound channel combination can include a front left channel, a front right channel, a left surround channel, and a right surround channel.

1401: the display apparatus can determine several audio receiving devices to be connected via Bluetooth scanning.

In the embodiments, the display apparatus can select some devices from the aforementioned several audio receiving devices to serve as speakers for various sound channels based on the sound channel information to be configured.

In the embodiments, before the display apparatus can broadcast multiple BIS audio streams, it can first scan for several audio receiving devices to be connected and configure a plurality of audio receiving devices according to the sound channel combination information to be configured. During the configuration process, Bluetooth scanning for audio receiving devices is required, and configuration is performed via ACL links.

In the embodiments, the scanning and configuration of audio receiving devices can be performed while the display apparatus is currently playing audio media resource, or can be performed while the display apparatus is not playing any audio media resource.

In some embodiments, a home speaker application can be installed on the display apparatus. The home speaker application can be a third-party application or a system application. The application identifier of the home speaker application can be displayed on the interface of the display apparatus. In some embodiments, FIG. 40 is a schematic diagram of an interface displaying an application identifier of a Bluetooth speaker application in a display apparatus according to some embodiments. As shown in FIG. 40, the display apparatus is a television, and the screen of this television can display the application identifier 151 of the Bluetooth speaker application.

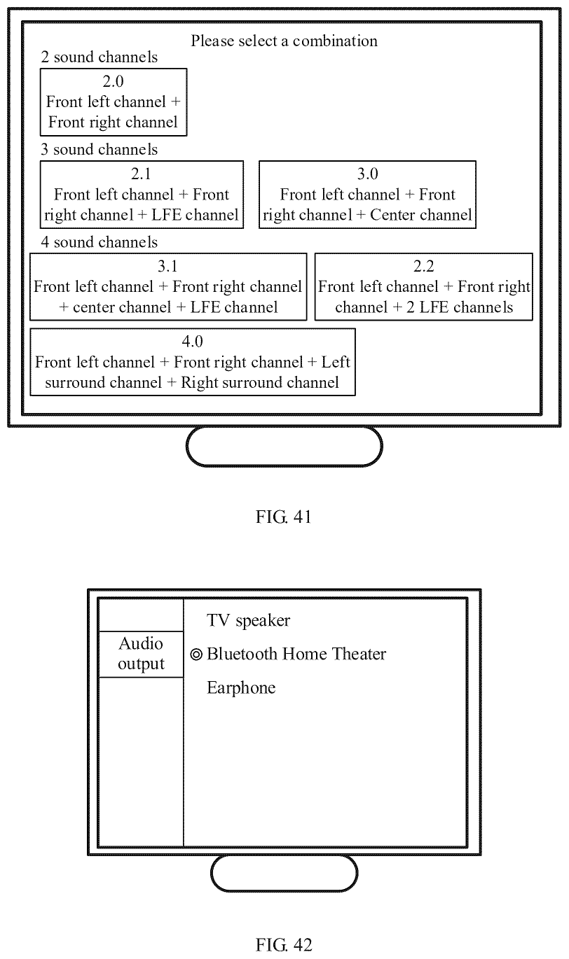

In response to a user's operation for starting the home speaker application, an interface for sound channel combination selection can be displayed on the display apparatus. FIG. 41 is a schematic diagram of an interface for channel combination selection according to some embodiments. The operation for starting the home speaker application can be a click on the application identifier of the home speaker application. As shown in FIG. 41, the interface for channel combination selection can include identifiers for 6 combinations. A 2.0 sound channel combination for two channels can include a front left channel and a front right channel. Sound channel combinations for three channels include a 2.1 sound channel combination and a 3.0 sound channel combination. The 2.1 sound channel combination can include a front left channel, a front right channel, and an LFE channel. The 3.0 sound channel combination can include a front left channel, a front right channel, and a center channel. Sound channel combinations for four channels include a 3.1 sound channel combination, a 2.2 sound channel combination, and a 4.0 sound channel combination. The 3.1 sound channel combination can include a front left channel, a front right channel, a center channel, and an LFE channel. The 2.2 sound channel combination can include a front left channel, a front right channel, and two LFE channels. The 4.0 sound channel combination can include a front left channel, a front right channel, a left surround channel, and a right surround channel.

In some embodiments, the interface for sound channel combination selection shown in FIG. 41 can be an interface within the home speaker application, and can be displayed through triggering operations on the home speaker application.

In other embodiments, the interface for sound channel combination selection shown in FIG. 41 can be an interface within the settings interface (also called the setting interface) of the display apparatus.

For the sound channel combinations displayed in the interface for sound channel combination selection shown in FIG. 41, when the display apparatus is not currently playing audio media resource, a user command received by the display apparatus can be used to select a certain sound channel combination. This user command can be a user's touch operation on the identifier of a certain sound channel combination in the interface for sound channel combination selection, or it can be a selection command for a certain sound channel combination issued by the user via the display apparatus's remote control or other associated device.

For the sound channel combinations displayed in the interface for sound channel combination selection shown in FIG. 41, when the display apparatus is currently playing audio media resource, the sound channel information to be configured (the sound channel combination to be configured) can be determined based on the sound channel information of the audio media resource currently being played by the display apparatus. That is, the corresponding sound channel combination can be selected from the sound channel combinations displayed in the interface for sound channel combination selection.

In some embodiments, determining the sound channel combination to be configured based on the sound channel information of the audio media resource currently played by the display apparatus can involve selecting, from the sound channel combinations displayed in the interface for channel combination selection, a sound channel combination that matches the sound channel information of the audio media resource currently played by the display apparatus. If a first sound channel combination matching the sound channel information of the audio media resource exists among the sound channel combinations displayed in the interface for channel combination selection, this first sound channel combination can be selected for subsequent configuration. If no first sound channel combination matching the sound channel information of the audio media resource exists among the sound channel combinations displayed in the interface for channel combination selection, a second sound channel combination with highest similarity to the sound channel information of the audio media resource among the sound channel combinations can be selected for subsequent configuration. The sound channel combinations displayed in the interface for channel combination selection are the sound channel combinations currently supported by the display apparatus.

The second sound channel combination with the highest similarity to the sound channel information of this audio media resource can be: among the sound channel combinations currently supported by the display apparatus, the sound channel combination that has most identical sound channels with the sound channel information of the audio media resource.

In some embodiments, determining the sound channel combination to be configured based on the sound channel information of the audio media resource currently played by the display apparatus may include, if no sound channel combination matching the sound channel information of the audio media resource currently played by the display apparatus exists among the sound channel combinations supported by the display apparatus, determining a sound channel combination with highest configuration among the sound channel combinations supported by the display apparatus as the sound channel information to be configured. Here, the sound channel combination with the highest configuration may be the sound channel combination with the highest number of channels.

In some embodiments, assume the sound channel information of the audio media resource currently played by the display apparatus is a 5.1 sound channel combination, which can include a center channel, front left channel, front right channel, left surround channel, right surround channel, and low-frequency effects (LFE) channel. The sound channel combinations displayed in FIG. 41 include: 2.0 sound channel combination, 2.1 sound channel combination, 3.0 sound channel combination, 3.1 sound channel combination, 2.2 sound channel combination, and 4.0 sound channel combination. Among them, the 4.0 sound channel combination can include a front left channel, front right channel, center channel, and LFE channel. This 4.0 sound channel combination has the highest similarity to the 5.1 sound channel combination. Therefore, if the sound channel information of the audio media resource indicates 5.1 sound channel combination, the 4.0 sound channel combination can be selected for subsequent configuration.

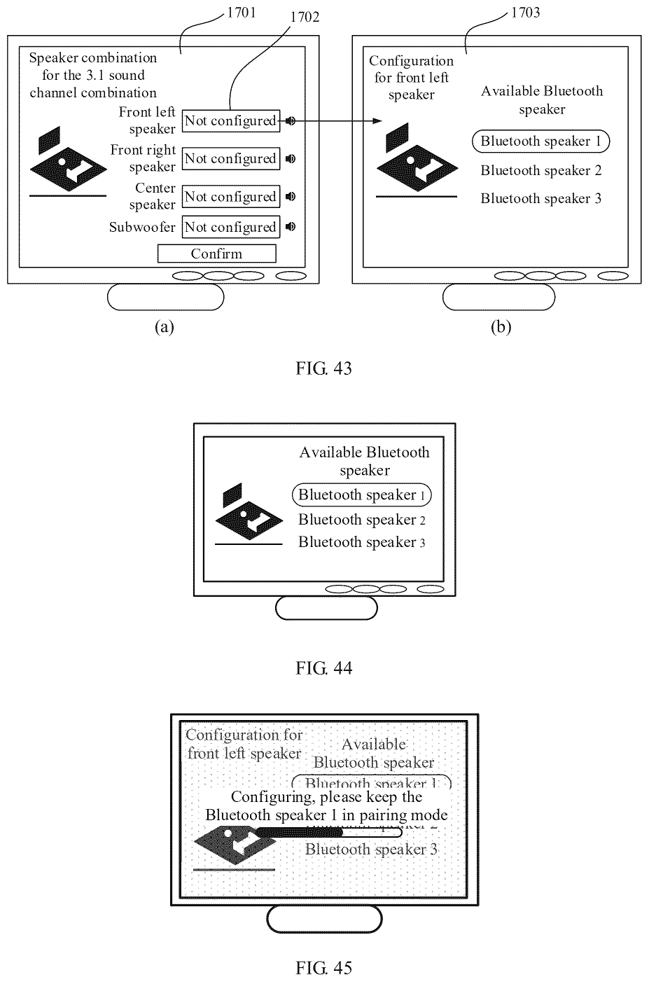

In some embodiments, assume the sound channel information of the audio media resource currently played by the display apparatus indicates a 3.1 sound channel combination. The selectable sound channel combinations displayed in FIG. 41 include: 2.0 sound channel combination, 2.1 sound channel combination, 3.0 sound channel combination, 3.1 sound channel combination, 2.2 sound channel combination, and 4.0 sound channel combination. The 3.1 sound channel combination displayed in FIG. 43 is identical to the sound channel information of the audio media resource, so the 3.1 sound channel combination can be selected for subsequent configuration.

In some embodiments, in response to a user's operation for starting the home speaker application, the interface for audio output mode selection shown in FIG. 42 is first displayed. Only in response to a selection for the “Bluetooth Home Theater” audio output mode in this interface for audio output mode selection, the interface for channel combination selection shown in FIG. 41 can be displayed. In the “Bluetooth Home Theater” audio output mode, multiple audio receiving devices can be configured for the display apparatus to output audio for different sound channels. FIG. 42 is a schematic diagram of an interface for audio output mode selection according to some embodiments.

In some embodiments, after selecting a certain sound channel combination, the speakers for different sound channels in the selected sound channel combination can be configured as different audio receiving devices, as shown in FIG. 41 and FIG. 43 below.

FIG. 43 is a first schematic diagram of a setup interface for configuring a speaker combination according to some embodiments. After selecting the 3.1 sound channel combination in the interface for channel combination selection shown in FIG. 16, interface 1701 shown in FIG. 43 (A) can be displayed. This interface 1701 is the setup interface for speaker combination for the 3.1 sound channel combination, and can show the speaker combination to be configured corresponding to this 3.1 sound channel combination, including a front left speaker, front right speaker, center speaker, and subwoofer. The front left speaker in this speaker combination corresponds to the front left channel in the 3.1 sound channel combination, the front right speaker corresponds to the front right channel, the center speaker corresponds to the center channel, and the subwoofer corresponds to the LFE channel. As shown in FIG. 43 (A), after the television can receive a user's trigger operation on the setup control 1702 for the front left speaker, it can trigger the television to determine one or more audio receiving devices to be connected via Bluetooth scanning (i.e., execute step 1401 above) and display the setup interface 1703 for the front left speaker shown in FIG. 43 (B). This front left speaker setup interface 1703 can display the identifiers of the audio receiving devices to be connected: “Bluetooth Speaker 1”, “Bluetooth Speaker 2”, and “Bluetooth Speaker 3”.

In some embodiments, after selecting a certain sound channel combination, the audio receiving devices discovered by the display apparatus via its Bluetooth scanning function can be determined first. Then, the display apparatus can select different audio receiving devices from the discovered ones to configure as speakers for different sound channels, as shown in FIGS. 44, 45, and 46.

FIG. 44 is a schematic diagram of an interface for scanning audio receiving devices according to some embodiments. After selecting the 3.1 sound channel combination in the interface for channel combination selection shown in FIG. 41, the display apparatus can be triggered to perform Bluetooth scanning, pair with nearby Bluetooth devices, and determine the scanned Bluetooth devices as available Bluetooth speakers. The interface shown in FIG. 44 can be displayed, showing the device identifiers corresponding to the available Bluetooth speakers: “Bluetooth Speaker 1”, “Bluetooth Speaker 2”, and “Bluetooth Speaker 3”.

After selecting the device identifier corresponding to the “Bluetooth Speaker 1” Bluetooth speaker in FIG. 44, the audio receiving device indicated by “Bluetooth Speaker 1” and the display apparatus can perform pairing and connection, and the interface shown in FIG. 45 can be displayed. FIG. 45 is a schematic diagram of a pairing interface according to some embodiments.

It should be noted that, in response to a user's operation for starting the home speaker application, the display apparatus can first determine if this is the first time performing speaker configuration (i.e., configuring speakers for the display apparatus for the first time). If it is the first time, it can trigger the display of the interface for channel combination selection shown in FIG. 41 for subsequent configuration operations. If it is not the first time, the configuration information from the previous speaker configuration can be displayed first, allowing the user to decide whether to reconfigure.

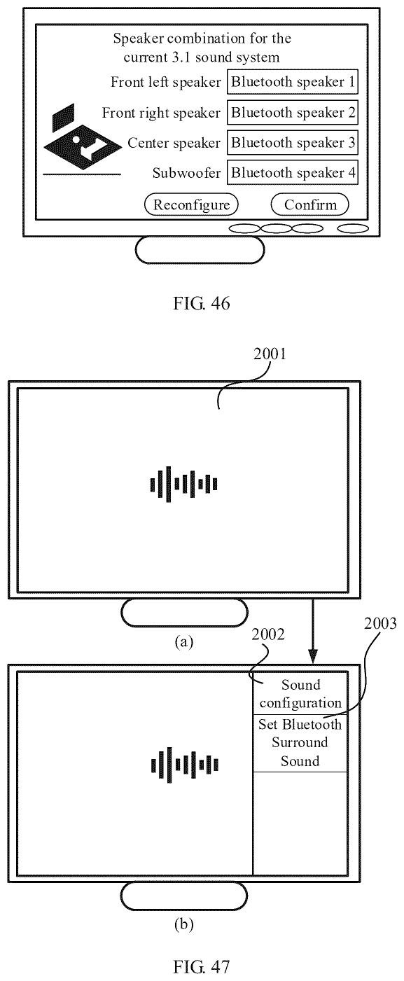

In some embodiments, FIG. 46 is a schematic diagram of an interface showing configuration information after speaker configuration has been performed according to some embodiments. In response to a user's operation for starting the home speaker application, for cases where it is not the first configuration, the interface shown in FIG. 46 can be triggered to display. It can be seen that the interface shown in FIG. 46 can show the identifiers of the Bluetooth speakers currently configured by the display apparatus for the speakers corresponding to each sound channel. The front left speaker corresponding to the front left channel can be configured as the audio receiving device indicated by “Bluetooth Speaker 1”; the front right speaker corresponding to the front right channel can be configured as the audio receiving device indicated by “Bluetooth Speaker 2”; the center speaker corresponding to the center channel can be configured as the audio receiving device indicated by “Bluetooth Speaker 3”; the subwoofer corresponding to the LFE channel can be configured as the audio receiving device indicated by “Bluetooth Speaker 4”. Furthermore, the interface also can show a “Reconfigure” control for triggering modification of the speaker configuration, and a “Confirm” control for triggering confirmation to use the currently saved speaker configuration.

In some embodiments, during the process of determining several audio receiving devices to be connected via Bluetooth scanning, the display apparatus can first enable the Bluetooth scanning function to scan for Bluetooth devices near the display apparatus. After the display apparatus can receive broadcast information sent by a Bluetooth device, it can determine the Bluetooth device that sent this broadcast information as an audio receiving device to be connected. This broadcast information can include the identifier of the Bluetooth device.

In the above embodiment, all Bluetooth devices for which the display apparatus can receive broadcast information are determined as audio receiving devices to be connected and can be displayed in the speaker setup interface. For example, the Bluetooth Speaker 1, Bluetooth Speaker 2, and Bluetooth Speaker 3 being displayed in interface 1703 shown in FIG. 43 (B) indicates that the display apparatus can receive broadcast information from these Bluetooth devices. Since BIS audio will need to be sent later based on LE Audio technology, if there is a device(s) not supporting LE Audio technology among Bluetooth Speaker 1, Bluetooth Speaker 2, and Bluetooth Speaker 3, the subsequent audio transmission process will be affected, and BIS identifiers cannot be configured. Therefore, after receiving a user's command to select a certain Bluetooth speaker (e.g., Bluetooth Speaker 1) in interface 1703, an ACL link can first be established with this Bluetooth Speaker 1. Through the ACL link, the type information of Bluetooth Speaker 1 sent by Bluetooth Speaker 1 can be obtained. Based on determining that Bluetooth Speaker 1 is a device that supports LE Audio technology, the Bluetooth Speaker 1 can be determined as an audio receiving device to be connected. The type information of Bluetooth Speaker 1 can be its UUID.

In some embodiments, during the process of determining several audio receiving devices to be connected via Bluetooth scanning, the display apparatus can first enable the Bluetooth scanning function to scan for Bluetooth devices near the display apparatus. After the display apparatus can receive broadcast information sent by a Bluetooth device, it can first obtain the type information of the Bluetooth device from the broadcast information. Based on determining that the device supports LE Audio technology, the Bluetooth device that sent the broadcast information can be determined as an audio receiving device to be connected. The broadcast information can include the identifier of the Bluetooth device and its type information.

The type information of the Bluetooth device can be its UUID. Since the UUIDs supporting Classic Bluetooth technology and LE Audio technology are different, the UUID can be used to identify whether the UUID of the Bluetooth device is of the type that supports LE Audio technology. If the UUID is determined to be of the type supporting LE Audio technology, the Bluetooth device can be considered to be a device that supports LE Audio technology.

The following describes a specific embodiment of the process for triggering the execution of the aforementioned step 1401 when the display apparatus is currently playing audio media resources.

FIG. 47 is a schematic diagram of an audio media resource playback interface according to some embodiments. As shown in FIG. 47, when the display apparatus is playing an audio media resource, the audio playback interface 2001 shown in FIG. 47 (A) can be displayed. After the display apparatus can receive a sound configuration instruction, the sound configuration interface 2002 shown in FIG. 47 (B) can be invoked on top of the audio playback interface. This sound configuration interface 2002 can include a control 2003 for “Set Bluetooth Surround Sound”. After the display apparatus can receive a command for selecting control 2003, it can obtain the sound channel information of the audio media resource being played currently and proceed with the selection of a sound channel combination based on this sound channel information.

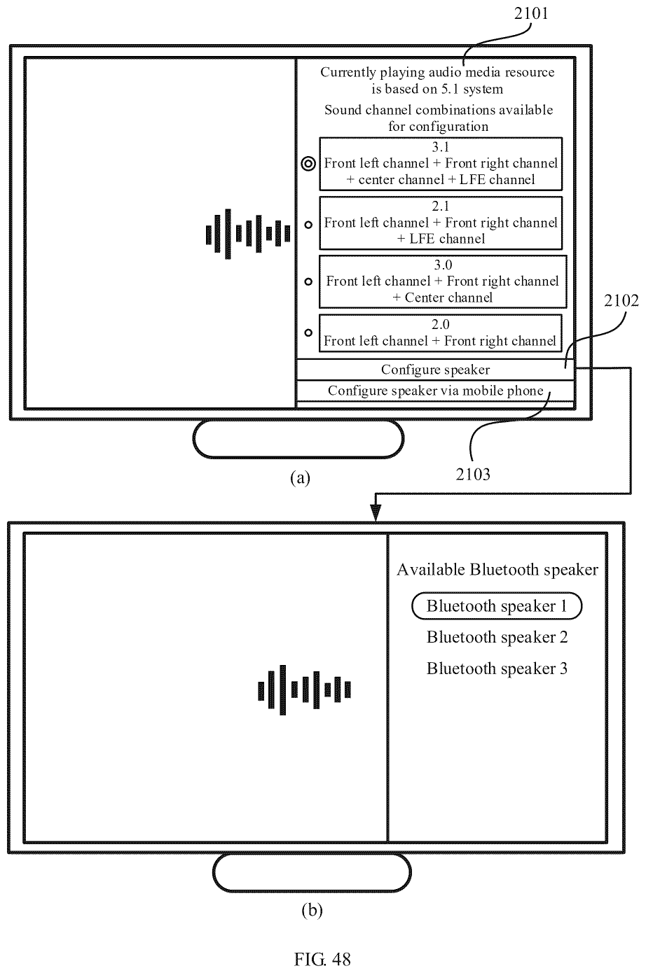

FIG. 48 is a schematic diagram of an interface for sound channel combination selection according to some embodiments. FIG. 48 (A) can show an interface 2101 for sound channel combination selection. This interface can show that the currently playing audio media resource is based on 5.1 sound channel combination, and can show 4 sound channel combinations for the user to choose from for configuration. The 4 sound channel combinations are: 3.1 sound channel combination, 2.1 sound channel combination, 3.0 sound channel combination, and 2.0 sound channel combination.

In some embodiments, in the interface 2101 for channel combination selection shown in FIG. 48 (A), the user can learn the sound channel combination of the currently playing audio media resource and the available sound channel combinations, making it convenient for the user to choose. The display apparatus can then respond to the user's command to select one channel combination from the currently selectable sound channel combinations.

In some embodiments, the display apparatus can automatically select the 3.1 sound channel combination, which has the highest similarity to the 5.1 sound channel combination of the currently playing audio media resource, from the selectable sound channel combinations for configuration.

After a sound channel combination can be selected in the interface 2101 for channel combination selection shown in FIG. 48 (A), and a command for selecting the “Configure Speakers” control 2102 is received, the display apparatus can be triggered to perform Bluetooth scanning, pair with nearby Bluetooth devices, determine the scanned Bluetooth devices as available Bluetooth speakers, and display the interface shown in FIG. 48 (B). This interface can show the device identifiers corresponding to the available Bluetooth speakers: “Bluetooth Speaker 1”, “Bluetooth Speaker 2”, and “Bluetooth Speaker 3”. Here, Bluetooth Speaker 1, Bluetooth Speaker 2, and Bluetooth Speaker 3 are Bluetooth devices scanned by the display apparatus via its Bluetooth scanning function. Furthermore, after the display apparatus can receive an instruction for selecting the device identifier “Bluetooth Speaker 1” on the interface shown in FIG. 48 (B), the display apparatus can establish an ACL link with the audio receiving device indicated by “Bluetooth Speaker 1” and further configure the BIS identifier for the corresponding sound channel and the volume of this audio receiving device via the ACL link.

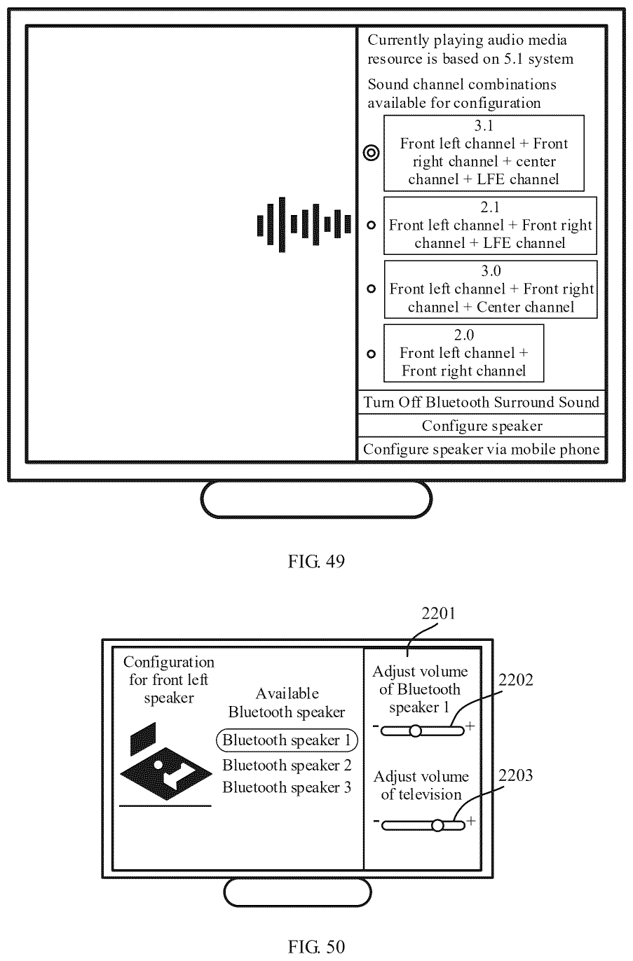

In some embodiments, in the sound configuration interface 2002 shown in FIG. 47, if an instruction for selecting the “Set Bluetooth Surround Sound” control 2003 is received, the display apparatus can first determine whether the audio output mode has already been configured as Bluetooth surround sound mode when playing the current audio media resource, i.e., whether different speakers have already been configured for different sound channels. Based on determining that the Bluetooth surround sound mode has been configured, the interface shown in FIG. 49 can be displayed. FIG. 49 is a schematic diagram of another interface for sound channel combination selection according to some embodiments. As shown in FIG. 49, this interface may show that the currently configured sound channel combination is the 3.1 sound channel combination and show a “Turn Off Bluetooth Surround Sound” control. In response to a selection on the “Turn Off Bluetooth Surround Sound” control, the audio output mode can be switched to the normal output mode, i.e., the display apparatus's own speakers for output.

1402: the display apparatus can establish ACL links with a plurality of audio receiving devices.

1403: the display apparatus can send the configured BIS identifier to each audio receiving device among the plurality of audio receiving devices via the ACL link based on the sound channel information to be configured.

Different audio receiving devices correspond to different BIS identifiers. Different BIS identifiers can be used to indicate BIS audio corresponding to different sound channels.

The display apparatus can send the configured BIS identifier to the audio receiving device via the ACL link so that later, when broadcasting a plurality of BIS audio streams, after the audio receiving device can receive the plurality of BIS audio streams, the audio receiving device can select the BIS audio corresponding to the sound channel it is supposed to play based on the configured BIS identifier.

In some embodiments, the display apparatus sending the configured BIS identifier to each audio receiving device among the plurality of audio receiving devices via the ACL link based on the sound channel information to be configured can include: the display apparatus configures the BIS identifier based on the sound channel information to be configured, and the display apparatus can send the configured BIS identifier to each audio receiving device among the plurality of audio receiving devices via the ACL link.

In some embodiments, after configuring the BIS identifier based on the sound channel information to be configured, the display apparatus can directly send the configured BIS identifier to each audio receiving device among the plurality of audio receiving devices via the ACL link.

In other embodiments, after configuring the BIS identifier based on the sound channel information to be configured, the display apparatus can first activate its built-in Broadcast Assistant Function (i.e., the aforementioned BASS) to scan for broadcast sources. After scanning for a BIS broadcast stream that matches the configured BIS identifier, the display apparatus can send the configured BIS identifier to each audio receiving device among the plurality of audio receiving devices via the ACL link.

The display apparatus can broadcast preset audio. During the broadcasting process, it executes the aforementioned activation of the built-in broadcast assistant function to scan its own broadcast preset audio source to determine if a BIS broadcast stream matching the configured BIS identifier exists.

1404: the display apparatus configures the volume of the plurality of audio receiving devices via the ACL link.

The display apparatus can send the volume parameter configured for each audio receiving device to the corresponding audio receiving device via the ACL link, so that each audio receiving device can adjust its own volume after receiving the volume parameter.

The volume parameter can be default configured parameter or user-configured parameter.

In some embodiments, the display apparatus can establish ACL links with each of the plurality of audio receiving devices sequentially. After the display apparatus can establish an ACL link with one audio receiving device, it configures the volume of the audio receiving device can send the configured BIS identifier to the audio receiving device while the ACL link is maintained. After the configuration of this audio receiving device is finished, the ACL link is disconnected, and the process continues by establishing an ACL link with the next audio receiving device for volume and BIS identifier configuration.

In the embodiments, before sequentially establishing ACL links with each of the plurality of audio receiving devices for volume configuration and BIS identifier configuration, considerations can be made based on the occupancy status of the display apparatus's Bluetooth links and/or the number of ACL links the Bluetooth protocol stack supports simultaneously, to decide whether to use this sequential ACL link establishment method for configuration. The ACL links established for volume configuration and BIS identifier configuration in the embodiments can all be ACL links established based on LE Audio.

In some embodiments, if the occupancy status of the display apparatus's Bluetooth links indicates that there is currently one idle Bluetooth link, then this sequential ACL link establishment method can be used for configuration. Otherwise, the method of the display apparatus simultaneously establishing ACL links with multiple audio receiving devices can be used for configuration.

In some embodiments, if the occupancy status of the display apparatus's Bluetooth links indicates that the current Bluetooth links are occupied by other ACL links established based on Classic Bluetooth, the ACL links based on Classic Bluetooth can be disconnected, establishing ACL links based on LE Audio can be given a priority in the allocation of Bluetooth links, and volume and BIS identifier configuration can be performed. If, after disconnecting the ACL links based on Classic Bluetooth, there is only 1 idle Bluetooth link, then this sequential ACL link establishment method can be used for configuration. Otherwise, the method of the display apparatus simultaneously establishing ACL links with multiple audio receiving devices can be used for configuration.

In some embodiments, if the Bluetooth protocol stack supports establishing only 1 ACL link simultaneously, this sequential ACL link establishment method can be used for configuration. Otherwise, the method of the display apparatus simultaneously establishing ACL links with the plurality of audio receiving devices can be used for configuration.

In some embodiments, if the Bluetooth protocol stack supports establishing a plurality of ACL links simultaneously, the number of ACL links the Bluetooth protocol stack supports simultaneously can be compared with the number of ACL links already established to determine the current remaining number of ACL links that can be established. If the current remaining number of ACL links that can be established is 1, this sequential ACL link establishment method can be used for configuration. Otherwise, the method of the display apparatus simultaneously establishing ACL links with the plurality of audio receiving devices can be used for configuration.

In some embodiments, after the display apparatus can receive an instruction for selecting “Bluetooth Speaker 1” in the front left speaker setup interface 1703 shown in FIG. 43 (B), the display apparatus can establish an ACL link with the audio receiving device indicated by “Bluetooth Speaker 1”. Furthermore, since the front left speaker setup interface 1703 shown in FIG. 43 (B) is for setting the speaker for the front left channel, after receiving the instruction for selecting “Bluetooth Speaker 1”, the audio receiving device indicated by “Bluetooth Speaker 1” can be configured as the speaker corresponding to the front left channel. After the display apparatus can establish an ACL link with the audio receiving device indicated by “Bluetooth Speaker 1”, the display apparatus can send the BIS identifier indicating the front left channel to the audio receiving device indicated by “Bluetooth Speaker 1” via the ACL link.

FIG. 50 is a schematic diagram of a volume adjustment interface according to some embodiments. After the display apparatus can receive an instruction for selecting “Bluetooth Speaker 1” in the front left speaker setup interface 1703 shown in FIG. 43 (B), it can trigger the display of the interface 2201 for volume adjustment shown in FIG. 50. This interface for volume adjustment can include a volume adjustment control 2202 for the audio receiving device indicated by “Bluetooth Speaker 1” and a volume adjustment control 2203 for television volume adjustment (the display apparatus is a television). The display apparatus can control the volume adjustment control 2202 based on the received volume adjustment command, obtain the corresponding volume parameters and send the volume parameters to the audio receiving device indicated by “Bluetooth Speaker 1” via the ACL link. The display apparatus can control the volume adjustment control 2203 based on the received volume adjustment command and obtain its own volume parameters to adjust the volume of the display apparatus itself.

The aforementioned volume adjustment commands can all be input by the user. During the process of controlling volume adjustment control 2202 and volume adjustment control 2203 based on the received volume adjustment commands, preset audio can be played. This allows the user to know the volume adjustment effect based on the preset audio during the volume adjustment process, making it easier to adjust the volume with suitable parameters. Furthermore, after the volume adjustment is finished, the settings for the front left speaker of the front left channel can be saved. The setup interface for a next speaker can then be entered to continue setting the speaker for the next sound channel.

FIG. 51 is a second schematic diagram of a setup interface for configuring a speaker combination according to some embodiments. After the front left speaker configuration is finished, interface 2301 shown in FIG. 51 (A) can be displayed. This interface 2301 can show the current configuration status information 2303 of the front left speaker as “Bluetooth Speaker 1”, indicating that the front left speaker is the audio receiving device indicated by “Bluetooth Speaker 1”. As shown in FIG. 51 (A), in response to a trigger operation on the setup control 2302 for the front right speaker in this interface 2301, the display apparatus can determine one or more audio receiving devices to be connected via Bluetooth scanning (i.e., execute step 1401 above) and display the front right speaker setup interface 2304 shown in FIG. 51 (B). This front right speaker setup interface 2304 can show the identifiers of the audio receiving devices to be connected: “Bluetooth Speaker 1”, “Bluetooth Speaker 2”, and “Bluetooth Speaker 3”. For “Bluetooth Speaker 1”, which has already been configured as the front left speaker, identifier information 2305 “Front Left” can be displayed to indicate that “Bluetooth Speaker 1” has already been configured as the front left speaker.

In some embodiments, if an audio receiving device that has already been configured for another sound channel can be selected when configuring a speaker for a certain channel, the display apparatus can output a prompt message to indicate that this audio receiving device has already been configured for another sound channel and ask the user whether to change it. This can improve human-computer interaction performance.

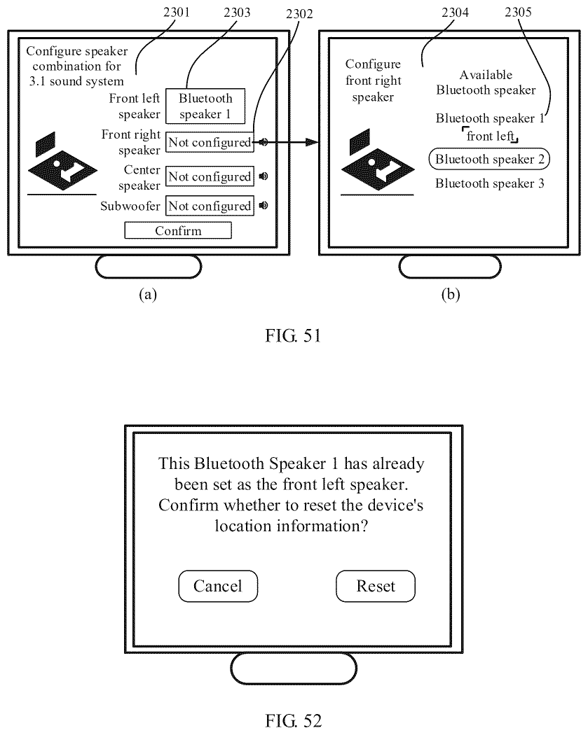

FIG. 52 is a schematic diagram of an interface for outputting a prompt message according to some embodiments. In the front right speaker setup interface 2304 shown in FIG. 51 (B), if the display apparatus can receive an instruction for selecting “Bluetooth Speaker 1”, since the audio receiving device indicated by “Bluetooth Speaker 1” was previously configured as the front left speaker and is now to be configured as the front right speaker, the display apparatus can display the interface shown in FIG. 52. The prompt message in the interface, “This Bluetooth Speaker 1 has already been set as the front left speaker. Confirm whether to reset the device's location information?” is shown to alert the user. Based on the user's selection of the “Cancel” or “Reset” control, it is further confirmed whether to configure the audio receiving device indicated by “Bluetooth Speaker 1” as the front right speaker. If an instruction for selecting the “Reset” control is received, the audio receiving device indicated by “Bluetooth Speaker 1” is re-configured as the front right speaker. If an instruction for selecting the “Cancel” control is received, the front right speaker setup interface 2304 shown in FIG. 51 (B) can be shown to reselect an audio receiving device to be configured as the front right speaker. After the speakers for each sound channel are configured, the interface showing setup success shown in FIG. 53 can be displayed. FIG. 53 is a schematic diagram of an interface showing setup success according to some embodiments. This interface showing setup success shown in FIG. 53 can display a prompt message to inform the user that the speakers for all sound channels have been configured. After the display apparatus can receive an instruction for selecting the “Finish” control, it can save the current configuration and trigger the Bluetooth home theater function to start broadcasting the plurality of BIS streams.

In some embodiments, in the interface shown in FIG. 48 (B), if an instruction for selecting “Bluetooth Speaker 1” is received, the display apparatus can establish an ACL link with the audio receiving device indicated by “Bluetooth Speaker 1” and further proceed with channel and volume configuration.

FIG. 54 is a schematic diagram of an interface for channel and volume configuration according to some embodiments. As shown in FIG. 54, for the connected Bluetooth speaker “Bluetooth Speaker 1”, one sound channel can be selected from “Front Left Channel”, “Front Right Channel”, “Center Channel”, and “LFE Channel” for configuration. The volume of the connected Bluetooth speaker “Bluetooth Speaker 1” can be adjusted using the volume adjustment control 2601 for Bluetooth speaker 1 shown in FIG. 54. The adjusted volume parameters can be sent to the audio receiving device indicated by “Bluetooth Speaker 1” for volume configuration.

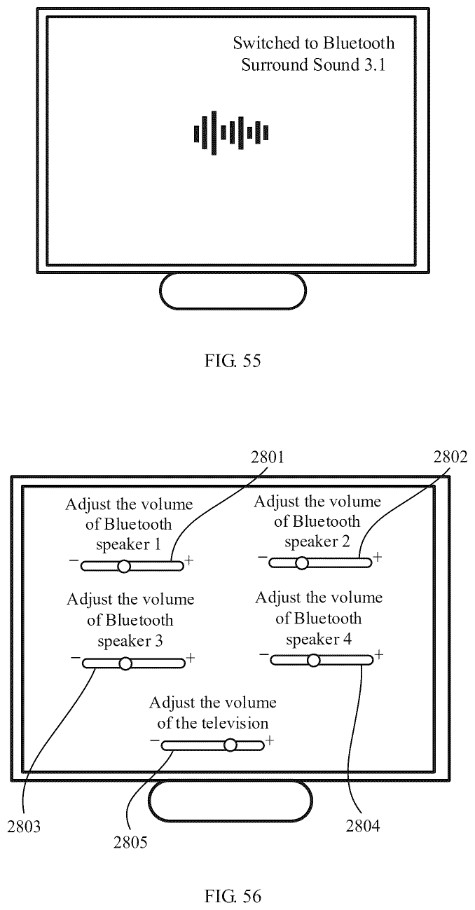

After configuring the volume and sound channel for “Bluetooth Speaker 1” in the interface for configuration shown in FIG. 54, an instruction for selecting the “Continue Configuration” control in this interface for configuration can be received to trigger configuration for the next connected Bluetooth speaker. After finishing the configuration of speakers for all sound channels, an instruction for selecting the “Finish” control in the interface for configuration can be received to end all configurations. After completing all configurations, the interface shown in FIG. 55 can be displayed. FIG. 55 is a schematic diagram of an interface showing configuration completion according to some embodiments. As shown in FIG. 55, “Switched to Bluetooth Surround Sound 3.1” can be displayed to prompt the user that the current mode for playing audio media resources is the 3.1 sound channel combination.

In the above implementation, the display apparatus sequentially can establish ACL links with one audio receiving device at a time. During the establishment of the ACL link, that one audio receiving device can be configured. After the configuration is complete, the display apparatus can disconnect the ACL link with that audio receiving device and continues to establish an ACL link with the next audio receiving device to continue configuration until speakers are configured for all sound channels. This method of sequentially establishing ACL links for configuration takes into account the limited Bluetooth links supporting ACL links in current display apparatuses. Establishing one ACL link at a time for configuration can save Bluetooth links supporting ACL links during the configuration process, preventing the Bluetooth link in the display apparatus that support ACL link from being occupied by one audio receiving device for a long time.

In some embodiments, the display apparatus can simultaneously establish ACL links with a plurality of audio receiving devices and simultaneously configure the BIS identifiers corresponding to different sound channels and perform volume configuration for the plurality of audio receiving devices.

In some embodiments, taking the example of configuring the audio receiving device indicated by “Bluetooth Speaker 1” as the front left speaker, the audio receiving device indicated by “Bluetooth Speaker 2” as the front right speaker, the audio receiving device indicated by “Bluetooth Speaker 3” as the center speaker, and the audio receiving device indicated by “Bluetooth Speaker 4” as the subwoofer, when performing volume configuration, the display apparatus can obtain the current volume parameters of the 4 audio receiving devices and display them in the same interface. This allows the display apparatus to adjust the volume of the display apparatus itself and the 4 audio receiving devices in this interface by receiving user volume adjustment commands on this interface.

FIG. 56 is a schematic diagram of an interface for volume adjustment according to some embodiments. As shown in FIG. 56, this interface for volume adjustment can show: a volume adjustment control 2801 for the audio receiving device indicated by “Bluetooth Speaker 1”, a volume adjustment control 2802 for the audio receiving device indicated by “Bluetooth Speaker 2”, a volume adjustment control 2803 for the audio receiving device indicated by “Bluetooth Speaker 3”, a volume adjustment control 2804 for the audio receiving device indicated by “Bluetooth Speaker 4”, and a volume adjustment control 2805 for television’ volume adjustment (the display apparatus is a television). The volume of each audio receiving device and/or the display apparatus can be adjusted separately through control commands for different volume adjustment can control.

1405: the audio receiving device can save the BIS identifier.

In the embodiments, each audio receiving device can receive the BIS identifier corresponding to a certain sound channel sent by the display apparatus via the ACL link and can save this BIS identifier.

In some embodiments, taking the example where the display apparatus configures 4 audio receiving devices as speakers for 4 sound channels, the 4 audio receiving devices are labeled as: Bluetooth Speaker 1, Bluetooth Speaker 2, Bluetooth Speaker 3, and Bluetooth Speaker 4. Bluetooth Speaker 1 can be configured as the front left speaker, and accordingly, the display apparatus can send the BIS identifier BIS-A to Bluetooth Speaker 1, and Bluetooth Speaker 1 can save this BIS-A. Bluetooth Speaker 2 can be configured as the front right speaker, and accordingly, the display apparatus can send the BIS identifier BIS-B to Bluetooth Speaker 2, and Bluetooth Speaker 2 can save this BIS-B. Bluetooth Speaker 3 can be configured as the center speaker, and accordingly, the display apparatus can send the BIS identifier BIS-C to Bluetooth Speaker 3, and Bluetooth Speaker 3 can save this BIS-C. Bluetooth Speaker 4 can be configured as the subwoofer, and accordingly, the display apparatus can send the BIS identifier BIS-D to Bluetooth Speaker 4, and Bluetooth Speaker 3 can save this BIS-D.

1406: the display apparatus can broadcast the plurality of BIS streams.

Each BIS stream can include BIS audio data and the BIS identifier corresponding to the BIS audio stream.

In the embodiments, in the scheme shown in FIG. 39, the display apparatus first configuring the audio receiving devices and then broadcasting the plurality of BIS streams is described. It should be noted that the display apparatus can broadcast the plurality of BIS streams before configuring the audio receiving devices.

In some embodiments, the BIS audio in each BIS stream can include audio for a single sound channel or audio for a plurality of sound channels.

1407: the audio receiving device can receive the plurality of BIS streams.

After the display apparatus sends the configured BIS identifier to each audio receiving device among the plurality of audio receiving devices via the ACL link, it can broadcast the plurality of BIS streams. Each BIS stream can include BIS audio data and the BIS identifier corresponding to the BIS audio stream, enabling the plurality of audio receiving devices to obtain the target BIS audio stream from the plurality of BIS streams. The BIS identifier corresponding to the target BIS audio stream matches the configured BIS identifier.

In the embodiments, while broadcasting the plurality of BIS streams, public broadcasting can be used, or encrypted broadcasting can be used. Using encrypted broadcasting to broadcast the plurality of BIS streams requires encrypting the plurality of BIS streams. Authorized devices can obtain the decryption key to correctly decrypt the broadcast information, while unauthorized devices cannot obtain the decryption key. Even if they intercept the broadcast data, they cannot obtain the correct information. This ensures information security.

1408: the audio receiving device can obtain the target BIS audio stream from the multiple BIS audio streams.

The BIS identifier corresponding to the target BIS audio stream matches the configured BIS identifier.

In some embodiments, the display apparatus can broadcast audio data. This audio data can include BIS audio for 4 sound channels: BIS audio for the front left channel with the corresponding BIS identifier BIS-A; BIS audio for the front right channel with the corresponding BIS identifier BIS-B; BIS audio for the center channel with the corresponding BIS identifier BIS-C; and BIS audio for the LFE channel with the corresponding BIS identifier BIS-D. Accordingly, after Bluetooth Speaker 1, Bluetooth Speaker 2, Bluetooth Speaker 3, and Bluetooth Speaker 4 receive the audio data, they can match it with the saved BIS identifier and select the target BIS audio from it. In some embodiments, taking Bluetooth Speaker 1 saving BIS identifier BIS-A, Bluetooth Speaker 2 saving BIS identifier BIS-B, Bluetooth Speaker 3 saving BIS identifier BIS-C, and Bluetooth Speaker 4 saving BIS identifier BIS-D as an example, Bluetooth Speaker 1 can determine the BIS audio for the front left channel as the target BIS audio; Bluetooth Speaker 2 can determine the BIS audio for the front right channel as the target BIS audio; Bluetooth Speaker 3 can determine the BIS audio for the center channel as the target BIS audio; Bluetooth Speaker 4 can determine the BIS audio for the LFE channel as the target BIS audio.

1409: the audio receiving device plays the target BIS audio.

In the embodiments, each audio receiving device can play the BIS audio corresponding to its channel, thereby achieving stereo playback effect, i.e., the playback effect of a Bluetooth home theater.

According to the display apparatus, audio receiving device, and multi-channel audio transmission method of some embodiments, the display apparatus can obtain the sound channel information to be configured, determine several audio receiving devices to be connected via Bluetooth scanning, establish ACL links with a plurality of audio receiving devices among them, and after establishing the ACL links, configure a BIS identifier for each audio receiving device among the plurality of audio receiving devices based on the sound channel information to be configured, and send the configured BIS identifier to each audio receiving device among the plurality of audio receiving devices via the ACL link. The plurality of audio receiving devices are some or all of the several audio receiving devices. After the configuration is complete, the display apparatus can broadcast the plurality of BIS streams. Each BIS stream can include BIS audio data and the BIS identifier corresponding to the BIS audio stream, enabling the plurality of audio receiving devices to obtain the target BIS audio stream from the multiple BIS streams. The BIS identifier corresponding to the target BIS audio stream matches the configured BIS identifier. Based on this scheme, the display apparatus configures speakers for different sound channels (i.e., audio receiving devices corresponding to different sound channels) based on ACL links and can simultaneously send Broadcast Isochronous Streams (BIS) for a plurality of sound channels to the plurality of audio receiving devices based on broadcasting. Thus, without occupying the display apparatus's Bluetooth links, audio for a plurality of sound channels can be simultaneously played through the plurality of audio receiving devices, achieving stereo playback effect.

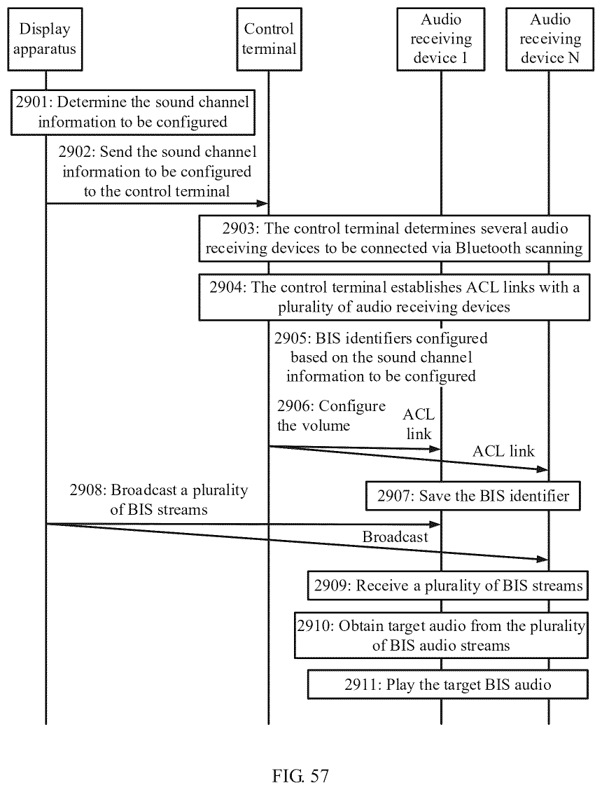

Corresponding to the scenario schematic shown in FIG. 37, embodiments of the disclosure provide a device control method as shown in FIG. 57 below.

FIG. 57 is a tenth schematic flowchart of a device control method according to some embodiments. As shown in FIG. 57, the method can be implemented through interaction between the display apparatus, control terminal, and N audio receiving devices. FIG. 57 only can show audio receiving device 1 and audio receiving device N. The audio receiving devices involved in the following steps can be any audio receiving device among these N audio receiving devices. The method may include, but is not limited to, the following steps.

2901: the display apparatus can determine the sound channel information to be configured.

The description for step 2901 can refer to the description for step 1400 above, which will not be repeated here.

2902: the display apparatus can send the sound channel information to be configured to the control terminal.

In the embodiments, the display apparatus can send the sound channel information to be configured to the control terminal, enabling the control terminal, after learning the channel information to be configured, to configure corresponding audio receiving devices as speakers for the respective sound channels for the display apparatus based on the channel information to be configured.

The display apparatus and the control terminal can establish a communication connection in a wireless manner and send the channel information to be configured based on the communication connection.

In some embodiments, the display apparatus and the control terminal can establish a Wireless Fidelity (Wi-Fi) connection through a Wi-Fi network. The display apparatus can send the sound channel information to be configured to the control terminal via the Wi-Fi connection. Alternatively, the display apparatus and the control terminal can establish an ACL link through a Bluetooth network. The display apparatus can send the sound channel information to be configured to the control terminal via the ACL link.

In some embodiments, in the interface shown in FIG. 41, after receiving an instruction for selecting the 3.1 sound channel combination, the display apparatus can determine the sound channel information to be configured. At this point, the display apparatus can be triggered to send the sound channel information to be configured to the control terminal, i.e., send the information of the 3.1 sound channel combination to the control terminal.

In some embodiments, in the interface 2101 shown in FIG. 48 (A), after receiving an instruction for selecting the “Configure Speakers via Phone” control 2103, the display apparatus can determine the sound channel information to be configured. At this point, the display apparatus can be triggered to send the sound channel information to be configured to the control terminal, i.e., send the information of the 3.1 sound channel combination to the control terminal.

2903: the control terminal determines several audio receiving devices to be connected via Bluetooth scanning.

In some embodiments, after the display apparatus sends the sound channel information to be configured to the control terminal, the control terminal can configure corresponding audio receiving devices as speakers for the respective channels for the display apparatus based on this channel information to be configured. In this case, BIS identifier configuration, and further volume configuration can be performed.

In some embodiments, a broadcast assistant application can be set up in the control terminal. This broadcast assistant application can be used to implement the function of configuring corresponding audio receiving devices as speakers for the respective channels for the display apparatus.

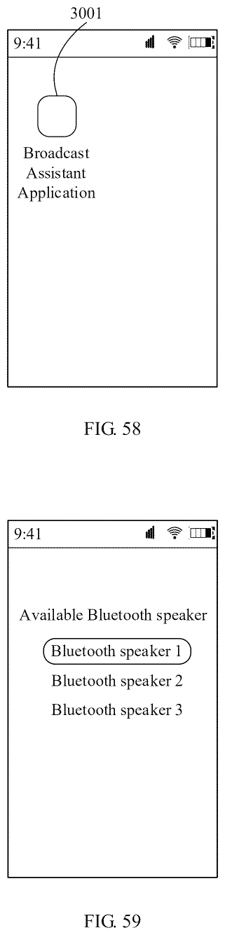

FIG. 58 is a schematic diagram of an interface for triggering the launch of a broadcast assistant application according to some embodiments. In some embodiments, as shown in FIG. 58, the application identifier 3001 of the broadcast assistant application can be displayed on the display screen of the control terminal. After receiving a command for selecting this broadcast assistant application's identifier from a user, in response to this selection command, the broadcast assistant function can be enabled for subsequent configuration. After the broadcast assistant function is enabled and the control terminal can receive the sound channel information to be configured sent by the display apparatus, the control terminal can determine several audio receiving devices to be connected via Bluetooth scanning based on this broadcast assistant application.

FIG. 59 is a schematic diagram of a control terminal scanning for available Bluetooth speakers according to some embodiments. As shown in FIG. 59, this interface can display the device identifiers corresponding to the available Bluetooth speakers: “Bluetooth Speaker 1”, “Bluetooth Speaker 2”, and “Bluetooth Speaker 3”. Here, Bluetooth Speaker 1, Bluetooth Speaker 2, and Bluetooth Speaker 3 are Bluetooth devices scanned by the control terminal via its Bluetooth scanning function. Furthermore, after the control terminal can receive an instruction for selecting “Bluetooth Speaker 1”, the display apparatus can establish an ACL link with the audio receiving device indicated by “Bluetooth Speaker 1”.

2904: the control terminal can establish ACL links with a plurality of audio receiving devices.

2905: the control terminal configures BIS identifiers based on the sound channel information to be configured can send the configured BIS identifiers to each audio receiving device among the plurality of audio receiving devices via the ACL link.

In some embodiments, after configuring the BIS identifiers based on the sound channel information to be configured, the control terminal can directly send the configured BIS identifiers to each audio receiving device among the plurality of audio receiving devices via the ACL link.

In other embodiments, after configuring the BIS identifiers based on the sound channel information to be configured, the control terminal can first activate its built-in Broadcast Assistant Function (i.e., the aforementioned BASS) to scan for broadcast sources. After discovering a BIS broadcast stream(s) matching the configured BIS identifier(s), the control terminal sends the configured BIS identifiers to each audio receiving device among the plurality of audio receiving devices via the ACL link.

After sending the sound channel information to be configured to the control terminal, the display apparatus can broadcast preset audio. During the broadcasting process, the aforementioned activation of the built-in broadcast assistant function is executed to scan for the display apparatus's broadcast preset audio to determine if a BIS broadcast stream matching the configured BIS identifiers exists.

2906: the control terminal configures the volume of the plurality of audio receiving devices via the ACL link.

It should be noted that step 2906 is an optional step. That is, the control terminal can configure the volume of the plurality of audio receiving devices via the ACL link, or it may not perform volume configuration for the plurality of audio receiving devices.

The control terminal configuring the volume of the plurality of audio receiving devices via the ACL link can be implemented as: the control terminal sends the volume parameter configured for each audio receiving device among the plurality of audio receiving devices to the corresponding audio receiving device via the ACL link.

In some embodiments, the control terminal can establish ACL links with each of the plurality of audio receiving devices sequentially. After the control terminal can establish an ACL link with one audio receiving device, it configures the volume of the audio receiving device can send the configured BIS identifier while the ACL link is maintained. After the configuration of this audio receiving device is complete, the ACL link is disconnected, and the process continues by establishing an ACL link with the next audio receiving device for volume and BIS identifier configuration.

By having the control terminal sequentially establish ACL links with one audio receiving device at a time, configure that audio receiving device during the establishment of the ACL link, disconnect the ACL link with that audio receiving device after configuration is complete, and continue establishing an ACL link with the next audio receiving device to continue configuration until speakers for all channels are configured. This method of sequentially establishing ACL links for configuration takes into account the limited Bluetooth links supporting ACL links in current control terminals. Establishing one ACL link at a time for configuration can save Bluetooth links supporting ACL links during the configuration process, preventing the Bluetooth links in the control terminal that support ACL link from being occupied by one audio receiving device for a long time.

In some embodiments, the control terminal can simultaneously establish ACL links with the plurality of audio receiving devices and simultaneously configure the BIS identifiers corresponding to different sound channels and perform volume configuration for the plurality of audio receiving devices.

Different audio receiving devices correspond to different BIS identifiers. Different BIS identifiers can be used to indicate BIS audio corresponding to different sound channels.

The aforementioned control terminal can first determine the BIS identifier corresponding to each channel based on the sound channel information to be configured. The configured BIS identifiers can be sent to the audio receiving devices via the ACL link, so that when broadcasting the plurality of BIS audio streams, after the audio receiving devices receive the plurality of BIS audio streams, they can select the BIS audio corresponding to the sound channel they are supposed to play based on the configured BIS identifiers.

In some embodiments, assume the sound channel information to be configured is for a 3.1 sound channel combination, including: front left channel, front right channel, center channel, and LFE channel. Then, BIS-A can be configured as the BIS identifier for the front left channel; BIS-B can be configured as the BIS identifier for the front right channel; BIS-C can be configured as the BIS identifier for the center channel; and BIS-D can be configured as the BIS identifier for the LFE channel.

In some embodiments, the control terminal can first connect with the Bluetooth speaker and then configure the channel.

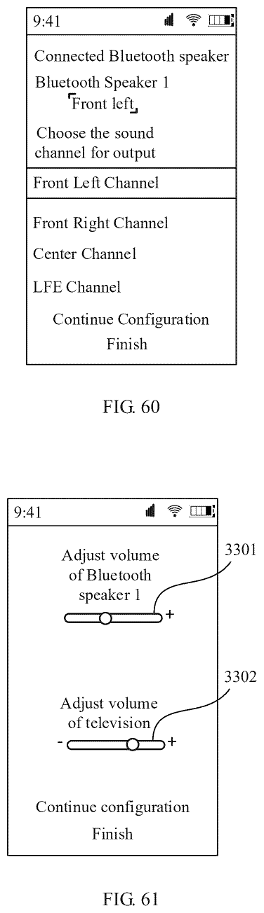

FIG. 60 is a schematic diagram illustrating configuring a sound channel for a connected Bluetooth speaker according to some embodiments. After the control terminal has connected with the audio receiving device indicated by “Bluetooth Speaker 1”, it can further select the sound channel that this audio receiving device needs to play audio. As shown in FIG. 60, if the front left channel can be selected, the audio receiving device indicated by “Bluetooth Speaker 1” can be configured as the speaker for the display apparatus's front left channel. At this point, the BIS identifier corresponding to the front left channel can be sent to the audio receiving device indicated by “Bluetooth Speaker 1”.

Furthermore, in the interface shown in FIG. 60, after configuring the audio receiving device indicated by “Bluetooth Speaker 1” as the speaker for the display apparatus's front left channel, the “Continue Configuration” control can be used to trigger a return to the interface for connecting other Bluetooth speakers, such as the interface shown in FIG. 59, to further connect other Bluetooth speakers and configure sound channels. After speakers are configured for all sound channels, the “Finish” control in the interface shown in FIG. 60 can be used to trigger saving the configuration.

In some embodiments, if the front left channel can be selected as shown in FIG. 60, it can further trigger the display of the interface shown in FIG. 61. FIG. 61 is a schematic diagram of an interface for volume adjustment via a control terminal according to some embodiments. As shown in FIG. 61, this interface can display a volume adjustment control 3301 corresponding to the audio receiving device indicated by Bluetooth Speaker 1, and a television volume adjustment control 3302 corresponding to the display apparatus (the display apparatus is a television). Adjusting the volume of the audio receiving device indicated by Bluetooth Speaker 1 can be achieved by operating the volume adjustment control 3301, and adjusting the volume of the display apparatus can be achieved by operating the television volume adjustment control 3302.

It should be noted that the schematic diagram of the interface for volume adjustment via the control terminal shown in FIG. 61 is based on the situation where the control terminal sequentially can establish ACL links with the plurality of audio receiving devices. For the situation where the control terminal simultaneously can establish ACL links with the plurality of audio receiving devices and simultaneously performs volume configuration for the plurality of audio receiving devices, the interface for volume adjustment on the control terminal can be similar to FIG. 56 above.

When the control terminal has established ACL links with a plurality of audio receiving devices, it can send the respective volume parameters to the plurality of audio receiving devices via the ACL links. In this case, if the control terminal is connected with the display apparatus via wireless communication, the control terminal can send the configured volume parameters to the display apparatus, thereby achieving volume adjustment for the plurality of audio receiving devices and the display apparatus through the control terminal. Furthermore, a volume setting interface similar to that shown in FIG. 56 can be set up in the control terminal, facilitating volume adjustment for the plurality of audio receiving devices and the display apparatus through the control terminal via operations on a visual interface.

In other embodiments, the control terminal can first configure the sound channel and then select the Bluetooth speaker corresponding to the sound channel.

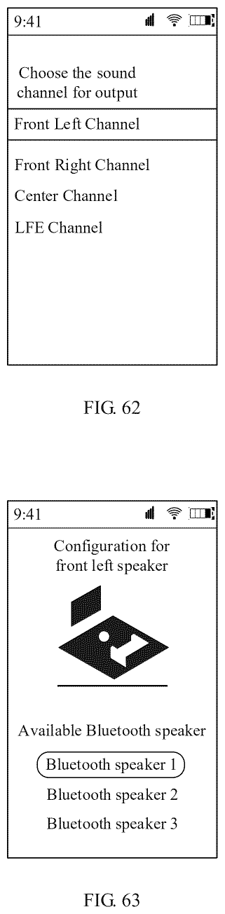

FIG. 62 is a schematic diagram of an interface for sound channel selection according to some embodiments. Before the control terminal performs Bluetooth scanning, it can first display the schematic diagram of the interface for sound channel selection shown in FIG. 62. This interface can show that the sound channels currently for play include: front left channel, front right channel, center channel, and LFE channel.

After the control terminal can receive an instruction for selecting the “Front Left Channel” shown in FIG. 62, the interface shown in FIG. 63 can be displayed. FIG. 63 is a schematic diagram of an interface for setting a front left speaker according to some embodiments. FIG. 63 can show the identifiers of the available Bluetooth speakers scanned by the control terminal via its Bluetooth scanning function, including: “Bluetooth Speaker 1”, “Bluetooth Speaker 2”, and “Bluetooth Speaker 3”. After receiving an instruction for selecting “Bluetooth Speaker 1” shown in FIG. 63, the control terminal can establish an ACL link with the audio receiving device indicated by Bluetooth Speaker 1 and send the BIS identifier corresponding to the front left channel to the audio receiving device indicated by Bluetooth Speaker 1 via this ACL link.

2907: the audio receiving device can save the BIS identifier.

2908: the display apparatus can broadcast multiple BIS streams.

Each BIS stream can include BIS audio data and the BIS identifier corresponding to the BIS audio stream.

After the display apparatus sends the configured BIS identifiers to each audio receiving device among the plurality of audio receiving devices via the ACL link, it can broadcast the plurality of BIS streams. Each BIS stream can include BIS audio data and the BIS identifier corresponding to the BIS audio stream, enabling the plurality of audio receiving devices to obtain the target BIS audio from the plurality of BIS streams. The BIS identifier corresponding to the target BIS audio stream matches the configured BIS identifier.

2909: the audio receiving device can receive the plurality of BIS streams.

2910: the audio receiving device can obtain the target BIS audio from the plurality of BIS audio streams.

The BIS identifier corresponding to the target BIS audio stream matches the configured BIS identifier.

2911: the audio receiving device plays the target BIS audio.

The description for steps 2907 to 2911 can refer to the description for steps 1405 to 1409 above, which will not be repeated here.

According to the multi-channel audio transmission method of some embodiments, the display apparatus can obtain the sound channel information to be configured and send this channel information to be configured to the control terminal. The control terminal can then configure speakers for different sound channels for the display apparatus (i.e., audio receiving devices corresponding to different sound channels) based on this channel information to be configured. In an embodiment of the disclosure, several audio receiving devices to be connected can be determined via Bluetooth scanning, ACL links can be established with a plurality of audio receiving devices among them. After establishing the ACL links, BIS identifier can be configured for each audio receiving device among the plurality of audio receiving devices based on the sound channel information to be configured. The configured BIS identifiers can be sent to each audio receiving device among the plurality of audio receiving devices via the ACL link. The plurality of audio receiving devices are some or all of the several audio receiving devices. After the control terminal completes the configuration, the display apparatus can broadcast the plurality of BIS streams. Each BIS stream can include BIS audio data and the BIS identifier corresponding to the BIS audio stream, enabling the plurality of audio receiving devices to obtain the target BIS audio from the plurality of BIS streams. The BIS identifier corresponding to the target BIS audio stream matches the configured BIS identifier. Through this scheme, the control terminal can configure speakers for different sound channels for the display apparatus, and the display apparatus can simultaneously send Broadcast Isochronous Streams (BIS) for a plurality of sound channels to a plurality of audio receiving devices based on broadcasting. Thus, without occupying the display apparatus's Bluetooth links, audio for the plurality of sound channels can be simultaneously played through the plurality of audio receiving devices, achieving stereo playback effect.

In some embodiments, the aforementioned BIS identifiers can be configured by the display apparatus based on the sound channel information to be configured and sent to the control terminal. The control terminal, acting as a relay device, then forwards these BIS identifiers to the plurality of audio receiving devices.

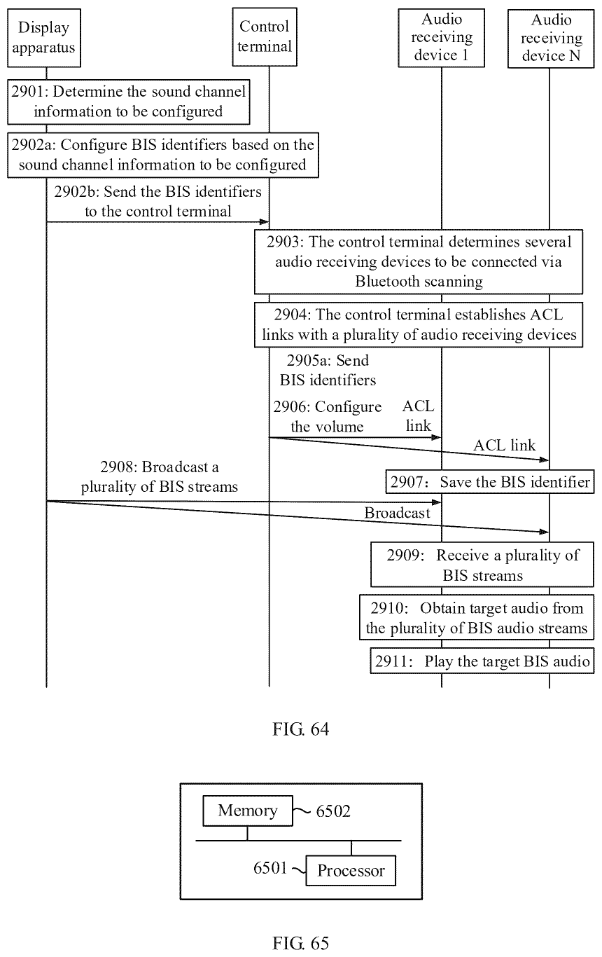

FIG. 64 is an eleventh schematic flowchart of a device control method according to some embodiments. FIG. 64 can be based on FIG. 57 above, replacing step 2902 in FIG. 57 with the following steps 2902a and 2902b.

2902a: the display apparatus configures BIS identifiers based on the sound channel information to be configured.

The method by which the display apparatus configures BIS identifiers based on the sound channel information to be configured is similar to the method by which the control terminal configures BIS identifiers based on the sound channel information to be configured, which will not be repeated here.

2902b: the display apparatus can send the configured BIS identifiers to the control terminal.

The display apparatus and the control terminal can establish a Wi-Fi connection through a Wi-Fi network. The display apparatus can send the configured BIS identifiers to the control terminal via the Wi-Fi connection. Alternatively, the display apparatus and the control terminal can establish an ACL link through a Bluetooth network. The display apparatus can send the configured BIS identifiers to the control terminal via the ACL link.

Correspondingly, step 2905 in FIG. 64 can be replaced with the following step 2905a.

2905a: the control terminal sends the BIS identifiers to each audio receiving device among the plurality of audio receiving devices via the ACL link.

The control terminal can receive the BIS identifiers sent by the display apparatus and send these BIS identifiers to different audio receiving devices respectively.

The method where the control terminal acts as a relay device to forward the BIS identifiers sent by the display apparatus can also be used for configuring speakers for different sound channels for the display apparatus through the control terminal. The display apparatus can simultaneously send Broadcast Isochronous Streams (BIS) for the plurality of sound channels to a plurality of audio receiving devices based on broadcasting. Thus, without occupying the display apparatus's Bluetooth links, audio for a plurality of sound channels can be simultaneously played through a plurality of audio receiving devices, achieving stereo playback effect.

FIG. 65 is a schematic diagram of a hardware structure of an electronic device according to some embodiments. This electronic device can be the aforementioned display apparatus, control terminal, or audio receiving device. As shown in FIG. 65, the electronic device can include: a processor 6501, a memory 6502, and a computer program stored on the memory 6502 and executable on the processor 6501. When the computer program is executed by the processor 6501, it implements the various processes of the method embodiments involving the following methods: the device control method executed by the display apparatus; and the device control method executed by the audio receiving device.

Embodiments of the disclosure provide a computer-readable storage medium. A computer program is stored on this computer-readable storage medium. When the computer program is executed by a processor, it implements the various processes of the device control method described above and can achieve the same technical effects. To avoid repetition, details are not repeated here. The computer-readable storage medium can be a Read-Only Memory (ROM), Random Access Memory (RAM), magnetic disk, or optical disk, etc.

The disclosure provides a computer program product. This computer program product can include a computer program. When this computer program is run on a computer, it causes the computer to implement the aforementioned device control method.

What is claimed is:

1. A display apparatus, comprising:
a display, configured to display images and/or a user interface from a broadcasting system and a network;
an audio playback module, configured to play audio;
a Bluetooth communication module, configured to communicate with an external device based on a Bluetooth protocol;
a memory, configured to store computer instructions and data associated with the display apparatus;
at least one processor, in connection with the display, the audio playback module, the Bluetooth communication module, and the memory, and configured to execute the computer instructions to cause the display apparatus to:
control the Bluetooth communication module to perform device scanning, and display scanned devices on the display;
in response to a pairing request triggered for a target device among the scanned devices, establish a Bluetooth connection based on an Advanced Audio Distribution Profile (A2DP) protocol with the target device;
obtain a Universally Unique Identifier (UUID) of the target device;
after successfully establishing the Bluetooth connection based on the A2DP protocol, add the target device to a list of connected devices;
determine, based on the UUID, that the target device supports a Low Energy Audio (LE Audio) protocol, add a preset visual indicator for the target device; wherein the preset visual indicator is used to prompt a user that the Bluetooth connection with the target device is allowed to be switched to a Bluetooth connection based on the LE Audio protocol.

2. The display apparatus according to claim 1, wherein the at least one processor is further configured to execute the computer instructions to cause the display apparatus to:
in response to entering a device management page, control the Bluetooth communication module to scan for nearby devices, and display the scanned devices on a device management interface.

3. The display apparatus according to claim 1, wherein the at least one processor is further configured to execute the computer instructions to cause the display apparatus to:
after controlling the Bluetooth communication module to establish the Bluetooth connection with the target device based on the A2DP protocol, in response to a connection protocol switching command for the target device based on the preset visual indicator, disconnect the Bluetooth connection based on the A2DP protocol, and control the Bluetooth communication module to establish a Bluetooth connection with the target device based on the LE Audio protocol.

4. The display apparatus according to claim 3, wherein the at least one processor is further configured to execute the computer instructions to cause the display apparatus to:
while a local speaker is playing audio data, after establishing the Bluetooth connection with the target device based on the A2DP protocol, synchronize the audio data to the target device;
in response to the connection protocol switching command for the target device, while controlling the Bluetooth communication module to disconnect the Bluetooth connection based on the A2DP protocol, control the local speaker to play the audio data;
establish the Bluetooth connection with the target device based on the LE Audio protocol, control the local speaker to stop playing the audio data, and synchronize the audio data of the display apparatus to the target device.

5. The display apparatus according to claim 3, wherein the at least one processor is further configured to execute the computer instructions to cause the display apparatus to:
while a local speaker is playing audio data, after establishing the Bluetooth connection with the target device based on the A2DP protocol, synchronize the audio data to the target device;
in response to the connection protocol switching command for the target device, while controlling the Bluetooth communication module to disconnect the Bluetooth connection based on the A2DP protocol, control the local speaker to play the audio data mutely;
establish the Bluetooth connection with the target device based on the LE Audio protocol, control the local speaker to stop playing the audio data mutely, and synchronize the audio data of the display apparatus to the target device.

6. The display apparatus according to claim 1, wherein the at least one processor is further configured to execute the computer instructions to cause the display apparatus to:
after controlling the Bluetooth communication module to establish the Bluetooth connection with the target device based on the A2DP protocol, in response to a connection protocol switching command for the target device, control the Bluetooth communication module to establish a dual-protocol Bluetooth connection with the target device based on the A2DP protocol and the LE Audio protocol, set the A2DP protocol to be in an inactive state, and set the LE Audio protocol to be in an active state;
wherein the LE Audio protocol in the active state is used to synchronize audio data of the display apparatus to the target device.

7. The display apparatus according to claim 1, wherein the at least one processor is further configured to execute the computer instructions to cause the display apparatus to:
after controlling the Bluetooth communication module to establish the Bluetooth connection with the target device based on the LE Audio protocol, control the display to display a broadcast scan control in an operable state;
wherein the broadcast scan control is used to trigger scanning for broadcast signal sources for the target device.

8. The display apparatus according to claim 7, wherein the at least one processor is further configured to execute the computer instructions to cause the display apparatus to:
in response to a trigger operation on the broadcast scan control, switch a state of a Broadcast Media Sender (BMS) protocol to active, switch a state of a Unicast Media Sender (UMS) protocol to inactive, and switch a current audio output channel to a Bluetooth broadcast audio output channel.

9. The display apparatus according to claim 7, wherein the at least one processor is further configured to execute the computer instructions to cause the display apparatus to:
in response to a trigger operation on the broadcast scan control, control the Bluetooth communication module to scan for broadcast signal sources based on a Broadcast Assistant (BSA) protocol, and display identifiers of scanned broadcast signal sources on the display;
in response to a selection on a target identifier among the identifiers of the scanned broadcast signal sources, send broadcast parameter information of a broadcast signal source corresponding to the target identifier to a device to be processed, wherein the device to be processed is associated with the target identifier, to allow the device to be processed to play audio data transmitted from the broadcast signal source based on the broadcast parameter information of the broadcast signal source.

10. The display apparatus according to claim 9, wherein the at least one processor is further configured to execute the computer instructions to cause the display apparatus to:
based on that the display apparatus is currently broadcasting, show an identifier of a local broadcast on the display;
in response to a selection on the identifier of the local broadcast, send broadcast parameter information of the local broadcast to the device to be processed, to allow the device to be processed to play audio data of the local broadcast based on the broadcast parameter information of the local broadcast.

11. The display apparatus according to claim 9, wherein the at least one processor is further configured to execute the computer instructions to cause the display apparatus to:
in response to a trigger operation for switching the current audio output channel to the Bluetooth broadcast output channel, obtain broadcast parameter information of the display apparatus;
send the broadcast parameter information to the device to be processed via a Bluetooth channel established based on the BSA protocol with the device to be processed.

12. The display apparatus according to claim 11, wherein the at least one processor is further configured to execute the computer instructions to cause the display apparatus to:
after obtaining the broadcast parameter information of the display apparatus in response to the trigger operation for switching the current audio output channel to the Bluetooth broadcast output channel, and before sending the broadcast parameter information to the device to be processed via the Bluetooth channel established based on the BSA protocol with the device to be processed, control the Bluetooth communication module to perform device scanning;
in response to a pairing request triggered for the device to be processed among scanned devices, determine whether the device to be processed supports the LE Audio protocol;
based on determining that the device to be processed supports the LE Audio protocol, establish a Bluetooth connection, based on the LE Audio protocol and the BSA protocol, with the target device.

13. The display apparatus according to claim 1, wherein the at least one processor is further configured to execute the computer instructions to cause the display apparatus to:
receive an instruction for selecting a sound channel combination;
in response to the instruction for selecting a channel combination, obtain sound channel information to be configured, and obtain sound channel information of an audio media resource currently being played;
determine, from sound channel information supported by the display apparatus, sound channel information to be configured that matches the sound channel information of the audio media resource;
control the Bluetooth communication module to perform device scanning to determine several audio receiving devices to be connected;
control the Bluetooth communication module to establish Access Control List (ACL) links with a plurality of audio receiving devices;
configure, based on the sound channel information to be configured, a Broadcast Isochronous Stream (BIS) identifier for each audio receiving device in the plurality of audio receiving devices via the ACL links, wherein the plurality of audio receiving devices are some or all of the several audio receiving devices;
control the Bluetooth communication module to transmit a plurality of BIS streams, each BIS stream comprising BIS audio data and a BIS identifier corresponding to the BIS audio stream, to allow the plurality of audio receiving devices to obtain target BIS audio from the plurality of BIS streams;
wherein a BIS identifier corresponding to the target BIS audio matches the configured BIS identifier.

14. The display apparatus according to claim 13, wherein the at least one processor is further configured to execute the computer instructions to cause the display apparatus to:
after determining the several audio receiving devices to be connected through Bluetooth scanning, and before controlling the Bluetooth communication module to establish ACL links with the plurality of audio receiving devices, obtain a UUID corresponding to each audio receiving device in the several audio receiving devices;
select, from the several audio receiving devices, the plurality of audio receiving devices whose device type indicated by the UUID supports the LE Audio protocol.

15. A method for a display apparatus, comprising:
controlling a Bluetooth communication module of the display apparatus to perform device scanning, and displaying scanned devices on a display of the display apparatus;
in response to a pairing request triggered for a target device among the scanned devices, establishing a Bluetooth connection based on an Advanced Audio Distribution Profile (A2DP) protocol with the target device;
obtaining a Universally Unique Identifier (UUID) of the target device;
after successfully establishing the Bluetooth connection based on the A2DP protocol, adding the target device to a list of connected devices;
determining, based on the UUID, that the target device supports a Low Energy Audio (LE Audio) protocol, adding a preset visual indicator for the target device; wherein the preset visual indicator is used to prompt a user that the Bluetooth connection with the target device is allowed to be switched to a Bluetooth connection based on the LE Audio protocol.

16. The method according to claim 15, further comprising:
in response to entering a device management page, controlling the Bluetooth communication module to scan for nearby devices, and displaying the scanned devices on a device management interface.

17. The method according to claim 15, further comprising:
after controlling the Bluetooth communication module to establish the Bluetooth connection with the target device based on the A2DP protocol, in response to a connection protocol switching command for the target device based on the preset visual indicator, disconnecting the Bluetooth connection based on the A2DP protocol, and controlling the Bluetooth communication module to establish a Bluetooth connection with the target device based on the LE Audio protocol.

18. The method according to claim 17, further comprising:
while a local speaker is playing audio data, after establishing the Bluetooth connection with the target device based on the A2DP protocol, synchronizing the audio data to the target device;
in response to the connection protocol switching command for the target device, while controlling the Bluetooth communication module to disconnect the Bluetooth connection based on the A2DP protocol, controlling the local speaker to play the audio data;
establishing the Bluetooth connection with the target device based on the LE Audio protocol, controlling the local speaker to stop playing the audio data, and synchronizing the audio data of the display apparatus to the target device.

19. The method according to claim 17, further comprising:
while a local speaker is playing audio data, after establishing the Bluetooth connection with the target device based on the A2DP protocol, synchronizing the audio data to the target device;
in response to the connection protocol switching command for the target device, while controlling the Bluetooth communication module to disconnect the Bluetooth connection based on the A2DP protocol, controlling the local speaker to play the audio data mutely;
establishing the Bluetooth connection with the target device based on the LE Audio protocol, controlling the local speaker to stop playing the audio data mutely, and synchronizing the audio data of the display apparatus to the target device.

20. The method according to claim 15, further comprising:
after controlling the Bluetooth communication module to establish the Bluetooth connection with the target device based on the A2DP protocol, in response to a connection protocol switching command for the target device, controlling the Bluetooth communication module to establish a dual-protocol Bluetooth connection with the target device based on the A2DP protocol and the LE Audio protocol, setting the A2DP protocol to be in an inactive state, and setting the LE Audio protocol to be in an active state;
wherein the LE Audio protocol in the active state is used to synchronize audio data of the display apparatus to the target device.
